(19) United States
(12) Patent Application Publication
(10) Pub. No.: US 2026/0038873 A1
(43) Pub. Date: Feb. 5, 2026

(54) BATTERIES WITH SOLID STATE ELECTROLYTE MULTILAYERS

(71) Applicant: President and Fellows of Harvard College, Cambridge, MA (US)

(72) Inventors: Xin LI, Belmont, MA (US); Luhan Ye, Cambridge, MA (US)

(21) Appl. No.: 19/024,576

(22) Filed: Jan. 16, 2025

Related U.S. Application Data
(63) Continuation of application No. 18/141,740, filed on May 1, 2023, now abandoned.
Application No. 18/141,740 is a continuation of application No. PCT/US21/57591, filed on Nov. 1, 2021.
(60) Provisional application No. 63/108,075, filed on Oct. 30, 2020.
(60) Provisional application No. 63/179,011, filed on Apr. 23, 2021.
(60) Provisional application No. 63/212,407, filed on Jun. 18, 2021.

(51) Int. Cl. H01M 10/0562; H01M 10/04; H01M 10/0525; H01M 10/0585

(52) U.S. Cl. CPC H01M 10/0562; H01M 10/0468; H01M 10/0525; H01M 10/0585; H01M 2300/008; H01M 2300/0094

(57) ABSTRACT

The invention provides rechargeable solid state batteries with multilayers of solid state electrolytes. The rechargeable solid state batteries disclosed herein are advantageous as they provide improved battery cycling performance combined with excellent power and energy density.

### FIELD OF THE INVENTION

The invention is directed to the field of solid state rechargeable batteries.

### BACKGROUND OF THE INVENTION

Dendrite formation (e.g., Li or Na dendrite formation) is a major cause of battery failure and shortening of battery life in solid state batteries with electrodes containing lithium or sodium metal. Dendrite formation diminishes the capacity of batteries and eventually causes total failure by shorting when dendrites meet each other or the opposite electrode. Previous attempts to solve this problem have focused on improving the stability of the solid state electrolyte and modifications to the interfaces between electrodes and the solid state electrolyte, e.g., adding barrier layers. Such remediations have met with limited success.

Thus, there is a need for improved solid state batteries incorporating solid state electrolytes.

### SUMMARY OF THE INVENTION

The invention provides rechargeable solid state batteries with multilayers of solid state electrolytes. The rechargeable solid state batteries disclosed herein are advantageous as they represent an advance in battery cycling performance combined with excellent power and energy density.

In one aspect, the invention provides a rechargeable battery including a) an anode and a cathode and b) a solid state electrolyte multilayer disposed between the anode and the cathode including: i) a first solid state electrolyte and ii) a second solid state electrolyte. The second solid state electrolyte is separated from the anode by the first solid state electrolyte, i.e., the multilayer includes at least two layers, e.g., at least three.

In certain embodiments, the second solid state electrolyte is less stable to the anode metal, e.g., lithium or sodium, than the first solid state electrolyte. In some embodiments, the first solid state electrolyte has a first decomposition energy (Eₕᵤₗₗ), a first local effective modulus, e.g., when being made into solid state batteries, and a first critical modulus (K*), where the first critical modulus is lower than the first local effective modulus thereby causing the first decomposition energy to have a positive value. In some embodiments, the second solid state electrolyte has a second decomposition energy (Eₕᵤₗₗ), a second local effective modulus, e.g., when being made into solid state batteries, and a second critical modulus (K*); where the second decomposition energy is more negative than the first decomposition energy, and local decomposition of the second solid state electrolyte raises the second local effective modulus to locally above the second critical modulus.

In some embodiments, the solid state electrolyte multilayer is under mechanical constriction. In particular embodiments, the mechanical constriction generates a local stress of about 0.1 GPa to about 250 GPa on the multilayer. In certain embodiments, the battery is under external pressure of about 0.1 MPa to about 1000 MPa. Pressure can vary, or be varied, periodically during battery cycling, e.g., by a passive response system, e.g., springs, e.g., with spring constants determined to apply a particular pressure, or, e.g., an active response system, e.g., configured to adjust pressure in real-time, e.g., as monitored by pressure sensors. In some embodiments, the mechanical constriction is produced by warm isotropic pressing (WIP), cold isotropic pressing (CIP), hydraulic cold pressing, or external pressure applied to the battery during assembly, e.g., a formation pressure from cold and/or hot and/or warm isotropic and/or anisotropic press and/or rolling with the external pressure of about 0.1 MPa to 1000 MPa and temperature at about 25° C.-1000° C.

In some embodiments, the porosity of the anode, cathode, and/or multilayer is 0%-25%. In some embodiments, the external pressure is provided by mechanical stress from a battery case or a pouch cell and/or from a hydraulic press made by a gel or liquid sealed in an environment within a case, cell, or press. In some embodiments, the battery case or pouch cell includes steel, aluminum, a polymer, a spring system, an electronic pressurization system with pressure sensors, and/or a combination thereof.

In some embodiments, the anode includes Li or Na metal. In some embodiments, the anode further includes a protective layer, e.g., including silicon, silicon dioxide, Li₄Ti₅O₁₂, Li₃V₂O₅, carbon (e.g., amorphous carbon, carbon nanotube, graphene, carbon nanofiber, fullerenes (e.g., C₆₀ fullerene), hard carbon, or graphite), Au, Ag, Sn, SnO₂, or a combination thereof. The particle size of the protection materials can be 1 nm to 100 μm. The protection layer can be mixed with the Li metal and/or polymer with a thickness of 0 μm-500 μm. In some embodiments, the anode further includes Li, Na, Mg, Al, Si, K, Ca, Sc, Ti, V, Cr, Mn, Fe, Co, Ni, Cu, Zn, Ga, Ge, As, Rb, Sr, Y, Zr, Nb, Mo, Ag, Cd, In, Sn, Sb, Bi, Cs, Te, or a combination thereof (e.g., as an alloy). In some embodiments, the anode includes Li, Na, Mg, Al, Si, K, Ca, Sc, Ti, V, Cr, Mn, Fe, Co, Ni, Cu, Zn, Ga, Ge, As, Rb, Sr, Y, Zr, Nb, Mo, Ag, Cd, In, Sn, Sb, Bi, Cs, Te, or a combination thereof in a protective layer. The lithium metal can also mix or alloy with these elements to form one single layer. The mixture of Li and other metal can form a 2D parallel layer or a 3D structure. The loading of the Li or Na in the anode can be 0-50 mg/cm². The thickness of the Li or Na in the anode can be 0 μm-1000 μm. 0 μm means the battery can be made with an anode-free design, where Li or Na source is from the cathode material.

In certain embodiments, the cathode includes LiNi_{0.8}Mn_{0.1}Co_{0.1}O₂ (NMC811), LiNi_{0.33}Mn_{0.33}Co_{0.33}O₂ (NMC111), LiNi_{0.5}Mn_{0.3}Co_{0.2}O₂ (NMC532), LiNi_{0.6}Mn_{0.2}Co_{0.2}O₂ (NMC622), LiNi_{0.9}Mn_{0.05}Co_{0.05}O₂ (NMC955), LiNiₓMn_{y}Co_{(1-x-y)}O₂ (0≤x,y≤1), LiNiₓCo_{y}Al_{(1-x-y)}O₂ (0≤x,y≤1), LiMn₂O₄, LiMnO₂, LiNiO₂, Li_{1+z}NiₓMn_{y}Co_{(1-x-y-z)}O₂ (0≤x,y,z≤1), Li_{1+z}NiₓMn_{y}Co_{w}Al_{(1-x-y-z-s)}O₂ (0≤x,y,z,s≤1), Li_{1+z}NiₓMn_{y}CoₛW_{(1-x-y-z-s)}O₂ (0≤x,y,z,w≤1), V₂O₅, selenium, sulfur, selenium-sulfur compound, LiCoO₂(LCO), LiFePO₄, LiNi_{0.5}Mn_{1.5}O₄, Li₂CoPO₄F, LiNiPO₄, Li₂Ni(PO₄)F, LiMnF₄, LiFeF₄, or LiCo_{0.5}Mn_{1.5}O₄. The cathode can be coated with LiNbO₃, LiTaO₃Li₂ZrO₃, LiNbₓTa₁₋ₓO₃ (0≤x≤1), yLi₂ZrO₃-(1-y)LiNbₓTa₁₋ₓO₃ (0≤x, y≤1), Al₂O₃, TiO₂, ZrO₂, AlF₃, MgF₂, SiO₂, ZnS, ZnO, Li₄SiO₄Li₃PO₄. Li₃InCl₆, Li₁₋ₓAlₓTi₂₋ₓ(PO₄)₃ (0<x<2), LiMn₂O₄, LiInO₂—LiI, Li₆PS₅Cl, LiAlO₂, a polymer, or carbon. In some embodiments, the cathode includes a polymer and/or carbon black, or the first and/or second solid electrolytes include a polymer.

In certain embodiments, the first solid state electrolytes is selected from Table 1, or the solid electrolytes of Table 1 with one or more elements replaced by a homogeneous element:

TABLE 1

| Solid State | |
|---|---|
| Electrolyte | Chemical formula |
| 1 | Li₆PS₅Cl |
| 2 | Li_{6±y}PS_{5±y}Cl_{1±y} |
| 3 | Li_{5.5}PS_{4.5}Cl_{1.5} |
| 4 | Li_{5.5±y}PS_{4.5±y}Cl_{1.5±y} |
| 5 | Li_{6±y}PS_{5±y}Br_{1±y} |
| 6 | Li_{6±y}PS_{5±y}I_{1±y} |
| 7 | Li_{6±y}PS_{5±y}F_{1±y} |
| 8 | Li₆PS₅Cl₁₋ₓFₓ (0 ≤ x ≤ C) |
| 9 | Li_{6±y}PS_{5±y}(Cl₁₋ₓFₓ)_{1±y} (0 ≤ x ≤ C) |
| 10 | Li_{6±y}PS_{5±y}(Cl₁₋ₓBrₓ)_{1±y} (0 ≤ x ≤ C) |
| 11 | Li_{6±y}PS_{5±y}(Cl₁₋ₓIₓ)_{1±y} (0 ≤ x ≤ C) |
| 12 | Li_{6±y}PS_{5±y}(BrᵤIᵥF_{w}Cl_{1-u-v-w})_{1±y} (0 ≤ u, v, w ≤ C) |
| 13 | LiₓP_{y}S_{z}(BrᵤIᵥF_{w}Cl_{1-u-v-w})ₚ (0 ≤ u, v, w ≤ C, |
| | 0 ≤ x, y, z, p ≤ 7) |
| 14 | Li₇P₂S₈I |
| 15 | Li₃PS₄ |
| 16 | Li_{3±x}P_{1±y}S_{4±z} |
| 17 | 54Li₃PS₄—46LiI |
| 18 | xLi₃PS₄—(1 − x)LiI |
| 19 | Li_{9.6}P₃S₁₂ |
| 20 | Li₃ClO |
| 21 | Li₃BrO |
| 22 | Li₃BrₓCl₁₋ₓO |
| 23 | Li₇La₃Zr₂O₁₂ |
| 24 | Li_{6.75}La₃Zr_{1.75}Ta_{0.5}O₁₂ |
| 25 | Li_{6.75±x}La_{s±y}Zr_{1.75±z}Ta_{0.5±u}O_{12±v} |
| 26 | Li_{6.25}Al_{0.25}La₃Zr₂O₁₂ |
| 27 | Li_{6.25±x}Al_{0.25±y}La_{3±z}Zr_{2±u}O_{12±v} |
| 28 | Li_{6.3}La₃Zr_{1.65}W_{0.35}O₁₂ |
| 29 | Li_{6.3±x}La_{3±y}Zr_{1.65±z}W_{0.35±u}O_{12±v} |
| 30 | Li_{6.5}La₃Zr_{1.5}Nb_{0.5}O₁₂ |
| 31 | Li_{6.5±x}La_{3±y}Zr_{1.5±z}Nb_{0.5±u}O_{12±v} |
| 32 | LiₓPO_{y}N_{z} (0 < x = 2y + 3z − 5 ≤ 3) |
| 33 | Li_{6.4}Ga_{0.2}La₃Zr₂O₁₂ |
| 34 | Li_{6.4±x}Ga_{0.2±y}La_{3±u}Zr_{2±v}O_{12±w} |
| 35 | Li₃PO₄ |
| 36 | Li₃YCl₆ |
| 37 | Li₃YBr₆ |
| 38 | Li₃InCl₆ |
| 39 | Li₃InBr₆ |
| 40 | Li₃ErCl₆ |
| 41 | Li₃ErBr₆ |
| 42 | Li₃ScCl₆ |
| 43 | Li₃ScBr₆ |
| 44 | Li₃(YₓIn_{y}Sc_{1-x-y})(FᵤBrᵥCl₁₋ᵤ₋ᵥ)₆ |

The second solid state electrolyte may be selected from Table 2, or the solid electrolytes of Table 1 with one or more elements replaced by a homogeneous element:

TABLE 2

| Solid State | |
|---|---|
| Electrolyte | Chemical Formula |
| 1 | Li₁₀GeP₂S₁₂ |
| 2 | Li_{10±x}Ge_{1±y}P_{2±p}S_{12±q} |
| 3 | Li_{10±x}Ge_{1±y}PₚSb₂₋ₚ)S_{12±q} |
| 4 | Li₁₀SiP₂S₁₂ |
| 5 | Li_{10±x}Si_{1±y}P_{2±p}S_{12±q} |
| 6 | Li₁₀SnP₂S₁₂ |
| 7 | Li_{10±x}Sn_{1±y}P_{2±p}S_{12±q} |
| 8 | Li_{10±x}Sn_{1±y}(PₚSb₂₋ₚ)S_{12±q} |
| 9 | Li_{6±y}P₍₁₋ₓ₎SbₓS_{5±y}(BrᵤIᵥF_{w}Cl_{1-u-v-w})_{1±y} |
| | (x ≥ C, 0 ≤ u, v, w ≤ 1) |
| 10 | Li_{6±y}P₍₁₋ₓ₎SbₓS_{5±y}(BrᵤIᵥF_{w}Cl_{1-u-v-w})_{1±y} |
| | (u, v, w ≥ C, 0 ≤ x ≤ 1) |
| 11 | Li_{3±x}P_{1±y}S_{4±z} |
| 12 | Li_{9.54}Si_{1.74}P_{1.44}S_{11.7}Cl_{0.3} |
| 13 | Li_{10±x}Si_{1±y}P_{2±p}S_{12±q}Cl_{w} |
| 14 | Li_{9.54} Si_{1.74}(PₓSb₁₋ₓ)_{1.44}S_{11.7}Cl_{0.3} |
| 15 | Li_{10±x}Si_{1±y}PₓSb₁₋ₓ)_{2±p}S_{12±q}Cl_{w} |
| 16 | Li_{10±x}Si_{1±y}(PₓSb₁₋ₓ)_{2±p}S_{12±q}(FᵤBrᵥI_{w}Cl_{1-u-v-w})_{z} |
| 17 | Li_{10±x}(SiₐSn_{b}Ge_{1-a-b})_{1±y}((PₓSb₁₋ₓ)_{2±p}(S_{d}Se_{1-d})_{12±q} |
| | (FᵤBrᵥI_{w}Cl_{1-u-v-w})_{z} |
| 18 | Li_{3.2}P_{0.8}Sn_{0.2}S₄ |
| 19 | Li_{3.2±x}P_{0.8±y}Sn_{0.2±z}S_{4±u} |
| 20 | Li₇P₃S₁₁ |
| 21 | 75Li₂S—25P₂S₅ |
| 22 | (x)Li₂S—(1 − x)P₂S₅ |
| 23 | Li₇Ge₃PS₁₂ |
| 24 | L_{1.5}Al_{0.5}Ti_{1.5}(PO₄)₃ |
| 25 | Li_{7±x}Ge_{3±y}P_{1±z}S_{12±u} |
| 26 | Li₆PS₅Cl₁₋ₓFₓ (x ≥ C) |
| 27 | Li_{6±y}PS_{5±y}(Cl₁₋ₓFₓ)_{1±y} (x ≥ C) |
| 28 | Li_{6±y}PS_{5±y}(Cl₁₋ₓBrₓ)_{1±y} (x ≥ C) |
| 29 | Li_{6±y}PS_{5±y}(Cl₁₋ₓIₓ)_{1±y} (x ≥ C) |
| 30 | Li_{6±y}PS_{5±y}(BrᵤIᵥF_{w}Cl_{1-u-v-w})_{1±y} (u, v, w ≥ C) |
| 31 | LiₓP_{y}S_{z}(BrᵤIᵥF_{w}Cl_{1-u-v-w})ₚ (u, v, w ≥ C, 0 ≤ x, y, z, p ≤ 7) |
| 32 | nLiX-xACl₃-(1 − x)GaF₃ |
| | (n = 2, 3, 4, X = Cl, Br, A = La, In) |
| 33 | nLiCl—LiOH—GaF₃ (n = 2, 3, 4) |
| 34 | nLiX-GaF₃ (X = Cl, Br, n = 2, 3, 4) |

where 0≤a, b, d, p, q, w, x, y, z, u, v, and w≤1 unless otherwise specified, where C is the critical doping content, above which the electrolyte become less stable, and where C can be varied for u, v, and w; 0≤C≤1.

In some embodiments, the anode includes Na metal. In some embodiments, the first solid state electrolyte is selected from Table 3, or the solid electrolytes of Table 3 with one or more elements replaced by a homogeneous element:

TABLE 3

| Solid State | |
|---|---|
| Electrolyte | Chemical Formula |
| 1 | Na₃PS₄ |
| 2 | Na_{3±x}P_{1±y}S_{4±z} |
| 3 | Na_{2.9375}PS_{3.9375}Cl_{0.0625} |
| 4 | Na_{3±x}P_{1±y}S_{4±z}Cl_{w} |
| 5 | Na_{3±x}(P₁₋ᵤ₋ᵥSbᵤWᵥ) _{1±y} (S_{1-w}Se_{w}) _{4±z} |
| | (O ≤ u, v, w < C) |
| 6 | Na₃YCl₆ |
| 7 | Na₃YBr₆ |
| 8 | Na₃InCl₆ |
| 9 | Na₃InBr₆ |
| 10 | Na₃ErCl₆ |
| 11 | Na₃ErBr₆ |
| 12 | Na₃ScCl₆ |
| 13 | Na₃ScBr₆ |
| 14 | Na₃(YₓIn_{y}Sc_{1-x-y}) (FᵤBrᵥCl₁₋ᵤ₋ᵥ)₆ |
| 15 | Na₃(YₓIn_{y}Sc_{z}X_{1-x-y-}z) (FᵤBrᵥCl₁₋ᵤ₋ᵥ)₆ |
| | (X = transition metal) |

and/or the second solid state electrolyte is selected from Table 4, or the solid electrolytes of Table 4 with one or more elements replaced by a homogeneous element:

TABLE 4

| Solid State | |
|---|---|
| Electrolyte | Chemical Formula |
| 1 | Na₁₀GeP₂S₁₂ |
| 2 | Na_{10±x}Ge_{1±y}P_{2±p}S_{12±q} |
| 3 | Na_{10±x}Ge_{1±y}(PₚSb₂₋ₚ)S_{12±q} |
| 4 | Na_{10±x}(GeᵤSi_{z}Sn_{1-u-z})_{1±y}(PᵥAsᵢSb₁₋ᵥ₋ᵢ)_{2±p} |
| | (S_{w}Se_{1-w})_{12±q} |
| 5 | Na_{2.88}Sb_{0.88}W_{0.12}S₄ |
| 6 | Na_{2.88±x} Sb_{0.88±y} W_{0.12±z} S_{4±w} |
| 7 | Na_{3±x}(P₁₋ᵤ₋ᵥSbᵤWᵥ) _{1±y} (S_{1-w}Se_{w}) _{4±z} (u, v, w ≥ C) |

where 0≤p, q, w, x, y, z, u, v, and w≤1 unless otherwise specified, where C is the critical doping content above which the electrolyte become less stable, and where C can be varied for u, v, and w; 0≤C≤1.

In some embodiments, the anode includes Na; where the anode further includes a protective layer including graphite, silicon, silicon dioxide, Na₄Ti₅O₁₂, Na₃V₂O₅, Au, Ag, Sn, SnO₂, or carbon, or a combination thereof; and/or where the protective layer includes Na metal or a mixture of Na metal and/or polymer with a thickness of 0 μm-500 μm. The particle size of the protection materials can be 1 nm to 100 μm, e.g., about 1-100 nm (e.g., about 1-10 nm, 1-25 nm, 10-20 nm, 20-30 nm, 25-50 nm, 30-40 nm, 40-50 nm, 50-60 nm, 50-75 nm, 60-70 nm, 70-80 nm, 75-100 nm, 80-90 nm, or 90-100 nm, e.g., about 1 nm, 5 nm, 10 nm, 20 nm, 30 nm, 40 nm, 50 nm, 60 nm, 70 nm, 80 nm, 90 nm, or 100 nm), e.g., about 100-1000 nm (e.g., about 100-110 nm, 100-125 nm, 100-200 nm, 200-300 nm, 250-500 nm, 300-400 nm, 400-500 nm, 500-600 nm, 500-750 nm, 600-700 nm, 700-800 nm, 750-1000 nm, 800-900 nm, or 900-1000 nm, e.g., about 100 nm, 200 nm, 300 nm, 400 nm, 500 nm, 600 nm, 700 nm, 800 nm, 900 nm, or 1000 nm), e.g., about 1-10 μm (e.g., about 1-2 μm, 1-5 nm, 2-3 μm, 3-4 μm, 4-5 μm, 5-10 μm, 5-6 μm, 6-7 μm, 7-8 μm, 8-9 μm, or 9-10 μm, e.g., about 1 μm, 2 μm, 3 μm, 4 μm, 5 μm, 6 μm, 7 μm, 8 μm, 9 μm, or 10 μm), or, e.g., about 10-100 μm (e.g., about 10-20 μm, 10-25 μm, 10-50 μm, 20-30 μm, 25-50 μm, 30-40 μm, 40-50 μm, 50-60 μm, 50-75 μm, 60-70 μm, 75-100 μm, 70-80 μm, 80-90 μm, or 90-100 μm, e.g., about 10 μm, 12 μm, 13 μm, 14 μm, 15 μm, 16 μm, 17 μm, 18 μm, 19μ, 20μ, 21μ, 22 μm, 23 μm, 24 μm, 25μ, 26μ, 27μ, 28μ, 29μ, 30 μm, 40 μm, 50 μm, 60 μm, 70 μm, 80 μm, 90 μm, or 100 μm). In some embodiments, the carbon includes hard carbon, amorphous carbon, carbon nanotube, graphene, carbon nanofiber, or a fullerene (e.g., C₆₀). In some embodiments, the sodium metal in the protection layer is mixed or alloyed with Li, Mg, Al, Si, K, Ca, Sc, Ti, V, Cr, Mn, Fe, Co, Ni, Cu, Zn, Ga, Ge, As, Rb, Sr, Y, Zr, Nb, Mo, Ag, Cd, In, Sn, Sb, Bi, Cs, Te, or a combination thereof. In some embodiments, the cathode includes Na_{w}MnO₂, Na_{w}CoO₂, Na_{w}NiO₂, Na_{w}TiO₂, Na_{w}VO₂, Na_{w}CrO₂, Na_{w}FeO₂, Na_{w}(MnₓFe_{y}Co_{z}Ni_{1-x-y-z})O₂ (0≤x,y,z≤1), Na_{w}(M)PO₄, Na_{w}(M)P₂O₇, Na_{w}(M)O₂, NaₓM_{y}(XO₄)_{z}; where M is a metal element or a combination of metal elements, e.g., transition metal elements; where X is B, S, P, Si, As, Mo, W, or a combination thereof; where 0≤x,y,z≤3; 0<w≤1; and where O can be partially replaced by F, Cl, Br, or I. In some embodiments, the cathode includes a coating of NaNbO₃, NaTaO₃, Na₂ZrO₃, NaNbₓTa₁₋ₓO₃ (0≤x≤1), yNa₂ZrO₃-(1-y)NaNbₓTa₁₋ₓO₃ (0≤x, y≤1), Al₂O₃, TiO₂, ZrO₂, AlF₃, MgF₂, SiO₂, ZnS, ZnO, Na₄SiO₄, NasPO₄, NasInCl₆, Na₁₊ₓAlₓTi₂₋ₓ(PO₄)₃ (0<x<2), NaMn₂O₄, NaInO₂—NaI, Na₆PS₅Cl, NaAlO₂, or carbon.

In some embodiments, the battery can cycle at a current density from 0.001 mA/cm² to 100 mA/cm². In some embodiments the battery retains at least 80% of capacity after at least 10,000 charge-discharge cycles from 20C-rate to 100C-rate, e.g., 2 mg/cm² cathode loading, with an initial capacity higher than 80 mAh/g and a current density higher than 8 mA/cm². In particular embodiments, the solid state electrolyte multilayer includes at least two different first solid state electrolytes. In some embodiments, the battery cathode material has a power density of at least 10 kW/kg. In some embodiments, the battery cathode material has an energy density of at least 600 Wh/kg.

In some embodiments, the first and/or second solid state electrolyte has a core-shell particle structure. In certain embodiments, the core-shell particles have a core conductivity and a shell conductivity that are different. In some embodiments, the core conductivity is higher than the shell conductivity. In some embodiments, the core-shell particles have a core composition and a shell composition, and the core composition is different from the shell composition, e.g., having different non-stoichiometric weightings of, e.g., Li or Na. The different core and shell compositions can provide different properties, e.g., K*, Eₕᵤₗₗ, conductivity, etc., e.g., the shell composition may have a smaller K* or a more negative Eₕᵤₗₗ than the core, or, e.g., the core conductivity may be higher than the shell conductivity, or any combination thereof.

In some embodiments, the first solid state electrolyte includes a material selected from Table 5 or Table 6, or a material having a formula of a material selected from Table 5 or Table 6 with one or more elements replaced with an element of equal group number:

TABLE 5

| | |
|---|---|
| 1 | Li_{0.3} Cl_{0.6} Er_{0.1} |
| 2 | Li_{0.3} Cl_{0.6} Y_{0.1} |
| 3 | Li_{0.3} Cl_{0.6} Sc_{0.1} |
| 4 | Li_{0.291} O_{0.5} Zr_{0.083} La_{0.125} |
| 5 | Li_{0.271} O_{0.508} Ga_{0.008} Zr_{0.084} La_{0.127} |
| 6 | Li_{0.265} O_{0.510} Al_{0.010} Zr_{0.085} La_{0.127} |
| 7 | Li_{0.276} O_{0.510} Zr_{0.063} Nb_{0.021} La_{0.127} |
| 8 | Li_{0.270} O_{0.515} Zr_{0.070} La_{0.128} W_{0.015} |

TABLE 6

| | |
|---|---|
| 1 | Li_{0.400 − x} B_{0.000 − y} O_{0.000 − z} Al_{3.503 + w} |
| | Si_{0.133 − l} S_{0.465 − m} |
| 2 | Li_{0.3 + x} Cl_{0.6 − y} Sc_{0.1 − z} |
| 3 | Li_{0.3 + x} Cl_{0.6 − y} In_{0.1 − z} |
| 4 | Li_{0.3 + x} Cl_{0.6 − y} Er_{0.1 − z} |
| 5 | Li_{0.3 + x} Cl_{0.6 − y} Y_{0.1 − z} |
| 6 | Li_{0.444 + x} S_{0.444 − y} Sn_{0.111 − z} |
| 7 | Li_{0.44 + x} P_{0.08 − y} S_{0.36 − z} Cl_{0.12 − w} |
| 8 | Li_{0.270 + x} O_{0.515 − y} Zr_{0.070 − z} La_{0.128 + w} |
| | W_{0.015 − l} |
| 9 | Li_{0.265 + x} O_{0.510 − y} Al_{0.010 − z} Zr_{0.085 + w} |
| | La_{0.127 + l} |
| 10 | Li_{0.291 + x} O_{0.5 − y} Zr_{0.083 − z} La_{0.125 − w} |
| 11 | Li_{0.276 + x} O_{0.510 − y} Zr_{0.063 + z} Nb_{0.021 − w} |
| | La_{0.127 + l} |
| 12 | Li_{0.166 + x} B_{0.166 − y} O_{0.5 − z} Al_{0.125 + w} |
| | Cl_{0.041 + l} |

Additionally or alternatively, the second solid state electrolyte includes a material selected from Table 7 or Table 8, or a material having a formula of a material selected from Table 5 or Table 6 with one or more elements replaced with an element of equal group number:

TABLE 7

| | |
|---|---|
| 1 | Li_{0.6} O_{0.2} Cl_{0.2} |
| 2 | Li_{0.6} O_{0.2} Br_{0.2} |
| 3 | Li_{0.3} Br_{0.6} Er_{0.1} |
| 4 | Li_{0.3} Br_{0.6} Y_{0.1} |
| 5 | Li_{0.3} Sc_{0.1} Br_{0.6} |
| 6 | Li_{0.3} Br_{0.6} In_{0.1} |
| 7 | Li_{0.375} O_{0.5} P_{0.125} |
| 8 | Li_{0.3} Cl_{0.6} In_{0.1} |
| 9 | Li_{0.166} B_{0.166} O_{0.5} Al_{0.125} Cl_{0.041} |
| 10 | Li_{0.444} S_{0.444} Sn_{0.111} |
| 11 | Li_{0.416} Si_{0.106} S_{0.363} I_{0.113} |
| 12 | Li_{0.428} P_{0.142} S_{0.428} |
| 13 | Li_{0.485} P_{0.029} S_{0.367} Ge_{0.044} I_{0.073} |
| 14 | Li_{0.433} S_{0.452} As_{0.018} Sn_{0.094} |
| 15 | Li_{0.325} B_{0.181} S_{0.377} I_{0.115} |
| 16 | Li_{0.475} Si_{0.026} P_{0.048} S_{0.374} Br_{0.074} |
| 17 | Li_{0.461} O_{0.076} P_{0.076} S_{0.307} Cl_{0.076} |
| 18 | Li_{0.400} B_{0.000} O_{0.000} Al_{3.503} Si_{0.133} S_{0.465} |
| 19 | Li_{0.461} P_{0.076} S_{0.384} I_{0.076} |
| 20 | Li_{0.44} P_{0.08} S_{0.36} Cl_{0.108} Br_{0.012} |
| 21 | Li_{0.44} P_{0.08} S_{0.36} Cl_{0.108} I_{0.012} |
| 22 | Li_{0.44} P_{0.08} S_{0.36} Cl_{0.12} |
| 23 | Li_{0.388} P_{0.111} S_{0.444} I_{0.055} |
| 24 | Li_{0.4} P_{0.08} S_{0.48} Sn_{0.04} |
| 25 | Li_{0.4} P_{0.08} S_{0.48} Sn_{0.04} |
| 26 | Li_{0.5} P_{0.071} S_{0.428} |
| 27 | Li_{0.461} P_{0.076} S_{0.384} Cl_{0.076} |
| 28 | Li_{0.308} P_{0.153} S_{0.536} I_{0.001} |
| 29 | Li_{0.333} P_{0.138} S_{0.509} Mn_{0.004} I_{0.014} |
| 30 | Li_{0.310} P_{0.152} S_{0.537} |
| 31 | Li_{0.385} Si_{0.070} P_{0.058} S_{0.473} Cl_{0.012} |
| 32 | Li_{0.423} Al_{0.038} P_{0.076} S_{0.461} |
| 33 | Li_{0.385} Si_{0.070} P_{0.052} S_{0.473} Cl_{0.012} Sb_{0.005} |
| 34 | Li_{0.304} P_{0.043} S_{0.521} Ge_{0.130} |
| 35 | Li_{0.333} P_{0.142} S_{0.523} |
| 36 | Li_{0.333} P_{0.142} S_{0.523} |
| 37 | Li_{0.333} P_{0.142} S_{0.523} |
| 38 | Li_{0.390} P_{0.097} S_{0.487} Sn_{0.024} |
| 39 | Li_{0.481} P_{0.074} S_{0.407} Cl_{0.037} |
| 40 | Li_{0.44} F_{0.032} P_{0.08} S_{0.36} Cl_{0.088} |
| 41 | Li_{0.4} P_{0.08} S_{0.48} Ge_{0.04} |
| 42 | Li_{0.337} P_{0.139} S_{0.522} Mo_{0.000} |
| 43 | Li_{0.461} P_{0.076} S_{0.384} Br_{0.076} |
| 44 | Li_{0.4} Si_{0.04} P_{0.08} S_{0.48} |
| 45 | Li_{0.4} Si_{0.04} P_{0.08} S_{0.48} |
| 46 | H_{0.004} Li_{0.373} B_{0.001} P_{0.124} S_{0.496} |
| 47 | Li_{0.393} P_{0.090} S_{0.484} Ge_{0.030} |
| 48 | Li_{0.375} P_{0.125} S_{0.5} |
| 49 | Li_{0.260} P_{0.173} S_{0.565} |
| 50 | Li_{0.390} P_{0.121} S_{0.487} |
| 51 | Li_{0.081} O_{0.648} Al_{0.027} P_{0.162} Ti_{0.081} |

TABLE 8

| | |
|---|---|
| 1 | Li_{0.6 + x} O_{0.2 + y} Br_{0.2 − z} |
| 2 | Li_{0.6 − x} O_{0.2 − y} Cl_{0.2 + z} |
| 3 | Li_{0.3 + x} Br_{0.6 − y} In_{0.1 − z} |
| 4 | Li_{0.3 + x} Br_{0.6 − y} Y_{0.1 − z} |
| 5 | Li_{0.3 + x} Br_{0.6 − y} Er_{0.1 − z} |
| 6 | Li_{0.416 + x} Si_{0.106 + y} S_{0.363 − z} I_{0.113 − w} |
| 7 | Li_{0.3 + x} Sc_{0.1 − y} Br_{0.6 − z} |
| 8 | Li_{0.166 + x} B_{0.166 − y} O_{0.5 − z} Al_{0.125 + w} Cl_{0.041 + l} |
| 9 | Li_{0.375 + x} O_{0.5 − y} P_{0.125 − z} |
| 10 | Li_{0.485 + x} P_{0.029 − y} S_{0.367 − z} Ge_{0.044 + w} I_{0.073 − l} |
| 11 | Li_{0.5 + x} P_{0.071 − y} S _{0.428 − z} |
| 12 | Li_{0.461 + x} P_{0.076 − y} S_{0.384 − z} I_{0.076 − w} |
| 13 | Li_{0.433 + x} S_{0.452 − y} As_{0.018 − z} Sn_{0.094 − w} |
| 14 | Li_{0.481 + x} P_{0.074 − y} S _{0.407 − z} Cl_{0.037 − w} |
| 15 | Li_{0.461 + x} O_{0.076 + y} P_{0.076 − z} S_{0.307 − w} Cl_{0.076 − l} |
| 16 | Li_{0.475 + x} S_{0.026 + y} P_{0.048 − z} S_{0.374 − w} Br_{0.074 − l} |
| 17 | Li_{0.461 + x} P_{0.076 − y} S_{0.384 − z} Br_{0.076 + w} |
| 18 | Li_{0.461 + x} P_{0.076 − y} S_{0.384 − z} Cl_{0.076 − w} |
| 19 | Li_{0.44 + x} P_{0.08 − y} S_{0.36 − z} Cl_{0.108 − w} Br_{0.012 + l} |
| 20 | Li_{0.44 + x} P_{0.08 − y} S_{0.36 − z} Cl_{0.108 − w} I_{0.012 + l} |
| 21 | Li_{0.428 + x} P_{0.142 − y} S_{0.428 − z} |
| 22 | Li_{0.423 + x} Al_{0.038 + y} P__{0.076 − z} S_{0.461 − w} |
| 23 | Li_{0.4 + x} Si_{0.04 + y} P_{0.08 − z} S_{0.48 − w} |
| 24 | Li_{0.4 + x} SI_{0.04 + y} P_{0.08 − z} S_{0.48 − w} |
| 25 | Li_{0.44 + x} F_{0.032 − y} P_{0.08 − z} S_{0.36 − w} Cl_{0.088 − l} |
| 26 | Li_{0.4 + x} P_{0.08 − y} S_{0.48 − z} Sn_{0.04 + w} |
| 27 | Li_{0.4 + x} P_{0.08 − y} S_{0.48 − z} Sn_{0.04 + w} |
| 28 | Li_{0.385 + x} Si_{0.070 + y} P_{0.058 − z} S_{0.473 − w} Cl_{0.012 − l} |
| 29 | Li_{0.388 + x} P_{0.111 + y} S_{0.444 − z} I_{0.055 + w} |
| 30 | Li_{0.385 + x} Si_{0.070 + y} P_{0.052 − z} S_{0.473 − w} Cl_{0.012 − l} Sb_{0.005 − m} |
| 31 | Li_{0.310 + x} P_{0.152 + y} S_{0.537 − z} |
| 32 | Li_{0.375 + x} P_{0.125 + y} S_{0.5 − z} |
| 33 | Li_{0.308 + x} P_{0.153 + y} S_{0.536 − z} I_{0.001 − w} |
| 34 | Li_{0.333 + x} P_{0.142 + y} S_{0.523 − z} |
| 35 | Li_{0.333 + x} P_{0.142 + y} S_{0.523 − z} |
| 36 | Li_{0.333 + x} P_{0.142 + y} S_{0.523 − z} |
| 37 | Li_{0.333 + x} P_{0.138 + y} S_{0.509 − z} Mn_{0.004 − w} I_{0.014 + l} |
| 38 | Li_{0.260 + x} P_{0.173 + y} S_{0.565 − z} |
| 39 | Li_{0.390 + x} P_{0.121 + y} S_{0.487 − z} |
| 40 | Li_{0.337 + x} P_{0.139 + y} S_{0.522 − z} Mo_{0.000 + w} |
| 41 | Li_{0.390 + x} P_{0.097 + y} S_{0.487 − z} Sn_{0.024 + w} |
| 42 | H_{0.004 + x} Li_{0.373 + y} B_{0.001 − z} P_{0.124 + w} S_{0.496 − l} |
| 43 | Li_{0.393 + x} P_{0.090 + y} S_{0.484 − z} Ge_{0.030 + w} |
| 44 | Li_{0.4 + x} P_{0.08 + y} S_{0.48 − z} Ge_{0.04 + w} |
| 45 | Li_{0.304 + x} P_{0.043 + y} S_{0.521 − z} Ge_{0.130 + w} |
| 46 | Li_{0.325 − x} B_{0.181 + y} S_{0.377 + z} I_{0.115 − w} |
| 47 | Li_{0.081 + x} O_{0.648 − y} Al_{0.027 + z} P_{0.162 − w} Ti_{0.081 − l} |

In Tables 5-8 ‘_{#}’ and ‘_{#±x, y, z, w, l, or m}’ represent non-stoichiometric weightings of an element immediately to the left of ‘_{#}’ or ‘_{#±x, y, z, w, l, or m}’ in a chemical formula of the material, where # can be in the range of #±n, wherein 0≤n≤0.5, where 0≤x, y, z, w, l, and m≤#, and where # can be ±n, 0≤n≤0.5.

In some embodiments, the first solid state electrolyte includes a material selected from Table 9 or Table 10, or a material having a formula of a material selected from Table 9 or Table 10 with one or more elements replaced with an element of equal group number:

TABLE 9

| | |
|---|---|
| 1 | Na_{0.300} Cl_{0.600} Y_{0.100} |
| 2 | O_{0.2} Na_{0.6} Br_{0.2} |
| 3 | Na_{0.291} Cl_{0.607} Y_{0.088} Zr_{0.012} |
| 4 | Na_{0.282} Cl_{0.615} Y_{0.076} Zr_{0.025} |
| 5 | H_{0.600} Na_{0.300} Al_{0.100} |
| 6 | H_{0.46} B_{0.46} Na_{0.08} |
| 7 | O_{0.6} Al_{0.4} |
| 8 | H_{0.458} B_{0.458} Na_{0.083} |
| 9 | O_{0.588} Na_{0.166} Si_{0.098} P_{0.049} Sc_{0.019} |
| | Zr_{0.078} |
| 10 | H_{0.666} Na_{0.166} Al_{0.166} |
| 11 | O_{0.614} Na_{0.067} Zr_{0.204} La_{0.112} |
| 12 | H_{0.454} B_{0.454} Na_{0.090} |
| 13 | O_{0.6} Na_{0.15} Si_{0.1} P_{0.05} Zr_{0.1} |
| 14 | Na_{0.272} Cl_{0.623} Y_{0.064} Zr_{0.038} |
| 15 | O_{0.588} Na_{0.166} Si_{0.098} P_{0.049} Zn_{0.009} |
| | Zr_{0.088} |
| 16 | O_{0.601} Na_{0.066} Sr_{0.066} Zr_{0.200} La_{0.066} |
| 17 | Na_{0.263} Cl_{0.631} Y_{0.052} Zr_{0.052} |

TABLE 10

| | |
|---|---|
| 1 | Na_{0.243 + x} Cl_{0.648 − y} Y_{0.027 + z} Zr_{0.081 + w} |
| 2 | O_{0.2 + x} Na_{0.6 + y} Br_{0.2 − z} |
| 3 | Na_{0.300 − x} Cl_{0.600 − y} Y_{0.100 + z} |
| 4 | Na_{0.232 + x} Cl_{0.657 − y} Y_{0.013 + z} Zr_{0.095 + w} |
| 5 | Na_{0.263 + x} Cl_{0.631 − y} Y_{0.052 + z} Zr_{0.052 + w} |
| 6 | Na_{0.253 + x} Cl_{0.640 − y} Y_{0.040 + z} Zr_{0.066 − w} |
| 7 | Na_{0.291 − x} Cl_{0.607 + y} Y_{0.088 + z} Zr_{0.012 + w} |
| 8 | Na_{0.282 − x} Cl_{0.615 + y} Y_{0.076 + z} Zr_{0.025 − w} |
| 9 | Na_{0.272 − x} Cl_{0.623 + y} Y_{0.064 + z} Zr_{0.038 − w} |
| 10 | H_{0.600 + x} Na_{0.300 − y} Al_{0.100 + z} |
| 11 | O_{0.588 − x} Na_{0.166 + y} Si_{0.098 + z} P_{0.049 − w} |
| | Sc_{0.019 + l} Zr_{0.078 + m} |
| 12 | Na_{0.370 + x} P_{0.125 + y} S_{0.496 − z} Cl_{0.007 − w} |
| 13 | O_{0.614 − x} Na_{0.067 − y} Zr_{0.204 − z} La_{0.112 + w} |
| 14 | Na_{0.365 + x} S_{0.507 − y} Sb_{0.111 − z} W_{0.015 + w} |
| 15 | O_{0.601 − x} Na_{0.066 + y} Sr_{0.066 + z} Zr_{0.200 + w} |
| | La_{0.066 + l} |
| 16 | O_{0.588 − x} Na_{0.166 + y} Si_{0.098 + z} P_{0.049 − w} |
| | Zn_{0.009 − 1} Zr_{0.088 + m} |
| 17 | Na_{0.379 + x} Si_{0.007 − y} P_{0.116 + z} S_{0.496 − w} |
| 18 | O_{0.631 − x} Na_{0.157 + y} P_{0.157 − z} La_{0.052 + w} |
| 19 | Na_{0.347 + x} P_{0.127 + y} S_{0.508 − z} Ca_{0.017 − w} |
| 20 | Na_{0.423 + x} P_{0.038 + y} S_{0.461 − z} Sn_{0.076 − w} |
| 21 | Na_{0.375 + x} P_{0.125 + y} S_{0.5 − z} |
| 22 | O_{0.6 − x} Na_{0.16 + y} Si_{0.1 + z} P_{0.05 − w} Zr_{0.1 − l} |
| 23 | Na_{0.423 + x} S_{0.461 − y} Sn_{0.076 + z} Sb_{0.038 + w} |
| 24 | Na_{0.375 + x} S_{0.5 − y} Sb_{0.125 + z} |

Additionally or alternatively, the second solid state electrolyte includes a material selected from Table 11 or Table 12, or a material having a formula of a material selected from Table 11 or Table 12 with one or more elements replaced with an element of equal group number:

TABLE 11

| | |
|---|---|
| 1 | H_{0.444} B_{0.111} O_{0.111} Na_{0.333} |
| 2 | O_{0.142} Na_{0.571} I_{0.285} |
| 3 | Na_{0.423} P_{0.038} S_{0.461} Sn_{0.076} |
| 4 | Na_{0.379} Si_{0.007} P_{0.116} S_{0.496} |
| 5 | Na_{0.375} P_{0.125} S_{0.5} |
| 6 | Na_{0.370} P_{0.125} S_{0.496} Cl_{0.007} |
| 7 | Na_{0.347} P_{0.127} S_{0.508} Ca_{0.017} |
| 8 | O_{0.2} Na_{0.6} Br_{0.12} I_{0.08} |
| 9 | Na_{0.375} P_{0.125} Se_{0.5} |
| 10 | O_{0.202} Na_{0.585} Br_{0.121} Sr_{0.010} I_{0.080} |
| 11 | Na_{0.365} S_{0.507} Sb_{0.111} W_{0.015} |
| 12 | Na_{0.423} P_{0.038} Se_{0.461} Sn_{0.076} |
| 13 | Na_{0.423} S_{0.461} Sn_{0.076} Sb_{0.038} |
| 14 | Na_{0.375} Se_{0.5} Sb_{0.125} |
| 15 | Na_{0.375} S_{0.5} Sb_{0.125} |
| 16 | Na_{0.378} S_{0.486} Sb_{0.121} I_{0.013} |
| 17 | Na_{0.253} Cl_{0.640} Y_{0.040} Zr_{0.066} |
| 18 | Na_{0.243} Cl_{0.648} Y_{0.027} Zr_{0.081} |
| 19 | Na_{0.232} Cl_{0.657} Y_{0.013} Zr_{0.095} |
| 20 | Na_{0.222} Cl_{0.666} Zr_{0.111} |
| 21 | O_{0.631} Na_{0.157} P_{0.157} La_{0.052} |

TABLE 12

| | |
|---|---|
| 1 | H_{0.454 − x} B_{0.454 + y} Na_{0.090 + z} |
| 2 | H_{0.444 − x} B_{0.111 + y} O_{0.111 + z} Na_{0.333 − w} |
| 3 | H_{0.458 − x} B_{0.458 + y} Na_{0.083 + z} |
| 4 | H_{0.46 − x} B_{0.46 + y} Na_{0.08 + z} |
| 5 | H_{0.666 + x} Na_{0.166 − y} Al_{0.166 − z} |
| 6 | O_{0.142 + x} Na_{0.571 + y} I_{0.285 − z} |
| 7 | Na_{0.375 + x} P_{0.125 + y} Se_{0.5 − z} |
| 8 | Na_{0.378 + x} S_{0.486 − y} Sb_{0.121 − z} I_{0.013 − w} |
| 9 | O_{0.2 − x} Na_{0.6 + y} Br_{0.12 − z} I_{0.08 + w} |
| 10 | O_{0.202 + x} Na_{0.585 + y} Br_{0.121 − z} Sr_{0.010 − w} |
| | I_{0.080 + l} |
| 11 | Na_{0.375 + x} Se_{0.5 − y} Sb_{0.125 + z} |
| 12 | Na_{0.423 + x} P_{0.038 + y} Se_{0.461 − z} Sn_{0.076 + w} |
| 13 | O_{0.6 − x} Al_{0.4 + y} |
| 14 | Na_{0.222 + x} Cl_{0.666 − y} Zr_{0.111 + z} |

In Tables 9-12 ‘_{#}’ and ‘_{#±x, y, z, w, l, or m}’ represent non-stoichiometric weightings of an element immediately to the left of ‘_{#}’ or ‘_{#±x, y, z, w, l, or m}’ in a chemical formula of the material, where # can be in the range of #±n, where 0≤n≤0.5, where 0≤x, y, z, w, l, and m≤#, and where # can be ±n, 0≤n≤0.5.

5 In certain embodiments, the first or second solid state electrolyte has a core-shell particle structure, and the material of Table 6, Table 8, Table 10, or Table 12 is in the shell.

In some embodiments, the cathode is mixed with a solid state electrolyte including a material selected from Table 13 or Table 14:

TABLE 13

| | |
|---|---|
| 1 | Li_{0.375} O_{0.5} P_{0.125} |
| 2 | Li_{0.3} Br_{0.6} Er_{0.1} |
| 3 | Li_{0.166} B_{0.166} O_{0.5} Al_{0.125} Cl_{0.041} |
| 4 | Li_{0.081} O_{0.648} Al_{0.027} P_{0.162} Ti_{0.081} |
| 5 | Li_{0.3} Cl_{0.6} Er_{0.1} |
| 6 | Li_{0.3} Cl_{0.6} Y_{0.1} |
| 7 | Li_{0.3} Cl_{0.6} Sc_{0.1} |
| 8 | Li_{0.265} O_{0.510} Al_{0.010} Zr_{0.085} La_{0.127} |
| 9 | Li_{0.271} O_{0.508} Ga_{0.008} Zr_{0.084} La_{0.127} |
| 10 | Li_{0.276} O_{0.510} Zr_{0.063} Nb_{0.021} La_{0.127} |
| 11 | Li_{0.270} O_{0.515} Zr_{0.070} La_{0.128} W_{0.015} |
| 12 | Li_{0.3} Cl_{0.6} In_{0.1} |
| 13 | Li_{0.291} O_{0.5} Zr_{0.083} La_{0.125} |
| 14 | Li_{0.3} Br_{0.6} In_{0.1} |
| 15 | Li_{0.3} Sc_{0.1} Br_{0.6} |
| 16 | Li_{0.3} Br_{0.6} Y_{0.1} |
| 17 | Li_{0.260} P_{0.173} S_{0.565} |
| 18 | Li_{0.304} P_{0.043} S_{0.521} Ge_{0.130} |
| 19 | Li_{0.310} P_{0.152} S_{0.537} |
| 20 | Li_{0.308} P_{0.153} S_{0.536} I_{0.001} |
| 21 | Li_{0.333} P_{0.142} S_{0.523} |
| 22 | Li_{0.333} P_{0.142} S_{0.523} |
| 23 | Li_{0.333} P_{0.142} S_{0.523} |
| 24 | Li_{0.325} B_{0.181} S_{0.377} I_{0.115} |
| 25 | Li_{0.337} P_{0.139} S_{0.522} Mo_{0.000} |
| 26 | Li_{0.333} P_{0.138} S_{0.509} Mn_{0.004} I_{0.014} |
| 27 | Li_{0.375} P_{0.125} S_{0.5} |
| 28 | H_{0.004} Li_{0.373} B_{0.001} P_{0.124} S_{0.496} |
| 29 | Li_{0.390} P_{0.121} S_{0.487} |
| 30 | Li_{0.385} Si_{0.070} P_{0.052} S_{0.473} Cl_{0.012} Sb_{0.005} |
| 31 | Li_{0.390} P_{0.097} S_{0.487} Sn_{0.024} |
| 32 | Li_{0.385} Si_{0.070} P_{0.058} S_{0.473} Cl_{0.012} |
| 33 | Li_{0.393} P_{0.090} S_{0.484} Ge_{0.030} |
| 34 | Li_{0.4} Si_{0.04} P_{0.08} S_{0.48} |
| 35 | Li_{0.4} Si_{0.04} P_{0.08} S_{0.48} |
| 36 | Li_{0.4} P_{0.08} S_{0.48} Ge_{0.04} |
| 37 | Li_{0.388} P_{0.111} S_{0.444} I_{0.055} |
| 38 | Li_{0.400} B_{0.000} O_{0.000} Al_{3.503} Si_{0.133} S_{0.465} |
| 39 | Li_{0.4} P_{0.08} S_{0.48} Sn_{0.04} |
| 40 | Li_{0.4} P_{0.08} S_{0.48} Sn_{0.04} |
| 41 | Li_{0.423} Al_{0.038} P_{0.076} S_{0.461} |
| 42 | Li_{0.433} S_{0.452} As_{0.018} Sn_{0.094} |
| 43 | Li_{0.444} S_{0.444} Sn_{0.111} |
| 44 | Li_{0.44} P_{0.08} S_{0.36} Cl_{0.108} I_{0.012} |
| 45 | Li_{0.428} P_{0.142} S_{0.428} |
| 46 | Li_{0.44} P_{0.08} S_{0.36} Cl_{0.12} |
| 47 | Li_{0.44} F_{0.032} P_{0.08} S_{0.36} Cl_{0.088} |
| 48 | Li_{0.44} P_{0.08} S_{0.36} Cl_{0.108} Br_{0.012} |
| 49 | Li_{0.461} Q_{0.076} P_{0.076} S_{0.307} Cl_{0.076} |
| 50 | Li_{0.416} Si_{0.106} S_{0.363} I_{0.113} |
| 51 | Li_{0.6} O_{0.2} Cl_{0.2} |
| 52 | Li_{0.461} P_{0.076} S_{0.384} I_{0.076} |
| 53 | Li_{0.461} P_{0.076} S_{0.384} Cl_{0.076} |
| 54 | Li_{0.461} P_{0.076} S_{0.384} Br_{0.076} |
| 55 | Li_{0.481} P_{0.074} S_{0.407} Cl_{0.037} |
| 56 | Li_{0.475} Si_{0.026} P_{0.048} S_{0.374} Br_{0.074} |
| 57 | Li_{0.6} O_{0.2} Br_{0.2} |
| 58 | Li_{0.485} P_{0.029} S_{0.367} Ge_{0.044} I_{0.073} |
| 59 | Li_{0.5} P_{0.071} S_{0.428} |

TABLE 14

| | |
|---|---|
| 1 | Li_{0.3 + x} Cl_{0.6 − y} Er_{0.1 − z} |
| 2 | Li_{0.3 + x} Cl_{0.6 − y} Y_{0.1 − z} |
| 3 | Li_{0.081 + x} O_{0.648 − y} Al_{0.027 + z} P_{0.162 − w} Ti_{0.081 − l} |
| 4 | Li_{0.3 + x} Cl_{0.6 − y} Se_{0.1 − z} |
| 5 | Li_{0.3 + x} Br_{0.6 − y} Er_{0.1 − z} |
| 6 | Li_{0.265 + x} O_{0.510 − y} Al_{0.010 − z} Zr_{0.085 + w} La_{0.127 + l} |
| 7 | Li_{0.271 + x} O_{0.508 − y} Ga_{0.008 − z} Zr_{0.084 + w} La_{0.127 + l} |
| 8 | Li_{0.276 + x} O_{0.510 − y} Zr_{0.063 + z} Nb_{0.021 − w} La_{0.127 + l} |
| 9 | Li_{0.166 + x} B_{0.166 − y} O_{0.5 − z} Al_{0.125 + w} Cl_{0.041 + l} |
| 10 | Li_{0.291 + x} O_{0.5 − y} Zr_{0.083 − z} La_{0.125 − w} |
| 11 | Li_{0.270 + x} O_{0.515 − y} Zr_{0.070 − z} La_{0.128 + w} W_{0.015 − l} |
| 12 | Li_{0.400 − x} B_{0.000 − y} O_{0.000 − z} Al_{3.503 + w} Si {0.133 − l} S_{0.465 − m} |
| 13 | Li_{0.3 + x} Cl_{0.6 − y} In_{0.1 − z} |
| 14 | Li_{0.3 + x} Sc_{0.1 − y} Br_{0.6 − z} |
| 15 | Li_{0.3 + x} Br_{0.6 − y} Y_{0.1 − z} |
| 16 | Li_{0.3 + x} Br_{0.6 − y} In_{0.1 − z} |
| 17 | Li_{0.325 − x} B_{0.181 + y} S_{0.377 + z} I_{0.115 − w} |
| 18 | Li_{0.260 + x} P_{0.173 + y} S_{0.565 − z} |
| 19 | Li_{0.375 + x} P_{0.125 + y} S_{0.5 − z} |
| 20 | Li_{0.304 + x} P_{0.043 + y} S_{0.521 − z} Ge_{0.130 + w} |
| 21 | Li_{0.310 + x} P_{0.152 + y} S_{0.537 − z} |
| 22 | Li_{0.333 + x} P_{0.142 + y} S_{0.523 − z} |
| 23 | Li_{0.333 + x} P_{0.142 + y} S_{0.523 − z} |
| 24 | Li_{0.333 + x} P_{0.142 + y} S_{0.523 − z} |
| 25 | Li_{0.375 + x} O_{0.5 − y} P_{0.125 − z} |
| 26 | Li_{0.308 + x} P_{0.153 + y} S_{0.536 − z} I_{0.001 − w} |
| 27 | Li_{0.333 + x} P_{0.138 + y} S_{0.509 − z} Mn_{0.004 − w} I_{0.014 + l} |
| 28 | Li_{0.337 + x} P_{0.139 + y} S_{0.522 − z} Mo_{0.000 + w} |
| 29 | Li_{0.6 − x} O_{0.2 − y} Cl_{0.2 + z} |
| 30 | Li_{0.388 + x} P_{0.111 + y} S_{0.444 − z} I_{0.055 + w} |
| 31 | H_{0.004 + x} Li_{0.373 + y} B_{0.001 − z} P_{0.124 + w} S_{0.496 − l} |
| 32 | Li_{0.461 + x} O_{0.076 + y} P_{0.076 − z} S_{0.307 − w} Cl_{0.076− l} |
| 33 | Li_{0.390 + x} P_{0.097 + y} S_{0.487 − z} Sn_{0.024 + w} |
| 34 | Li_{0.393 + x} P_{0.090 + y} S_{0.484 − z} Ge {0.030 + w} |
| 35 | Li_{0.6 + x} O_{0.2 + y} Br {0.2− z} |
| 36 | Li_{0.390 + x} P_{0.121 + y} S_{0.487 − z} |
| 37 | Li_{0.4 + x} P_{0.08 + y} S_{0.48−z} Ge_{0.04 + w} |
| 38 | Li_{0.385 + x} Si_{0.070 + y} P_{0.052 − z} S_{0.473 − w} Cl_{0.012 − l} Sb_{0.005 − m} |
| 39 | Li_{0.385 + x} Si_{0.070 + y} P_{0.058 − z} S_{0.473 − w} Cl_{0.012 − l} |
| 40 | Li_{0.416 + x} Si_{0.106 + y} S_{0.363 − z} I_{0.113 − w} |
| 41 | Li_{0.461 + x} P_{0.076 − y} S_{0.384 − z} Br_{0.076 + w} |
| 42 | Li_{0.4 + x} Si_{0.04 + y} P_{0.08 − z} S_{0.48 − w} |
| 43 | Li_{0.4 + x} Si_{0.04 + y} P_{0.08 − z} S_{0.48 − w} |
| 44 | Li_{0.4 + x} P_{0.08 − y} S_{0.48 − z} Sn_{0.04 + w} |
| 45 | Li_{0.4 + x} P_{0.08 − y} S_{0.48 − z} Sn_{0.04 + w} |
| 46 | Li_{0.428 + x} P_{0.142 − y} S_{0.428 − z} |
| 47 | Li_{0.423 + x} Al_{0.038 + y} P_{0.076 − z} S_{0.461 − w} |
| 48 | Li_{0.444 + x} S_{0.444 − y} Sn_{0.111 − z} |
| 49 | Li_{0.433 + x} S_{0.452 − y} As_{0.018 − z} Sn_{0.094 − w} |
| 50 | Li_{0.485 + x} P_{0.029 − y} S_{0.367 − z} Ge_{0.044 + w} I_{0.073 − 0} |
| 51 | Li_{0.44 + x} P_{0.08 − y} S_{0.36 − z} Cl_{0.108 − w} I_{0.012 + } |
| 52 | Li_{0.44 + x} P_{0.08 − y} S_{0.36 − z} Cl_{0.108 − w} Br_{0.012 + l} |
| 53 | Li_{0.44 + x} P_{0.08 − y} S_{0.36 − z} Cl_{0.12 − w} |
| 54 | Li_{0.44 + x} F_{0.032 − y} P_{0.08 − z} S_{0.36 − w} Cl_{0.088 − l} |
| 55 | Li_{0.475 + x} Si_{0.026 + y} P_{0.048 − z} S_{0.374 − w} Br_{0.074 − l} |
| 56 | Li_{0.461 + x} P_{0.076 − y} S_{0.384 − z} Cl_{0.076 − w} |
| 57 | Li_{0.461 + x} P_{0.076 − y} S_{0.384 − z} I_{0.076 − w} |
| 58 | Li_{0.481 + x} P_{0.074 − y} S_{0.407 − z} Cl_{0.037 −w} |
| 59 | Li_{0.5 + x} P_{0.071 − y} S_{0.428 − z} |

In Tables 13 and 14, ‘_{#}’ and ‘_{#+x, y, z, w, l, or m}’ represent non-stoichiometric weightings of an element immediately to the left of ‘_{#}’ or ‘_{#+x, y, z, w, l, or m}’ in a chemical formula of the material, where # can be in the range of #±n, where 0≤n≤0.5, where 0≤x, y, z, w, l, and m≤#, and where # can be ±n, 0≤n≤0.5.

In certain embodiments, the solid-state electrolyte mixed with the cathode includes any one of materials 32-40 from Table 13 or any one of materials 37-45 from Table 14.

In some embodiments, the solid state electrolyte mixed with the cathode has a core-shell particle structure.

In another aspect, the invention provides a method of storing energy including applying a voltage across the anode and cathode and charging any rechargeable battery disclosed herein. In another aspect, the invention provides a method of providing energy including connecting a load to the anode and cathode and discharging any rechargeable battery disclosed herein.

### Definitions

The term “about,” as used herein, refers to +10% of a recited value.

The term “stability,” as used herein with respect to solid-state electrolytes, refers to the stability of the material to decomposition via reaction with a metal in the anode, e.g., lithium or sodium. Stability of solid electrolytes can be determined experimentally.

### BRIEF DESCRIPTION OF THE DRAWINGS

FIGS. 1A-1D show battery cycling performance in symmetric batteries. FIG. 1A shows performance of a symmetric battery with Li₁₀Ge₁P₂S₁₂ (LGPS) as electrolyte, and FIG. 1B shows a symmetric battery with Li_{5.5}PS_{4.5}Cl_{1.5} (LPSCl) as electrolyte, with pure lithium metal as electrodes, cycling at 0.25 mA/cm² at room temperature for 1 hour in each half-cycle. FIG. 1C shows long cycling (0.25 mA/cm² at room temperature), and FIG. 1D shows high rate testing (20 mA/cm², at 55° C.) for the symmetric battery in the configuration of LPSCl-LGPS-LPSCl as electrolyte and graphite covered lithium (Li/G) as electrodes with the capacity of 0.25 mAh/cm².

FIGS. 2A-2H show chemical probing and SEM images of solid electrolyte after cycling. FIG. 2A shows an optical image of cross section of Li/G-LPSCl-LGPS-LPSCl-G/Li after 300 hours cycling at 0.25 mA/cm² at room temperature. FIG. 2B shows XRD broadening analysis for LGPS after symmetric battery testing. Dots are the broadening of different Bragg peaks after 300 hours cycling at 0.25 mA/cm², while the angle dependences of strain broadenings are represented by solid lines, and the y intercept represents the level of size broadening. FIGS. 2C-2D show XPS measurements of S2p (FIG. 2C) and Ge2p (FIG. 2D) on the black region after 30 cycles at 20 mA/cm² at 55° C. FIGS. 2E-2H show SEM images of different regions on LPSCl (FIG. 2E), LGPS (FIG. 2F), and LPSCl-LGPS (FIG. 2G) transition areas. The SEM images in FIG. 2E, FIG. 2F, and FIG. 2G were taken from regions (1), (2), (3), respectively, as illustrated in FIG. 2H.

FIGS. 3A-3I show cycling performance of the multilayer structure. FIG. 3A shows the charge and discharge profiles, FIG. 3B shows capacity retention, and FIG. 3C shows coulombic inefficiency of a battery cycled at 1.5C with cut-off voltages set at 4.2 V and 2.5 V at 55° C. FIG. 3D shows the high-rate discharging profiles of graphite covered Li—LiNi_{0.8}Mn_{0.1}Co_{0.1}O₂ (Li/G-NMC811) batteries with Li_{5.5}PS_{4.5}Cl_{1.5}Li_{9.54}Si_{1.74} (P_{0.9}Sb_{0.1})_{1.44}S_{11.7}Cl_{0.3} (LPSCl-LSPS-LPSCl) as the electrolyte. The batteries were charged and discharged at the same rate at 55° C. in an oven with humidity of 8%. FIG. 3E shows the capacity retention and FIG. 3F shows the coulombic inefficiency of a battery cycled at 15C with cut-off voltages set at 4.35 V and 2 V at 55° C. FIG. 3G shows charge and discharge profiles of a battery cycled over 10,000 cycles at 20 C with the voltage ranged in 2-4.35 V at 55° C. FIG. 3H shows the capacity retention, and FIG. 3I shows coulombic inefficiency of battery cycled at 20C with cut-off voltages set at 4.35 V and 2 V at 55° C. All batteries in FIGS. 3A-3I use LPSCl-LSPS-LPSCl as electrolyte, and NMC811 is not coated with other materials.

FIG. 4A shows battery cycling performance of Li/G-LPSCl-central electrolytes-LPSCl-NMC811 at 1 C at room temperature. The central electrolytes include Li_{9.54}Si_{1.74} (P_{0.9}Sb_{0.1})_{1.44}S_{11.7}Cl_{0.3} (LSP(Sb)S), Li₁₀Ge₁P₂S₁₂ (LGPS), Li_{9.54}Si_{1.74}P_{1.44}S_{11.7}Cl_{0.3} (LSPS) and Li₃YCl₆ (LYC316). Green curve represents the battery with the structure of Li/G-LYC316-LGPS-LPSCl-NMC811, where LYC316 can serve as a lithium anode stable electrolyte.

FIG. 4B shows the Ragone plot of the batteries in this study compared to batteries reported previously. The reported cycling numbers and the capacity retention are labeled in the plot, the energy density and the power density in the figure are calculated based on the mass of the cathode active material.

FIG. 5 shows electronic conductivity for different electrolytes (Li₁₀Ge₁P₂S₁₂ (LGPS) and Li_{5.5}PS_{4.5}Cl_{1.5} (LPSCl)) from direct current (DC) polarization. The electronic conductivities were obtained using Ohm's law with value of steady current at the end of the curve.

FIGS. 6A-6C shows SEM images of LPSCl, LGPS, and LSPS particles.

FIGS. 7A-7C show asymmetric batteries with Li/G as anode (lithium capacity loading=3 mAh/cm²), stainless steel (SS) current collector as cathode, and solid electrolytes as separator. Lithium was deposited on the surface of solid electrolytes at 0.25 mA/cm². Different electrochemical behaviors and surface information were observed. In FIG. 7A, a short circuit happened immediately after lithium was deposited on the surface of pure LPSCl pellet. Metallic color (sliver or gray) was observed from the optical image, and a small level of cracking was observed from the SEM image. In FIG. 7B, voltage ramped up quickly after lithium was deposited on the surface of pure LGPS pellet in a few hours. Decomposed color (dark black) was observed from the optical image, and no crack was observed from the SEM image. In FIG. 7C, voltage ramped up gradually and reach to cut-off voltage after lithium was fully deposited on the surface of the LGPS separated LPSCl pellet. Metallic color (sliver or gray) on large area was observed from the optical image and cracks were observed from the SEM image.

FIGS. 8A-8C show XPS data of the black region on the LGPS surface after lithium discharging (shown in FIG. 7B) with chemical information of S (FIG. 8A), P (FIG. 8b) and Ge (FIG. 8C).

FIGS. 8D-8F show XPS data of the silver region on the LPSCl surface after lithium discharging (shown in FIG. 8C) with chemical information of S (FIG. 8D), P (FIG. 8E) and Cl (FIG. 8F).

FIGS. 9A-9B show voltage cycling vs. time for two symmetric batteries. FIG. 9A shows a symmetric battery with Li_{9.54}Si_{1.74} (P_{0.9}Sb_{0.1})_{1.44}S_{11.7}Cl_{0.3} (LSPS) as electrolyte and graphite covered lithium (Li/G) as electrodes. FIG. 9B shows a symmetric battery with the combination of Li_{9.54}Si_{1.74} (P_{0.9}Sb_{0.1})_{1.44}S_{11.7}Cl_{0.3} (LSPS) and Li_{5.5}PS_{4.5}Cl_{1.5} (LPSCl) in the configuration of LPSCl-LSPS-LPSCl as electrolyte and graphite covered lithium as electrodes.

FIG. 10A shows high rate (10 mA/cm²) cycling for Li₁₀Ge₁P₂S₁₂ (LGPS) symmetric battery with Li/G as electrodes. The overpotential starts from 0.6 V and quickly ramp up to over 1.5 V in the first few cycles.

FIG. 10B shows high rate (15 mA/cm²) cycling for LGPS symmetric battery with Li/G as electrodes. The overpotential ramped up to over 5 V in the first cycle.

FIG. 10C shows a symmetric battery with LPSCl as electrolyte and Li/G as electrodes, cycling at 0.25 mA/cm². Short circuit occurs in the first two cycles.

FIGS. 11A-11E show optical images of battery active layer cross sections. FIG. 11A shows an optical image of a cross section of Li/G-LPSCl-LGPS-LPSCl-G/Li after 300 hours cycling at 0.25 mA/cm² at room temperature, showing another region without decomposition. FIG. 11B shows a post-treated image of FIG. 11A by setting only black and white colors. FIG. 11C shows an optical image of the cross section of the same pellet from FIG. 11A in a larger view. FIG. 11D shows an optical image of cross section of Li/G-LPSCl-LGPS-LPSCl-G/Li after 30 cycles at 20 mA/cm² at 55° C. FIG. 11E shows a post-treated image of FIG. 11D by setting only black and white colors.

FIGS. 12A-12C show XPS measurements of S2p (FIG. 12A), P2p (FIG. 12) and Ge2p (FIG. 12) on the black region in the cross section of the sandwich pellet after battery cycling at 0.25 mA/cm² for 300 hours.

FIGS. 12D-12F show XPS measurements of S2p (FIG. 12D), P2p (FIG. 12E) and Ge2p (FIG. 12F) on the black region in the cross section of the sandwich pellet after battery cycling at 20 mA/cm² for 30 cycles.

FIG. 13 shows SEM images of the solid electrolytes before (first row) and after cycling (second row) in the region of LPSCl, LGPS, and their transition areas.

FIGS. 14A-14F show half-battery cycling performance using pure LGPS or LPSCl as electrolyte. FIG. 14A shows the first charge and discharge profiles of Li—LiCoO₂ (Li-LCO) batteries with Li_{5.5}PS_{4.5}Cl_{1.5} (LPSCl) as the electrolyte. FIG. 14B shows the first charge and discharge profiles of Li₁₀Ge₁P₂S₁₂ (LGPS) as the electrolyte. Uncoated LCO and LiNbO₃ coated LCO is applied for LPSCl and LGPS, respectively. FIGS. 14C-14F show the first charge and discharge profiles of graphite covered Li—LiNi_{0.8}Mn_{0.1}Co_{0.1}O₂ (Li/G-NMC811) batteries with LPSCl as the electrolyte at (FIG. 14C) 0.3C and (FIG. 14D) 0.5C; along with the cycling performance at (FIG. 14E) 0.3C and (FIG. 14F) 0.5C. NMC811 is not coated with other materials. 1 C=0.43 mA/cm² in these tests. A current density in the range of 0.21 mA/cm²-215 mA/cm², and 1C=0.43-0.8 mA/cm² has also been tested. All batteries were tested at room temperature. The battery configurations and materials used are summarized in Table 4.

FIG. 15 shows cycling of Li-LCO battery with LPSCl as the electrolyte. LCO is not coated with other materials.

FIGS. 16A-16F show cycling performance of solid state electrolyte batteries. FIG. 16A shows the high-rate discharging profiles of graphite covered Li—LiNi_{0.8}Mn_{0.1}Co_{0.1}O₂ (Li/G-NMC811) batteries with Li_{5.5}PS_{4.5}Cl_{1.5}, LPSCl, Li_{9.54}Si_{1.74} (P_{0.9}Sb_{0.1})_{1.44}S_{11.7}Cl_{0.3}, LSPS, and LPSCl-LSPS-LPSCl configuration as the electrolyte. The batteries were firstly charged at 0.1C and then discharged at high rate at room temperature. FIGS. 16B-16C show the cycling performance of the same battery at 5C (FIG. 16B) and 10C (FIG. 16C) in the range of 2.5-4.3 V in the environment without humidity control (55° C.). NMC811 is not coated with other materials. FIG. 16D shows cycling performance of solid-state battery with multilayer electrolytes at different Li/graphite capacity ratios of 10:1, 5:1 and 2.5:1. FIG. 16E shows cycling performance of solid-state battery with multilayer electrolytes under different operating pressures of 50-75 MPa, 150 MPa, and 250 MPa. FIG. 16F shows cycling performance of solid-state battery with thin multilayer: Li/G-LPSCl (100 μm)-LSPS (50 μm)-LPSCl (50 μm)-NMC811.

FIGS. 17A-17B show the electrolyte decomposition design procedure and results. FIG. 17A is a schematic flowchart of computational procedure. FIG. 17B shows an optimized composition, decomposition energy Eₕᵤₗₗ and critical modulus K* at fixed Br requirements for LPSCl-Br with minimized K* (right panel). The left panel is for the values of original LPSCl without doping and minimization of K*.

FIGS. 18A-18C show composition characterizations of the core-shell structure in LPSCl-Br particles. FIG. 18A shows the SEM-EDX intensity ratio profile. The inset shows the line profile scanned from an ion-milled particle. FIGS. 18B and 18C show XPS quantification of elemental compositions at different ion-milling time, where the sample was transferred with (FIG. 18B) 15 s air exposure, the same as the SEM-EDX, and (FIG. 18C) a vacuum transfer holder.

FIGS. 19A-19F show super long cycling performance of SSBs using composition modified LPSCl-X with reduced shell critical modulus K. FIGS. 19A-19C show charge-discharge voltage curves of SSBs using (FIG. 19A) LPSCl-F, (FIG. 19B) LPSCl-Br, and (FIG. 19C) LPSCl-I as the central electrolyte layer. FIGS. 19D-19F show the corresponding cycling performance of SSBs using (FIG. 19D) LPSCl-F, (FIG. 19E) LPSCl-Br, and (FIG. 19F) LPSCl-I as the central electrolyte layer. All batteries were cycled at 55° C. with LPSCl-X as the central layer sandwiched by LPSCl layers on both sides, and a LiNbO₃ coated NMC811 (LNO@811) cathode with Li-Graphite composite anode (Li-G). Battery configurations are shown in FIGS. 19D, 19E, and 19F ending with the circled numbers correspond to those in FIG. 20C. Batteries in FIGS. 19A, 19B, 19D, and 19E were cycled in an environmental chamber with 8% humidity control, while the battery in FIGS. 19C and 19F was cycled on a battery test station without applying a humidity control.

FIGS. 20A-20C show high-capacity and high-rate capability of LPSCl-I and/or LGPS multilayer batteries. FIG. 20A shows charge-discharge voltage curves at different rates of the LPSCl-I|LGPS battery with the configuration described in (FIG. 20A), ending with \textcircled{3} for its sequence in FIG. 20C. FIG. 20B shows cycling performance of batteries with three different configurations as described in FIG. 20B, ending with the circled numbers for their sequences in FIG. 20C: \textcircled{1} LGPS battery, \textcircled{2} LGPS battery with LNO coated 811, and \textcircled{3} LPSCl-I|LGPS battery. C-rates from 0.5C up to 20C are labelled besides the data points. FIG. 20C shows a comparison of high- and low-rate initial discharge capacities (blue and purple bars) and average voltages (orange filled dot and circle) for batteries with different configurations. Electrolyte in parathesis represents the central layer. All the batteries were tested at 55° C. without the humidity control except for \textcircled{7}\textcircled{9}\textcircled{10}. The two liquid electrolyte batteries (\textcircled{11}\textcircled{12}) with different LNO@811 particle sizes are also tested for a comparison.

FIGS. 21A-21B show two examples to illustrate the calculation of K*: the unstable P₂S₇/Li interface (FIG. 21A); and the stable LiCl/Li interface (FIG. 21B).

FIGS. 22A-22D show optimized composition of LPSCl-X with changing fixed X as (FIG. 22A) I and (FIG. 22B) F compositions. K* and decomposition energy corresponding to the optimized compositions of (FIG. 22C) LPSCl-F and (FIG. 22D) LPSCl-I. The elemental compositions labeled by dots on the x- or y-axis are for the values of original LPSCl-F and LPSCl-I. LPSCl-F is optimized to be S, P deficient and Li rich. At F deficient range, Cl can be either rich or deficient. LPSCl-I is optimized to be S, P deficient and CI, Li rich. Both K* are low at around 10 GPa and decomposition energy can be increased up to a few tens of meV/atom.

FIG. 23 shows XRD and optical photographs of LPSCl and LPSCl-X (X=F, Br, I) powder. LPSCl and LPSCl-Br sample had a pure phase with F-43m space group, whose XRD reflections are marked by dashed line, while LPSCl-F and LPSCl-I have impurities.

FIGS. 24A-24D show SEM of (FIG. 24A) LPSCl, (FIG. 24B) LPSCl-F, (FIG. 24C) LPSCl-Br, and (FIG. 24D) LPSCl-I. The particles have similar size of a few to ˜30 μm.

FIG. 25 shows XPS of LPSCl and LPSCl-X with 15 s of air exposure during sample transfer. The X-axis is energy (eV), and Y-axis is intensity.

FIG. 26 shows XPS of LPSCl and LPSCl-X without air exposure during sample transfer. The X-axis is energy (eV), and Y-axis is intensity.

FIGS. 27A-27D show XPS quantification of LPSCl-F transferred (FIG. 27A) in air in 15 s and (FIG. 27B) in vacuum without air exposure, and LPSCl-I transferred (FIG. 27C) in air in 15 s and (FIG. 27D) in vacuum without air exposure.

FIGS. 28A-28C show the core shell structure of LPSCl characterized by SEM-FIB-EDX and XPS. FIG. 28A shows the intensity ratio of Li, P, S and Cl, and the inset shows the SEM image of the milled and line scanned particle. Index larger than 24 corresponds to points at the edge, where there is S deficiency and CI richness. The same S deficiency and Cl richness observed in the point index range from 16 to 23 is also located at the edges of the particle cracks. XPS quantifications with milling show a S-deficient and Cl-rich shell with sample transferred in both air (FIG. 28B) and vacuum (FIG. 28C).

FIGS. 29A-29C show XPS analyses, machine learning optimized compositions and optimized K* and predicted decomposition energies for LGPS particles. FIG. 29A shows XPS quantification at different depth of LGPS particles (transferred in vacuum) shows a Li rich, S, Ge, P deficient surface. FIG. 29B shows machine learning optimized compositions with different allowed compositional change percentage for each element itself (composition change constraint), aiming for lower K*. The zero point in x-axis corresponds to the original LGPS. With larger allowed compositional changes, LGPS is optimized to be Li rich, S, Ge, P deficient, which is the same trend observed in the XPS quantification. FIG. 29C shows optimized K* and the predicted decomposition energy with the same optimized composition. The 0.915 eV is the Li_{0.49}Cl_{0.49}P_{0.01}S_{0.01} reference for zero DFT 0V decomposition energy. A relatively small change in composition such as 30% can decrease the K* to below 15 GPa along with a relatively large decomposition energy of ˜100 meV/atom.

FIGS. 30A-30E show XPS analysis and optical photos of the Li deposited (FIG. 30A) LPSCl, (FIG. 30B) LPSCl-F, (FIG. 30C) LPSCl-Br, (FIG. 30D) LPSCl-I, and (FIG. 30E) LGPS. Samples were transferred in vacuum to avoid air exposure. XPS analysis shows that the decomposition is the weakest for the Li deposited LPSCl with least S reduction and limited P reduction, while the reduction of S becomes stronger for LPSCl-X and LGPS, and LPSCl-F and LPSCl-Br have stronger P reduction. Therefore, the gray and silver color of (A₃) Li deposited LPSCl should be largely from Li metal, while the larger area of dark gray color of (B₃) to (D₃) Li deposited LPSCl-X and the black color of (E₃) Li-deposited LGPS should be from decompositions.

FIG. 31 shows cycling performance comparison of Li-G|LPSCl|LNO@811, Li-G|LPSCl|LPSCl-I|LGPS|811 and Li-G|LPSCl|LPSCl-I|LPSCl|LNO@811 batteries at 0.5C-rate for 5 cycles and subsequently at 20C-rate. The 20C capacity quickly decreases to be lower than 30 mAh/g in 2500 cycles for the single electrolyte layer battery, while the cycling is robust for the multilayer electrolyte batteries.

FIGS. 32A-32D show 20C-rate cycling Coulombic inefficiency of (FIGS. 32A and 32B) Li-G|LPSCl|LPSCl-F|LPSCl|LNO@811 at (FIG. 32A) large scale (FIG. 32B) small scale, and of (FIGS. 32C and 32D) Li-G|LPSCl|LPSCl-Br|LPSCl|LNO@811 at (FIG. 32C) large scale (FIG. 32D) small scale.

FIG. 33 shows low-rate cycling of the Li-G|LPSCl|LGPS|811 battery.

FIGS. 34A-34B show: voltage curves of the batteries in FIG. 20 (FIG. 34A) and the comparison between LNO@811 liquid electrolyte battery and solid state Li-G|LPSCl|LGPSILNO@811 battery at different rates (FIG. 34B). The multilayer solid state battery shows much better rate capability than the liquid electrolyte battery. 5C, 10C, and 20C-rate in solid battery already shows higher capacity than 1C, 5C and 10C in liquid battery, respectively.

FIGS. 35A-35D show: for Li-G|LPSCl|LPSCl-I|LGPS|811 batteries, the charge-discharge voltage curves at extremely high current densities up to 43 mA/cm² (FIG. 35A) and high current density long cycling performance at 20 mA/cm² and 30 mA/cm² (FIG. 35B). Before the battery was cycled at 20 mA/cm² for 10,000 cycles in FIG. 35B, it was first cycled at 8.6 mA/cm² for 500 cycles and then cycled at 15 mA/cm² for 800 cycles (FIG. 35C). Before the battery was cycled at 30 mA/cm² for 10,000 cycles in FIG. 35B, it was first cycled at various current densities up to 43 mA/cm². All batteries were cycled at 55° C.

FIGS. 36A-36B depict the cycling performance of solid-state batteries with the multilayer design, with a cathode active material loading=25 mg/cm². The charge and discharge profiles at different C-rates (FIG. 36A) and capacity retention (FIG. 36B) of the battery cycled at 2C with cutoff voltages set at 4.1 V and 2.5 V at 55° C. The anode was Li covered by silicon-graphite mixture (Li/Si-G), where the Si particle size=1 μm, the cathode was LiNi_{0.8}Mn_{0.1}Co_{0.1}O₂ (NMC811, cathode active material loading=25 mg/cm²), with Li_{5.5}PS_{4.5}Cl_{1.5} (LPSCl) and Li₁₀Ge₁P₂S₁₂ (LGPS) as the electrolytes following the multilayer design of LPSCl-LGPS-LPSCl.

FIGS. 37A-37G show XPS measurements of cycled battery pellet cross sections with ion milling. FIGS. 37A-37C show results for a cycled LPSCl in Li-G|LPSCl|811 battery run at 8.6 mA/cm²: FIG. 37A shows Li 1 s XPS at different milling times; FIG. 37B shows Li 1 s XPS refinement of the 430 s milled sample; and FIG. 37C shows XPS quantification of elemental compositions at different ion-milling times. FIGS. 37D-37G show results for a cycled LPSCl-I in Li-G|LPSCl|LPSCl-I|LGPS|811 battery run at 30 mA/cm²: FIG. 37D shows Li 1 s XPS at different milling time; FIG. 37E shows Li 1 s XPS refinement of the 430 s milled sample; FIG. 37F shows XPS quantification of elemental compositions at different ion-milling times; and FIG. 37G shows S 2p XPS refinement of the 430 s milled sample.

### DETAILED DESCRIPTION OF THE INVENTION

The invention provides rechargeable batteries including a solid state electrolyte (SSE) multilayer containing three or more layers and two or more solid state electrolytes with different stabilities. The solid state electrolytes may be arranged such that the less stable electrolyte is sandwiched between more stable electrolyte(s). Localized decomposition of the less stable electrolyte can block the formation or progression of cracks in the multilayer and arrest dendrite progress.

Solid-state electrolyte with high mechanical strength is expected to solve the issue of lithium or sodium dendrites and enable Li or Na anodes. However, in practice it remains a challenge, as it is found that lithium can still penetrate most solid electrolytes even at a very low current density. This invention provides solid-state batteries using a multilayer design of solid electrolytes with a hierarchy of interface stabilities to achieve an ultra-high current density with no dendrite penetration. The more stable electrolyte ensures the interface stabilities with both high voltage cathodes and Li or Na metal anodes, while the less stable electrolyte responds to any dendrite growth with localized decompositions, to effectively inhibit the further growth of the dendrite by local mechanical constriction induced kinetic stability. Micron or submicron sized cracks in ceramic pellets are inevitable in any battery assembly over long-time cycling. The solid state electrolyte multilayers of the invention dynamically generate self-decomposed and well-constrained “cement” or “concrete” to fill in these cracks, no matter which pathway the dendrite chooses, thereby preserving battery performance. We emphasize that these comparisons and analyses about electrochemical stabilities at the various interfaces are made possible because the problem of Li metal dendrite induced capacity fading and internal short have been largely prevented through the designed functional decompositions of the invention. The invention provides new design principles for electrolytes, interfaces and devices within the framework of the mechanical constriction theory to enable solid state batteries with high capacity, stable cycling, high-rate, and high current density capabilities.

The cycling performance of Li metal anode paired with LiNi_{0.8}Mn_{0.1}Co_{0.1}O₂ cathode is demonstrated to be very stable, with 82% capacity retention after 10,000 cycles at 20C (70% capacity retention after 9,300 cycles at 15C). The average Coulombic efficiency is 99.96% at 20C and 100.0009% at 15C among all the thousands of cycles, with the highest power density reaching 11.9 kW/kg and the energy density up to 631 Wh/kg at the cathode active material level. LiNi_{0.8} Mn_{0.1}Co_{0.1}O₂ (NMC811) is regarded as one of the most important cathode materials with high capacity, energy density, and also cost effectiveness due to the decreased composition of the expensive Co element, while Li metal is considered as the holy grail of the anode for Li-ion batteries due to the high capacity and energy density. The stable cycling of NMC811 lithium metal battery is of great significance to the industry of electrical vehicle batteries. However, the stability of such a battery with most electrolytes, either liquid or solid, is poor. It is known that Li₁₀₋ₓM_{1zy}P₂₋ₚS_{12-q} (M=Ge, Si) is not stable with lithium metal. 1 Protection layers such as graphite² or indium metal³ are usually applied to insulate the contact between solid electrolytes and the lithium metal. While Li-argyrodites Li_{6-y} PS_{5-y}Cl_{1-y} is much more stable with lithium metal than LGPS.⁴⁻⁶ The invention thus provides a highly stable battery that can employ high capacity anodes and cathodes and has a broad space to provide batteries with an energy density and a power density greater than other batteries.

### Solid State Electrolyte Multilayers

Rechargeable batteries of the invention typically include an anode, a cathode, and a solid state electrolyte multilayer disposed between the anode and the cathode. The solid state multilayer includes a first solid state electrolytes (e.g., LPSCl) and a second solid state electrolyte (e.g., LGPS). The multilayer includes at least one layer of a first solid state electrolyte, which is more stable with lithium or sodium metal than the second solid state electrolyte. The second solid state electrolyte is separated from the anode by the first solid state electrolyte. The multilayer may contain ‘n’ layers of the second solid state electrolyte and ‘n’ layers of the one or more first solid state electrolytes (where n=e.g., 2, 3, 4, 5, 6, 7, 8, 9, 10, etc.).

The solid state multilayer may alternatively be arranged in, e.g., a “sandwich” structure, e.g., with one layer of the second solid state electrolyte between two layers of the one or more first solid state electrolytes (e.g., LPSCl-LGPS or LPSCl-LGPS-LPSCl). Alternatively, the multilayer may contain ‘n’ layers of the second solid state electrolyte and ‘n’ or ‘n+1’ layers of the one or more first solid state electrolytes (where n=e.g., 1, 2, 3, 4, 5, 6, 7, 8, 9, 10, etc.).

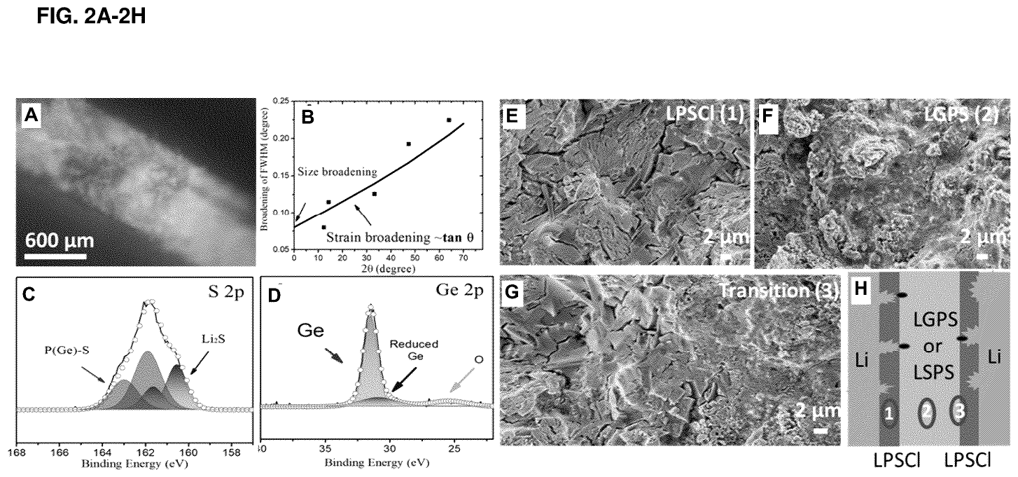

The second solid state electrolyte is less stable with lithium or sodium metal than the one or more first solid state electrolytes. Such an arrangement allows the first solid state electrolyte to protect the second solid state electrolyte from, e.g., large-scale decomposition, while confined localized decomposition of the second solid state electrolyte arrests the progression of metal dendrites (see, e.g., FIG. 2H). The multilayer may include multiple different first solid state electrolytes. In particular embodiments, the solid state electrolyte multilayer includes at least two different first solid state electrolytes, for example, a solid state electrolyte multilayer may include two different solid state electrolytes from Table 1 or Table 3.

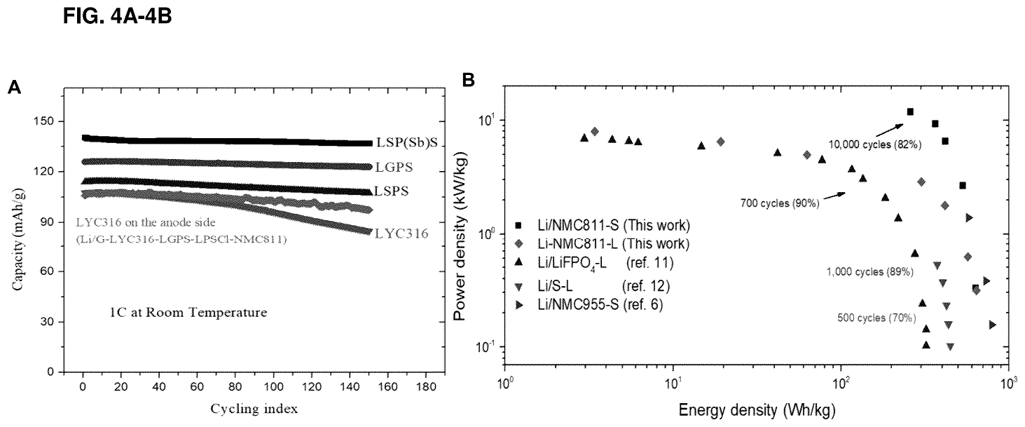

The multilayer design is not limited to any specific materials. The versatility of the multilayer design is demonstrated in FIG. 4A, which shows that it can work well with most electrolytes in the central layer, as long as the second solid state electrolyte can show such well-constrained decomposition with Li dendrite under mechanical constriction. Such solid state electrolytes include, but are not limited to LGPS, LSPS, LSP(Sb)S, which show similarly stable cycling.

Following this design principle, a broad range of solid state electrolytes can be included as the one or more first solid state electrolytes or the second electrolyte, as long as they are appropriately placed relative to each other in the multilayer design according to their relative stabilities, e.g., polymers, gels, or sulfides, halides, oxides, phosphates and nitrates, as listed in Tables 1 to 4.

A very promising aspect of the invention is that the stability of the multilayer structure takes advantage of relative chemical and/or electrochemical stabilities, which are not sensitive to the thickness or the micron crack density of the electrolyte layers. This new strategy of incorporating instability by design is different from the conventional wisdom in the field to improve battery stability using solid state electrolytes to mechanically block the Li (or Na) dendrite penetration, which naturally requires a thick and crack-free electrolyte layer. The flexibility and versality inherent in the multilayer batteries of the invention make them readily compatible with mass production procedures in battery industry, where the thickness and mechanical flexibility of the electrolyte layer can be further optimized in the future without sacrificing the safety and performance.

To quantify the electrochemical stability of solid electrolytes and their interfaces in such a solid state battery (SSB), a constrained ensemble description has been developed, where decompositions with a positive reaction strain can in principle be suppressed through a metastability if the local effective modulus (e.g., from being made into solid state batteries), K_{eff}, is sufficient. K_{eff} in the unit of GPa reflects the complicated coupling of microstructures, the mechanical strength of materials, and the stack pressure of battery devices.

We have found that when K_{eff} is larger than a critical threshold modulus, K*, the Gibbs energy of the decomposition reaction, Eₕᵤₗₗ, goes from negative to positive so that the decomposition can be suppressed through a metastability. Since most sulfide electrolytes are unstable at 0 V with Li metal, it is thus attractive to have a low K* interface between solid electrolyte and Li metal, so that interface reactions can be more easily stabilized through mechanical constriction. Importantly, since a stress field surrounding the decomposition front is inevitable in practice, a lower K* likely also causes a smaller decomposition-induced local volume expansion and a weaker stress field before it is fully inhibited by the metastability. Meanwhile, decompositions with sufficient Eₕᵤₗₗ at K_{eff}=0 GPa can serve as an effective supply of “concrete” to heal any microcracks, which may preexist in battery assembly or be generated by various stress fields during cycling, including the field induced by the local decomposition itself. Thus, an interface reaction with low K* and sufficient Eₕᵤₗₗ may effectively prevent the fracture and dendrite propagations. The continuous local stress field surrounding the decomposition front without cracks or with cracks immediately healed by electrochemical decompositions thus can provide the kinetic stability that further strengthens the metastability.

The invention provides the first quantification of the above picture to design functional decompositions by using high-throughput ab initio computations to evaluate the K*and Eₕᵤₗₗ of over 120,000 materials, and further use machine learning to extract the information to suggest solid electrolyte compositions that are likely to show small K* and sufficient Eₕᵤₗₗ at the interface to Li metal (See Methods in Example 4). The suggested composition change can be implemented in through a core-shell strategy, where the shell composition can be modified from the core, advantageously, also according to the predicted composition for a low K*. For example, the core conductivity may be higher than the shell conductivity. Alternatively or in addition, the shell composition may have a smaller K* or a more negative Eₕᵤₗₗ than the core. The design principles identified herein also apply to SSBs having other anode metals, e.g., Na.

### Mechanical Constriction

In some embodiments, the solid state electrolyte multilayer is under mechanical constriction. Mechanical constriction of the solid state electrolyte can limit the extent of chemical or electrochemical decomposition of solid state electrolyte materials by volumetric constraint, as detailed. Local stress on the order of a few GPa up to the mechanical modulus of solid electrolyte (e.g., around 20 GPa for sulfide solid electrolytes), may be generated from mechanical constriction. The mechanical constriction can be implemented by an external pressure applied to the battery cell of at least 0.1 MPa up to several hundred MPa. The level of external pressure needed for a battery is determined by the battery material, material processing, and battery assembly methods. Mechanical constriction may be provided by a formation pressure from cold and/or hot and/or warm isotropic and/or anisotropic press and/or rolling with the external pressure on the order of 0.1 MPa to 1000 MPa and temperature at 25° C.-500° C. Examples of suitable assembly methods include, but are not limited to, warm isotropic pressing (WIP), cold isotropic pressing (CIP), and hydraulic cold pressing of the battery cell or pouch. The mechanical constriction may result from an applied pressure of at least 0.1 MPa, e.g., at least 20 MPa, or about 0.1 MPa to about 40 MPa, e.g., about 0.1 MPa to about 1 MPa, about 0.1 MPa to about 10 MPa, about 1 MPa to about 30 MPa, about 20 MPa to about 40 MPa, about 30 MPa to about 50 MPa, about 40 MPa to about 60 MPa, about 50 MPa to about 70 MPa, about 60 MPa to about 80 MPa, about 70 MPa to about 90 MPa, or about 80 MPa to about 100 MPa, about 100 MPa to about 200 MPa, about 200 MPa to about 400 MPa, about 300 MPa to about 500 MPa, about 400 MPa to about 600 MPa, about 500 MPa to about 700 MPa, about 600 MPa to about 800 MPa, about 700 MPa to about 900 MPa, or about 800 MPa to about 1,000 MPa, e.g., about 70 MPa, about 75 MPa, about 80 MPa, about 85 MPa, about 90 MPa, about 95 MPa, about 100 MPa, about 150 MPa, about 200 MPa, about 250 MPa, about 300 MPa, about 350 MPa, about 400 MPa, about 450 MPa, about 500 MPa, about 550 MPa, about 600 MPa, about 650 MPa, about 700 MPa, about 750 MPa, about 800 MPa about 850 MPa, about 900 MPa, about 950 MPa, or about 1,000 MPa. Greater mechanical constriction may be applied during battery fabrication. After providing the formation pressure, the porosity of the anode, cathode, and/or multilayer may be 0%-15%. In some embodiments, the mechanical constriction is sufficient to raise the local effective modulus above K*, thereby preventing decomposition, or such that a local stress field caused by decomposition of the solid state electrolyte raises K_{eff} above K*, thereby arresting decomposition.

When the battery is operating, the local stress can be maintained by applying an operational stack pressure on the order of 0.1 MPa to 1000 MPa. The operational stack pressure can be applied by the mechanical stress from battery case or pouch cell made of steel, aluminum, plastic, polymer, as well as their 3D structures, and/or from a hydraulic press made by gel or any liquid sealed in an environment surrounding the pouch cell. The external pressure may also change periodically during battery cycling, e.g., through a passive response system, e.g., springs, or, e.g., an active response system, e.g., controlled by pressure sensors and programmed electronic devices.

### Solid State Electrolytes

The one or more first solid state electrolytes may be selected from Table 1, Table 3, Table 5, Table 6, Table 9, or Table 10.^{14, 17-18, 20-21, 26-38} The second solid state electrolyte may be selected from Table 2, Table 4, Table 7, Table 8, Table 11, or Table 12.^{15-16, 19, 20, 22, 24-25} Solid state electrolytes advantageous for mixing with a cathode material are described in Tables 13 and 14. Other solid state electrolyte materials that may be suitable include sulfide solid electrolytes, e.g., SiₓP_{y}S_{z}, e.g., SiP₂S₁₂, or β/γ-PS₄. Other solid state electrolytes include, but are not limited to, germanium solid electrolytes, e.g., GeₐP_{b}S_{c}, e.g., GeP₂S₁₂, tin solid electrolytes, e.g., Sn_{d}PₑS_{f}, e.g., SnP₂S₁₂, iodine solid electrolytes, e.g., P₂S₈I crystals, glass electrolytes, e.g., alkali metal-sulfide-P₂S₅ electrolytes or alkali metal-sulfide-P₂S₅-alkali metal-halide electrolytes, or glass-ceramic electrolytes, e.g., alkali metal-P_{g}Sₕ₋ᵢ electrolytes. Other solid state electrolyte materials are known in the art. The solid state electrolyte material may be in various forms, such as a powder, particle, clay, or solid sheet. An exemplary form is a powder. Advantageously, the solid state electrolyte may adopt a core-shell particle structure. In particular, methods of the invention (see, e.g., Example 4) may be used to produce core-shell LPSCl-X (where X is a halide) solid state electrolytes having properties suited for use as first or second solid state electrolytes. LGPS (Li₁₀GeP₂S₁₂) may also adopt a core-shell particle structure. Solid state electrolyte particles, e.g., core-shell particles, may have a cross sectional dimension, e.g., diameter, of between about 1 nm and about 30 μm, e.g., about 1-100 nm (e.g., about 10 nm, 20 nm, 30 nm, 40 nm, 50 nm, 60 nm, 70 nm, 80 nm, 90 nm, or 100 nm), e.g., about 100-1000 nm (e.g., about 100 nm, 200 nm, 300 nm, 400 nm, 500 nm, 600 nm, 700 nm, 800 nm, 900 nm, or 1000 nm), e.g., about 1-10 μm (e.g., about 1 μm, 2 μm, 3 μm, 4 μm, 5 μm, 6 μm, 7 μm, 8 μm, 9 μm, or 10 μm), or, e.g., about 10-30 μm (e.g., about 10 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, or 30 μm). In core-shell particles, the shell may make up from about 0.1% to about 99.9% of the particle, e.g., about 1-10%, about 10-20%, about 20-30%, about 25-50%, about 40-60%, about 50-75%, about 60-80%, about 75-90%, or about 80-99% of the particle, by, e.g., volume or mass.

Stability may be determined experimentally. For example, if a lithium metal symmetric battery made with a solid electrolyte (Li-solid electrolyte-Li) can run for 10 or more cycles at a current density <0.5 mA/cm² without clear voltage ramp-up, the electrolyte can be classified as stable for the application as the first solid state electrolyte. For a less stable electrolyte (the second solid electrolyte), such a symmetric battery would show clear voltage ramp-up within just a few, e.g., 1-3, cycles. A less stable solid state electrolyte also shows clear composition and structure change after contacting or cycling with a lithium metal anode. In some embodiments, the second solid state electrolyte has a good response to mechanical constriction, reflected as the straining of the solid-state electrolyte in X-ray diffraction measurement after being the central layer of the multilayer solid-state battery during cycling, which is due to the positive reaction strain of the constricted local decompositions.

### Electrode Materials

Electrode materials can be chosen to have optimum properties for ion transport. For example, may be preferred LiNi_{0.8} Mn_{0.1}Co_{0.1}O₂ (NMC811) due to its high capacity, energy density, and also cost effectiveness due to the decreased composition of the expensive Co element. As another example, Li metal has high capacity and energy density. Electrodes for use in a solid state electrolyte battery can include metals, e.g., transition metals, e.g., Au, alkali metals, e.g., Li or Na, or crystalline compounds, e.g., lithium titanate, or an alloy thereof. Other materials for use as electrodes in solid state electrolyte batteries are known in the art.

The electrodes may be a solid piece of the material, or alternatively, may be deposited on an appropriate substrate, e.g., a fluoropolymer or carbon. For example, liquefied polytetrafluoroethylene (PTFE) has been used as the binder when making solutions of electrode materials for deposition onto a substrate. Other binders are known in the art. The electrode material can be used without any additives. Alternatively, the electrode material may have additives to enhance its physical and/or ion conducting properties. For example, the electrode materials may have an additive that modifies the surface area exposed to the solid electrolyte, such as carbon. Other additives are known in the art. In particular embodiments, the anode includes Li, e.g., Li metal. The lithium metal can also mix or alloy with Na, Mg, Al, Si, K, Ca, Sc, Ti, V, Cr, Mn, Fe, Co, Ni, Cu, Zn, Ga, Ge, As, Rb, Sr, Y, Zr, Nb, Mo, Ag, Cd, In, Sn, Sb, Bi, Cs, Te, or a combination thereof to form one single layer. The mixture of Li and other metal can form a 2D parallel layer or a 3D structure. The loading of the Li in the anode can be 0-50 mg/cm². The thickness of the Li in the anode can be 0 μm-1000 μm. A thickness of 0 μm means the battery can be made with an anode-free design, where Li source is from the cathode material.

In some embodiments, the cathode can include, e.g., LiNi_{0.8}Mn_{0.1}Co_{0.1}O₂ (NMC811), LiNi_{0.33}Mn_{0.33}Co_{0.33}O₂ (NMC111), LiNi_{0.5}Mn_{0.3}Co_{0.2}O₂ (NMC532), LiNi_{0.6}Mn_{0.2}Co_{0.2}O₂ (NMC622), LiNi_{0.9}Mn_{0.05}Co_{0.05}O₂ (NMC955), LiNiₓMn_{y}Co_{(1-x-y)}O₂ (0≤x,y≤1), LiNiₓCo_{y}Al_{(1-x-y)} O₂ (0≤x,y≤1), LiMn₂O₄, LiMnO₂, LiNiO₂, Li_{1-z}NiₓMn_{y}Co_{(1-x-y-z)}O₂ (0≤x,y,z≤1), Li_{1-z}NiₓMn_{y}Co_{w}Al_{(1-x-y-z-s)}O₂ (0≤x,y,z,s≤1), Li_{1+z}NiₓMn_{y}CoₛW_{(1-x-y-z-s)}O₂ (0≤x,y,z,w≤1), V₂O₅, selenium-sulfur compound, LiCoO₂ (LCO), LiFePO₄, LiNi_{0.5}Mn_{1.5}O₄, Li₂CoPO₄F, LiNiPO₄, Li₂Ni(PO₄)F, LiMnF₄, LiFeF₄, or LiCo_{0.5}Mn_{1.5}O₄.

The cathode can be mixed with polymer and/or carbon. Examples of polymers may include polyethylene oxide, polyvinylidene fluoride, poly(vinylidene fluoride-co-hexafluoropropylene), poly(ethyl methacrylate), or poly(vinylidene fluoride-co-trifluoroethylene). The particle size of cathode materials can be 1 nm-30 μm. The loading of the cathode can be 0.1-100 mg/cm². The thickness of the cathode can be 5 μm-2000 μm. The cathode may be mixed with solid state electrolyte materials, e.g., those described in Table 13 and Table 14, e.g., to provide increased cathode capacity.

Where the anode includes Na metal, the sodium metal can be mixed or alloyed with one or more metals of Li, Mg, Al, Si, K, Ca, Sc, Ti, V, Cr, Mn, Fe, Co, Ni, Cu, Zn, Ga, Ge, As, Rb, Sr, Y, Zr, Nb, Mo, Ag, Cd, In, Sn, Sb, Bi, Cs, or Te. The mixtures of Na and other metal can form a 2D parallel layer or a 3D structure. The loading of the Na in the anode can be 0-50 mg/cm². The thickness of the Na in the anode can be 0 μm-1000 μm. 0 μm means the battery can be made with an anode-free design, where Na source is from the cathode material.

Na cathode materials can be Na_{w}MnO₂, Na_{w}CoO₂, Na_{w}NiO₂, Na_{w} TiO₂, Na_{w}VO₂, Na_{w}CrO₂, Na_{w}FeO₂, Na_{w}(MnₓFe_{y}Co_{z}Ni_{1-x-y-z})O₂ (0≤x,y,z≤1), Na_{w}(M)PO₄, Na_{w}(M)P₂O₇, Na_{w}(M)O₂, NaₓM_{y}(XO₄)_{z} (M represents metal elements, e.g., including but not limited to transition metals, it can be one metal element or combination of metal elements; X represents B, S, P, Si, As, Mo, W; 0≤x,y,z≤3; 0<w≤1; O can be partially replaced by F, Cl, Br, I).

Other cathode materials such as selenium or sulfur that exhibit promising high capacity and energy density also shows much better cycling performance in our multilayer design than the single layer design. In certain embodiments, cathode can be mixed with polymer and carbon black, solid electrolytes can be mixed with polymer. Examples of polymers may include polyethylene oxide, polyvinylidene fluoride, poly(vinylidene fluoride-co-hexafluoropropylene), poly(ethyl methacrylate), or poly(vinylidene fluoride-co-trifluoroethylene). The thickness of the solid electrolyte layer is 5-1000 μm. The thickness of the cathode can be 5-2000 μm. The anode, cathode, and solid electrolytes can use bipolar or parallel stacking to form a battery module. The area of each layer can be 0.1 cm²-1 m².

### Electrode Coatings

In some cases, the electrode materials may further include a coating on their surface to act as an interfacial layer between the base electrode material and the solid state electrolyte. In particular, the coatings are configured to improve the interface stability between the electrode, e.g., the cathode, and the solid electrolyte for superior cycling performance. For example, coating materials for electrodes of the invention include, but are not limited LiNbO₃, LiTaO₃Li₂ZrO₃, LiNbₓTa₁₋ₓO₃ (0≤x≤1), yLi₂ZrO₃-(1-y)LiNbₓTa₁₋ₓO₃ (0≤x, y≤1), Al₂O₃, TiO₂, ZrO₂, AlF₃, MgF₂, SiO₂, ZnS, ZnO, Li₄SiO₄Li₃PO₄, Li₃InCl₆, Li₁₋ₓAlₓTi₂₋ₓ(PO₄)₃ (0<x<2), LiMn₂O₄, LiInO₂—LiI, Li₆PS₅Cl, LiAlO₂, and carbon, in particular LiNbO₃.

An anode including Li may include a protection layer including silicon, silicon dioxide, Li₄Ti₅O₁₂, Li₃V₂O₅, Au, Ag, Sn, SnO₂, carbon (e.g., amorphous carbon, carbon nanotube, graphene, carbon nanofiber, a fullerene (e.g., C₆₀), hard carbon, or graphite), or a combination thereof. The particle size of the protection materials can be 1 nm to 100 μm, e.g., about 1-100 nm (e.g., about 1-10 nm, 1-25 nm, 10-20 nm, 20-30 nm, 25-50 nm, 30-40 nm, 40-50 nm, 50-60 nm, 50-75 nm, 60-70 nm, 70-80 nm, 75-100 nm, 80-90 nm, or 90-100 nm, e.g., about 1 nm, 5 nm, 10 nm, 20 nm, 30 nm, 40 nm, 50 nm, 60 nm, 70 nm, 80 nm, 90 nm, or 100 nm), e.g., about 100-1000 nm (e.g., about 100-110 nm, 100-125 nm, 100-200 nm, 200-300 nm, 250-500 nm, 300-400 nm, 400-500 nm, 500-600 nm, 500-750 nm, 600-700 nm, 700-800 nm, 750-1000 nm, 800-900 nm, or 900-1000 nm, e.g., about 100 nm, 200 nm, 300 nm, 400 nm, 500 nm, 600 nm, 700 nm, 800 nm, 900 nm, or 1000 nm), e.g., about 1-10 μm (e.g., about 1-2 μm, 1-5 nm, 2-3 μm, 3-4 μm, 4-5 μm, 5-10 μm, 5-6 μm, 6-7 μm, 7-8 μm, 8-9 μm, or 9-10 μm, e.g., about 1 μm, 2 μm, 3 μm, 4 μm, 5 μm, 6 μm, 7 μm, 8 μm, 9 μm, or 10 μm), or, e.g., about 10-100 μm (e.g., about 10-20 μm, 10-25 μm, 10-50 μm, 20-30 μm, 25-50 μm, 30-40 μm, 40-50 μm, 50-60 μm, 50-75 μm, 60-70 μm, 75-100 μm, 70-80 μm, 80-90 μm, or 90-100 μm, e.g., about 10 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 40 μm, 50 μm, 60 μm, 70 μm, 80 μm, 90 μm, or 100 μm) . . . . The protection layer can be mixed with the Li metal and/or polymer with a thickness of 0 μm-500 μm. The lithium metal layer can be protected by a layer formed by one or more elements of Na, Mg, Al, Si, K, Ca, Sc, Ti, V, Cr, Mn, Fe, Co, Ni, Cu, Zn, Ga, Ge, As, Rb, Sr, Y, Zr, Nb, Mo, Ag, Cd, In, Sn, Sb, Bi, Cs, or Te. The lithium metal layer can be alloyed with one or more elements of Na, Mg, Al, Si, K, Ca, Sc, Ti, V, Cr, Mn, Fe, Co, Ni, Cu, Zn, Ga, Ge, As, Rb, Sr, Y, Zr, Nb, Mo, Ag, Cd, In, Sn, Sb, Bi, Cs, or Te.

In particular embodiments, the solid state electrolyte multilayer is separated from the anode and/or the cathode by a protection layer including silicon, Li₄Ti₅O₁₂, Li₃V₂O₅, silicon dioxide, carbon (e.g., amorphous carbon, carbon nanotube, graphene, carbon nanofiber, fullerene (e.g., C₆₀), hard carbon, or graphite, e.g., as a graphite coating on the electrodes), Au, Ag, Sn, SnO₂ or a combination thereof. The particle size of the protection materials can be 1 nm to 100 μm, e.g., about 1-100 nm (e.g., about 1-10 nm, 1-25 nm, 10-20 nm, 20-30 nm, 25-50 nm, 30-40 nm, 40-50 nm, 50-60 nm, 50-75 nm, 60-70 nm, 70-80 nm, 75-100 nm, 80-90 nm, or 90-100 nm, e.g., about 1 nm, 5 nm, 10 nm, 20 nm, 30 nm, 40 nm, 50 nm, 60 nm, 70 nm, 80 nm, 90 nm, or 100 nm), e.g., about 100-1000 nm (e.g., about 100-110 nm, 100-125 nm, 100-200 nm, 200-300 nm, 250-500 nm, 300-400 nm, 400-500 nm, 500-600 nm, 500-750 nm, 600-700 nm, 700-800 nm, 750-1000 nm, 800-900 nm, or 900-1000 nm, e.g., about 100 nm, 200 nm, 300 nm, 400 nm, 500 nm, 600 nm, 700 nm, 800 nm, 900 nm, or 1000 nm), e.g., about 1-10 μm (e.g., about 1-2 μm, 1-5 nm, 2-3 μm, 3-4 μm, 4-5 μm, 5-10 μm, 5-6 μm, 6-7 μm, 7-8 μm, 8-9 μm, or 9-10 μm, e.g., about 1 μm, 2 μm, 3 μm, 4 μm, 5 μm, 6 μm, 7 μm, 8 μm, 9 μm, or 10 μm), or, e.g., about 10-100 μm (e.g., about 10-20 μm, 10-25 μm, 10-50 μm, 20-30 μm, 25-50 μm, 30-40 μm, 40-50 μm, 50-60 μm, 50-75 μm, 60-70 μm, 75-100 μm, 70-80 μm, 80-90 μm, or 90-100 μm, e.g., about 10 μm, 12 μm, 13 μm, 14 μm, 15 μm, 16 μm, 17 μm, 18 μm, 19 μm, 20 μm, 21 μm, 22μ, 23μ, 24 μm, 25 μm, 26 μm, 27 μm, 28 μm, 29 μm, 30 μm, 40 μm, 50 μm, 60 μm, 70 μm, 80 μm, 90 μm, or 100 μm).

For batteries using Na, Na metal may include a protection layer including silicon, silicon dioxide, Na₄Ti₅O₁₂, Na₃V₂O₅, carbon (hard carbon, amorphous carbon, carbon nanotube, graphene, carbon nanofiber, fullerene (e.g., C₆₀), hard carbon, or graphite), Au, Ag, Sn, SnO₂ or a combination thereof. The particle size of the protection materials can be 1 nm to 100 μm, e.g., about 1-100 nm (e.g., about 1-10 nm, 1-25 nm, 10-20 nm, 20-30 nm, 25-50 nm, 30-40 nm, 40-50 nm, 50-60 nm, 50-75 nm, 60-70 nm, 70-80 nm, 75-100 nm, 80-90 nm, or 90-100 nm, e.g., about 1 nm, 5 nm, 10 nm, 20 nm, 30 nm, 40 nm, 50 nm, 60 nm, 70 nm, 80 nm, 90 nm, or 100 nm), e.g., about 100-1000 nm (e.g., about 100-110 nm, 100-125 nm, 100-200 nm, 200-300 nm, 250-500 nm, 300-400 nm, 400-500 nm, 500-600 nm, 500-750 nm, 600-700 nm, 700-800 nm, 750-1000 nm, 800-900 nm, or 900-1000 nm, e.g., about 100 nm, 200 nm, 300 nm, 400 nm, 500 nm, 600 nm, 700 nm, 800 nm, 900 nm, or 1000 nm), e.g., about 1-10 μm (e.g., about 1-2 μm, 1-5 nm, 2-3 μm, 3-4 μm, 4-5 μm, 5-10 μm, 5-6 μm, 6-7 μm, 7-8 μm, 8-9 μm, or 9-10 μm, e.g., about 1 μm, 2 μm, 3 μm, 4 μm, 5 μm, 6μ, 7μ, 8μ, 9 μm, or 10 μm), or, e.g., about 10-100 μm (e.g., about 10-20 μm, 10-25 μm, 10-50 μm, 20-30 μm, 25-50 μm, 30-40 μm, 40-50 μm, 50-60 μm, 50-75 μm, 60-70 μm, 75-100 μm, 70-80 μm, 80-90 μm, or 90-100 μm, e.g., about 10 μm, 12 μm, 13 μm, 14 μm, 15 μm, 16 μm, 17 μm, 18 μm, 19 μm, 20 μm, 21 μm, 22 μm, 23 μm, 24 μm, 25μ, 26μ, 27 μm, 28μ, 29μ, 30μ, 40μ, 50 μm, 60 μm, 70 μm, 80μ, 90 μm, or 100μ m). The protection layer can be mixed with Na metal and/or polymer with a thickness of 0 μm-500 μm. The sodium metal layer can be protected by a layer formed by one or more elements of Li, Mg, Al, Si, K, Ca, Sc, Ti, V, Cr, Mn, Fe, Co, Ni, Cu, Zn, Ga, Ge, As, Rb, Sr, Y, Zr, Nb, Mo, Ag, Cd, In, Sn, Sb, Bi, Cs, or Te. The protection layer can include sodium metal alloyed with one or more elements of Li, Mg, Al, Si, K, Ca, Sc, Ti, V, Cr, Mn, Fe, Co, Ni, Cu, Zn, Ga, Ge, As, Rb, Sr, Y, Zr, Nb, Mo, Ag, Cd, In, Sn, Sb, Bi, Cs, or Te.

An Na cathode can be coated with NaNbO₃, NaTaO₃, Na₂ZrO₃, NaNbₓTa₁₋ₓO₃ (0≤x≤1), yNa₂ZrO₃-(1-y)NaNbₓTa₁₋ₓO₃ (0≤x, y≤1), Al₂O₃, TiO₂, ZrO₂, AlF₃, MgF₂, SiO₂, ZnS, ZnO, Na₄SiO₄, NasPO₄, NasInCl₆, Na₁₋ₓAlₓTi₂₋ₓ (PO₄)₃ (0<x<2), NaMn₂O₄, NaInO₂—NaI, Na₆PS₅Cl, NaAlO₂, and carbon.

Indium may also be used to coat the electrodes.

In some embodiments, electrode coatings may include polyethylene oxide, polyvinylidene fluoride, poly(vinylidene fluoride-co-hexafluoropropylene), poly(ethyl methacrylate), or poly(vinylidene fluoride-co-trifluoroethylene).

### Battery Performance

In some embodiments, the battery retains at least 80% of capacity after at least 10,000 charge-discharge cycles from 20C to 100C-rate, e.g., at 2 mg/cm² cathode loading, with an initial capacity higher than 80 mAh/g and a current density higher than 8 mA/cm². In some embodiments, the battery can cycle at a current density from 0.001 mA/cm² to 100 mA/cm². In some embodiments, the battery cathode material has a power density of at least 10 kW/kg. In some embodiments, the battery cathode material has an energy density of at least 600 Wh/kg (e.g., 631 Wh/kg). Batteries of the invention may have average Coulombic efficiency of 99.96% or higher at 20C and 100.00% at 15C across all the thousands of cycles, with the highest power density reaching 11.9 kW/kg and the energy density up to 631 Wh/kg at the cathode active material level. Batteries of the invention may have low Coulombic inefficiency, e.g., on the order of 104 to 103.

### EXAMPLES

### Methods Summary—for Examples 1-3

Li_{5.5}PS_{4.5}Cl_{1.5} (LPSCl) was prepared by high energy ball milling, followed by a post annealing treatment. Stoichiometric amounts of powders of Li₂S ((>99.9% purity, Alfa Aesar)), P₂S₅ (S>99% purity, Sigma Aldrich) and LiCl (>99% purity, Alfa Aesar) were milled for 16 hours in a planetary mill PM200 (Retsch GmbH, Germany) under a protective Argon atmosphere. Subsequently, the ball milled powder was transferred to quartz tubes and heated at 500° C. for 1 hour, using heating and cooling rates of 5 and 1° C. min-1, respectively.

Li_{9.54}Si_{1.74} (P_{0.9}Sb_{0.1})_{1.44}S_{11.7}Cl_{0.3} (LSPS) was prepared using the same method. Li₂S (>99.9% purity, Alfa Aesar), SiS₂ (>99% purity, American Elements), P₂S₅ (>99% purity, Sigma Aldrich), Sb₂S₅ (Sigma Aldrich), and LiCl (>99% purity, Alfa Aesar) 40 hours (LSPS). A spinning rate of 375 rpm was employed. The powder was heated at 460° C. for 8 hours, using heating and cooling rates of 5 and naturally cooling down. All heating treatments were under Ar gas flow protection.

The ¼″ diameter Li foil with the thickness of 25 μm was covered by a ⅜″ diameter graphite film with a weight ratio of graphite (BTR, China) and PTFE as 95:5. The capacity ratio of Li and graphite is 2.5:1. The cathode layer was made by mixing 30 wt % solid electrolyte and 70 wt % LiCoO₂ (Sigma Aldrich) or LiNi_{0.8} Mn_{0.1}Co_{0.1}O₂ (XTC, China) with a loading of 2 mg/cm². 140 mg Li₁₀Ge₁P₂S₁₂ (MSE Supplies LLC) or LPSCl was employed as electrolyte. For the combined electrolyte, 30 mg LPSCl and 110 mg LGPS (or LSPS) were used. Anode-solid electrolyte-cathode for half battery or anode-electrolyte-anode for symmetric battery were pressed together in a homemade pressurized cell at 467 MPa and kept at 250 MPa during testing. All batteries were assembled in an argon atmosphere glovebox and the galvanostatic battery cycling test was performed on an ArbinBT2000 workstation.

### Example 1

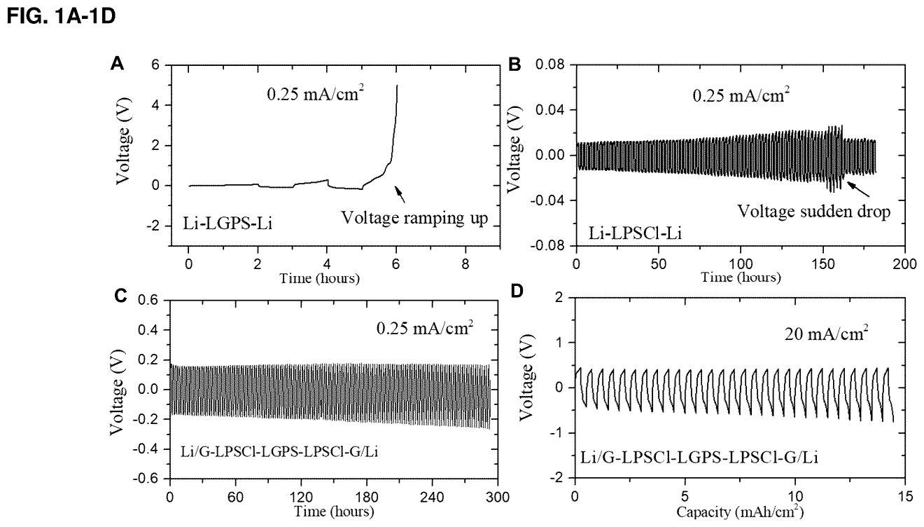

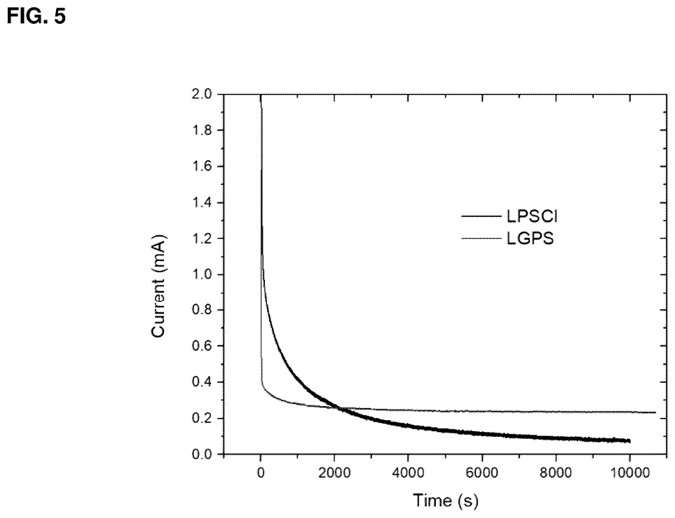

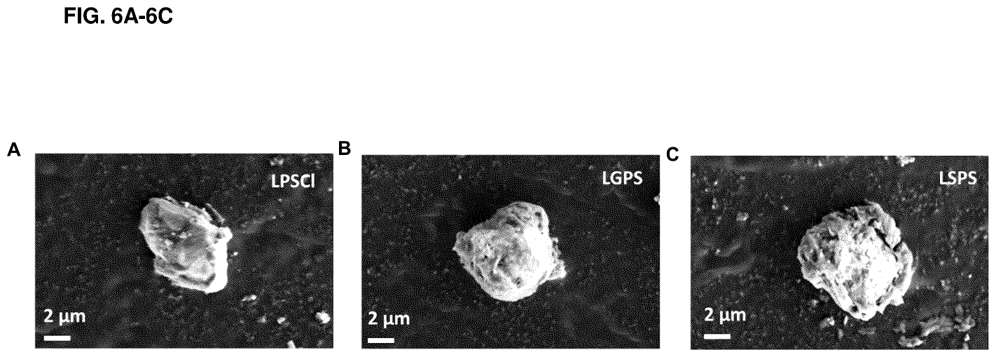

The symmetric battery using pure lithium metal as electrodes and Li₁₀Ge₁P₂S₁₂ (LGPS) as electrolyte can fail quickly with a voltage spark, as shown in FIG. 1A, while Li_{5.5}PS_{4.5}Cl_{1.5} (LPSCl) in such symmetrical battery can run for over 150 hours until a short circuit appears. FIG. 1A and FIG. 1B actually represent two typical failure phenomena, i.e., the overpotential ramping up (electrolyte decomposition) and the voltage sudden decrease (short circuit).^{5,7} Besides the stability difference with Li metal, the two electrolytes actually have very similar physical and (electro) chemical properties^{3,4,7,8}, including ionic and electronic conductivities, particle size and mechanical modulus shown in FIGS. 5 and 6 and Table 15.

TABLE 15

| | Ionic | Electronic | | |
|---|---|---|---|---|
| | conductivity | conductivity | Particle | Yong's |
| Electrolyte | (mS/cm)* | (mS/cm)** | size*** | modulus**** |
| Li₁₀Ge₁P₂S₁₂ (LGPS) | 5.1 | 7.4 × 10⁻⁵ | 1-3 μm | 37.2 |
| Li_{5.5}PS_{4.5}Cl_{1.5} (LPSCI) | 6.2 | 2.8 × 10⁻⁵ | 1-3 μm | 22-30 |
| Li_{9.54}Si_{1.74}(P_{0.9}Sb_{0.1})_{1.44}S_{11.7}Cl_{0.3}(LSPS) | 8.8 | | 1-3 μm | |

*All measurements are based on cold press without heating treatment.
**The orders of magnitude of electronic conductivity measured in the work are consistent with those reported in the literature
***Particle size is measured from SEM images
****Moduli are from previous studies

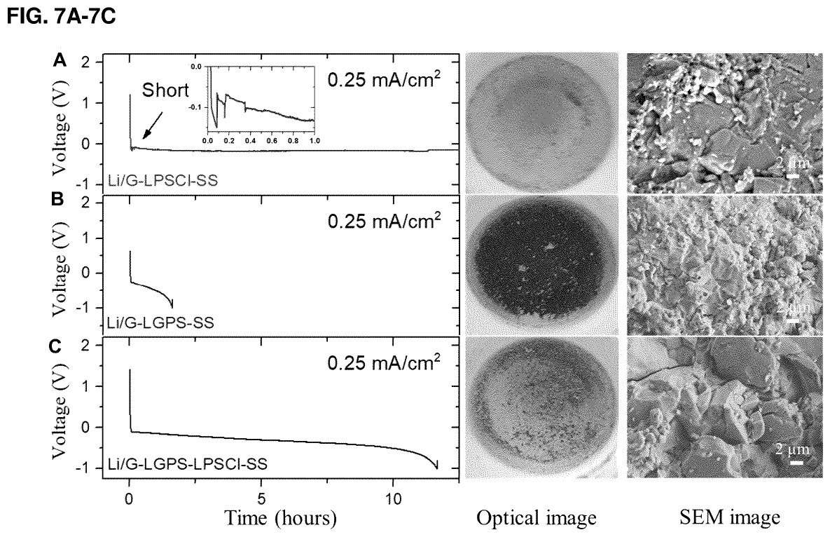

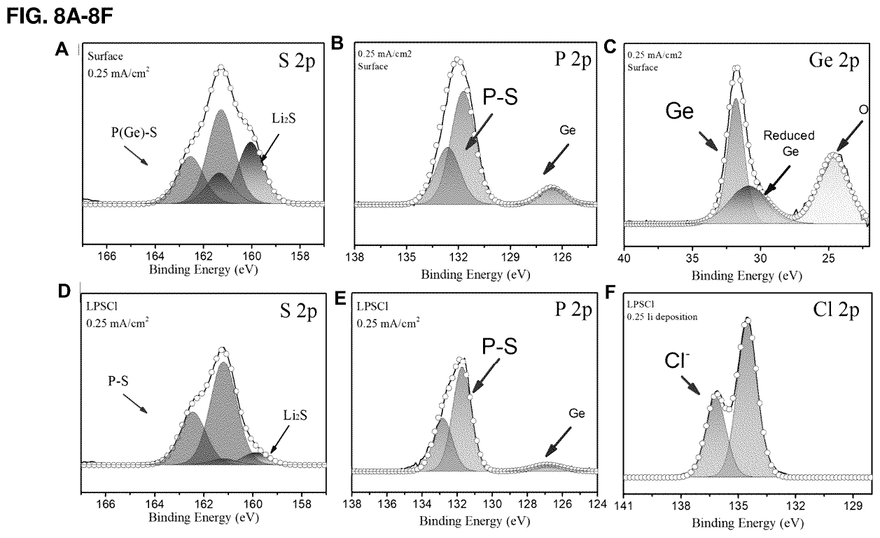

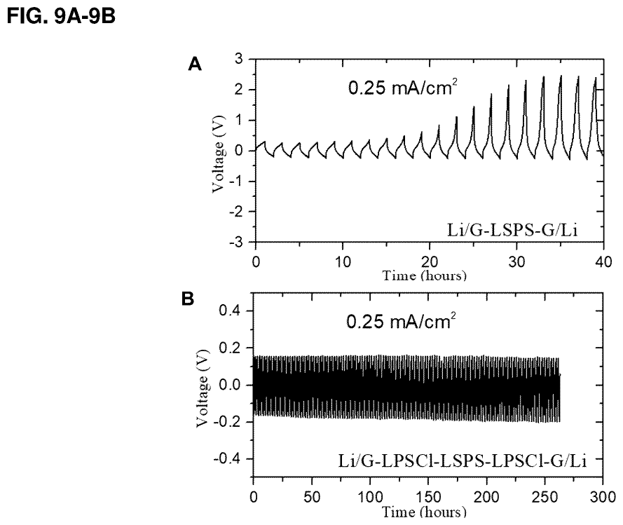

To focus on the most notable difference of the two electrolytes about the stability against lithium metal, lithium was discharged on to LGPS or LPSCl in asymmetric batteries (see, e.g., FIG. 7 and FIG. 8). The surface of LGPS becomes black (see, e.g., FIG. 7B), while that of LPSCl shows no notable color change (see, e.g., FIG. 7A and FIG. 7C). XPS shows that the heavy decomposition of LGPS to Li₂S and reduced Ge^{σ+}, etc., while LPSCl shows almost no decomposition peaks (see FIG. 8A-8F). In FIG. 1C, a symmetric battery about Li metal anodes with our multilayer electrolyte design of LPSCl-LGPS-LPSCl is assembled, where the sequence of the electrolyte names represents the sequence of materials in the battery, and the total thickness of the electrolyte layer keeps the same throughout the paper unless otherwise specified. The two LPSCl outside layers are in direct contact with graphite protected lithium metal to further protect the interfaces (electro) chemically. The combination of electrolytes shows a stable cycling performance for over 300 hours, which is better than any batteries with single type of electrolyte in our tests. The same performance can be obtained by replacing LGPS with Li_{9.54}Si_{1.74} (P_{0.9}Sb_{0.1})_{1.44}S_{11.7}Cl_{0.3} (LSPS) as shown in FIG. 9.

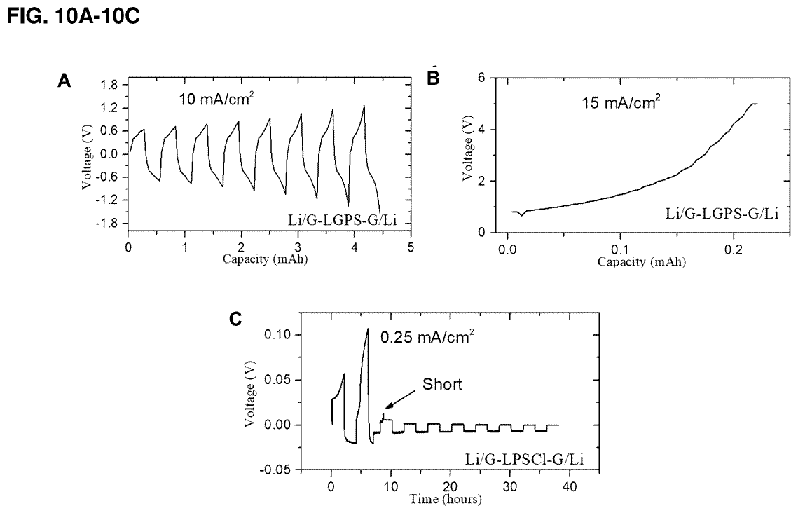

FIG. 1D depicts the cycling performance of the symmetric battery at 20 mA/cm². The battery runs for 30 cycles without notable signal of short-circuit. The charge and discharge curves show a low overpotential of ˜0.5 V with a slight increasing trend in the last few cycles, similar to what was observed before on graphite protected Li metal anode.² However, no short circuit is observed even at this ultra-high current density, indicating that the multilayer structure has a good stability to prevent lithium dendrite penetration. Previously, we have reported that with the protection of graphite layer, a Li/graphite-LGPS-graphite/Li symmetric battery can be tested up to 10 mA/cm². However, the overpotential was much higher (1.5 V at 10 mA/cm²), and it cannot last for long cycles or run at higher current density due to the high overpotential, as shown in FIG. 10. Here the LPSCl layer helps stabilize the primary interface to the Li/graphite layer and lower the overall overpotential, making the practical cycling at high-current density possible.

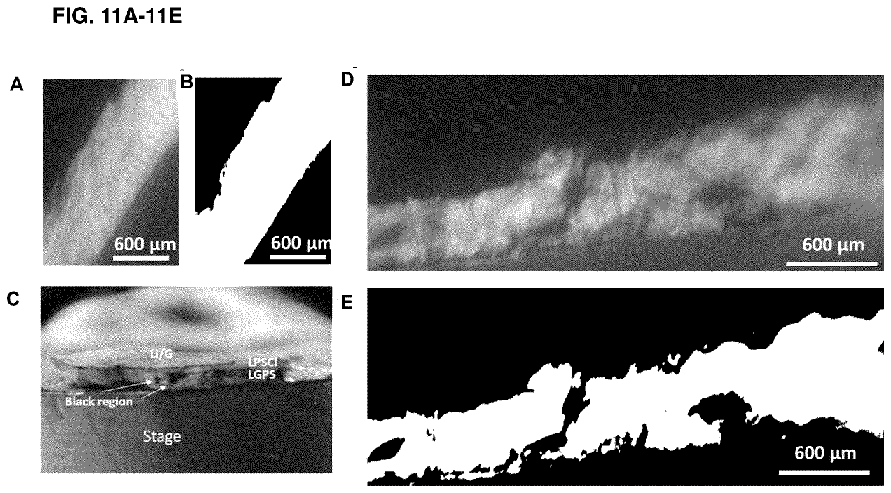

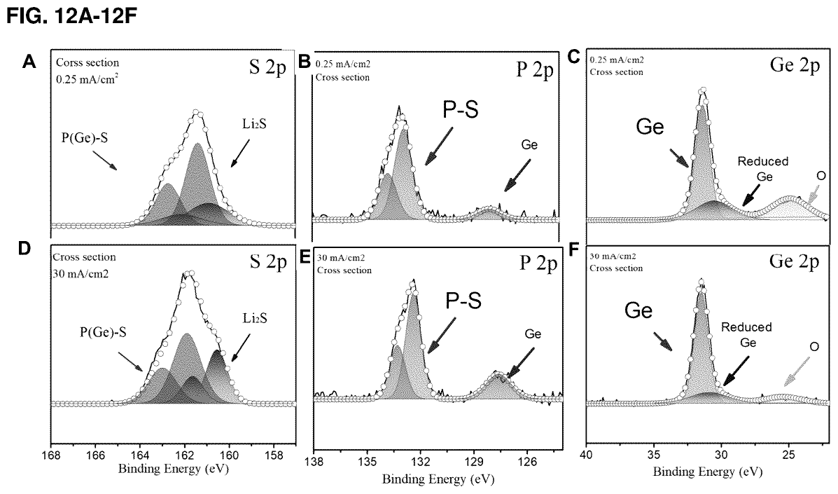

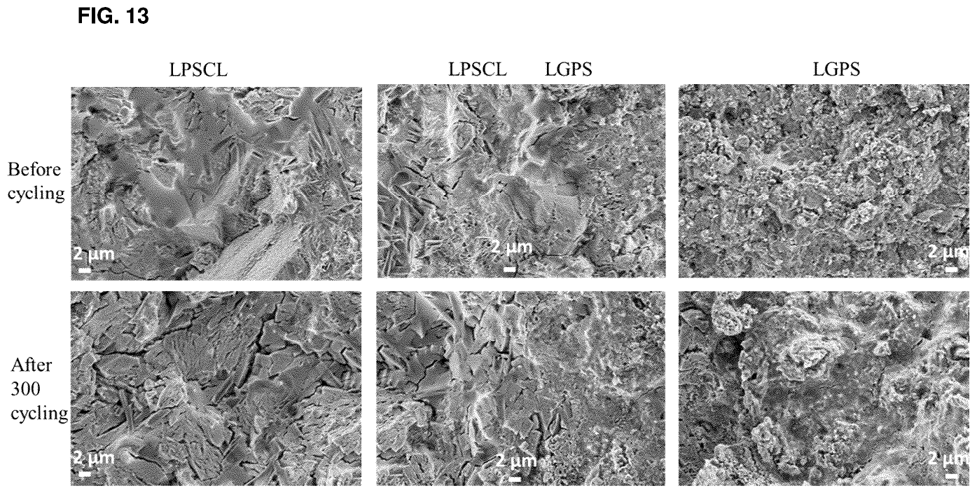

On the other hand, as shown in FIGS. 2A-2B, a clear black region occurs in the cross section optical image of the electrolyte pellet after the symmetric battery running for 300 hours at 0.25 mA/cm². Similar pattern is observed for the battery after 30 cycles at 20 mA/cm² (FIGS. 11A-11E). This is the same color under optical microscope as the decompositions induced by lithium discharged onto the LGPS surface (see FIG. 7B and FIGS. 8A-8C). The black region here, however, is only observed in some limited regions from the cross-section view. As identified by XPS, the decomposition includes moderately reduced Ge, without the highly reduced Ge state in the Li—Ge alloy, at either slow rate (FIG. 12) or high rate (see FIGS. 2C-2D and FIG. 12). In FIGS. 2E-2H, SEM images were taken from three regions of the LPSCl, LGPS layers and their transition region, from the same symmetric battery after cycling for 300 hours. LPSCl shows clear cracks after cycling (FIG. 2E), evolved from the one without observable cracks before cycling (FIG. 13). In contrast, the LGPS layer shows no cracks even after cycling (FIG. 2F). Furthermore, compared with the LGPS before cycling (FIG. 13), many morphology details on the cross-section in the cycled one are smeared out (FIG. 2F), as if it is masked by a “cement” or “concrete” layer, suggesting that some local decomposition happened during the cycling, which may play a critical role here to prevent the crack formation.

Previously, it was predicted that Li—Ge alloys should be the standard decomposition products on the interface between LGPS and Li metal at no mechanical constrictions, e.g., such interface immersed in a liquid electrolyte cell environment.² However, under the testing condition of sufficient local mechanical constriction in our all-solid-state battery design, the suppression of Ge reduction was predicted in computation and observed in XPS, making the decomposition electronically insulating.² Recently, it was found that such mechanical constriction can further provide kinetic stability to effectively inhibit the propagation of LGPS decomposition through ionic passivation, when going far beyond the voltage (meta) stability window, and stabilize LGPS up to 10V.⁹ Here, mechanical constriction is likely to inhibit further propagation of the decomposition interface between LGPS and Li dendrite at 0 V by such ionic and electronic passivations. Therefore, this well-constrained decomposition serves as a self-decomposed “cement” or “concrete” to fill all the micron or submicron sized cracks that either preexisted during battery assembly or emerged during battery cycling, enabling a high current density cycling without the short-circuit induced by the Li dendrite penetration.

### Example 2

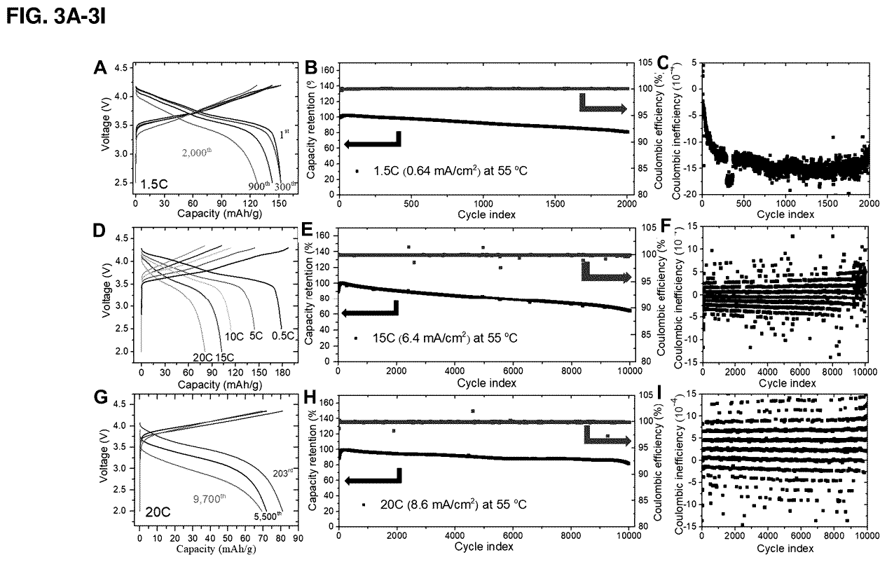

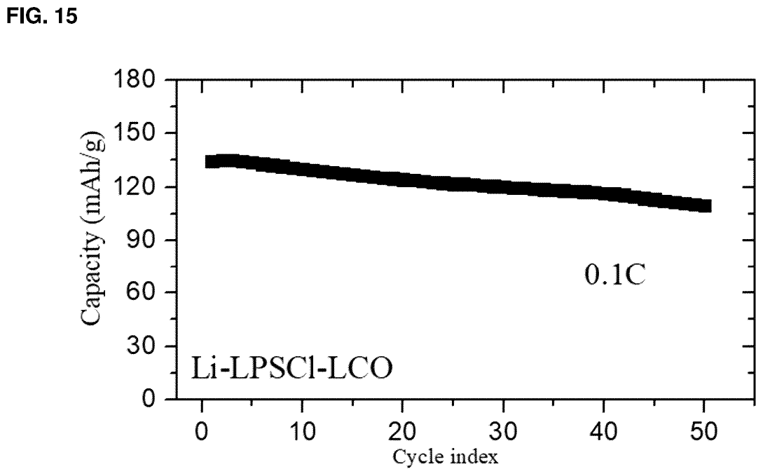

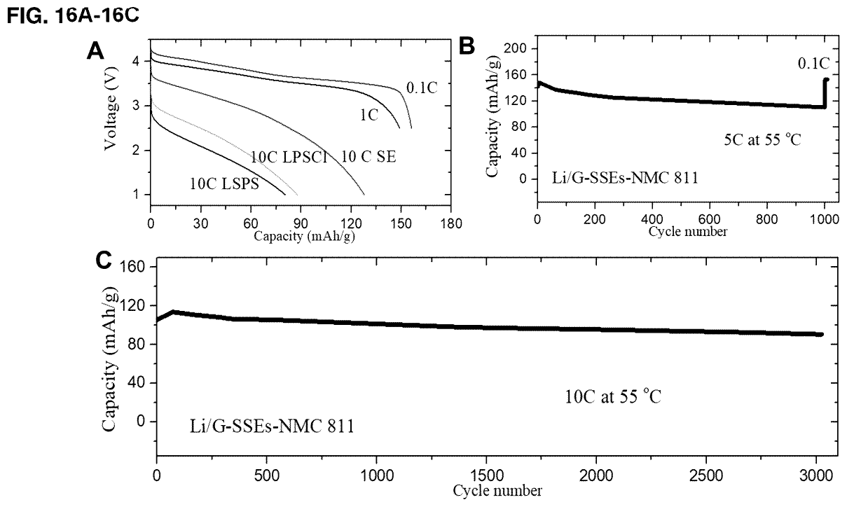

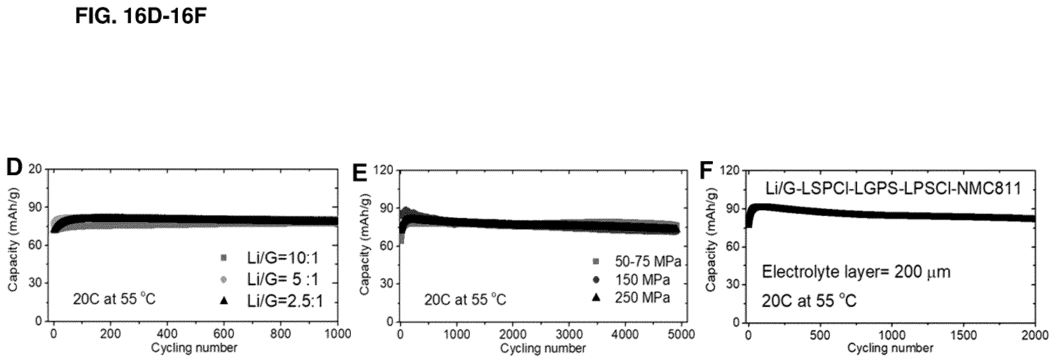

In order to demonstrate the uniqueness and practical application of the multilayer design, batteries of the single layer electrolyte design with lithium metal anode and high voltage cathode of NMC811 are made using various electrolytes. The solid-state battery configuration with the multilayer design shows significantly improved battery performances for NMC811 cathode paired with Li metal anode (FIG. 3, FIG. 15). The discharge capacity of the multilayer electrolyte design (LPSCl-LSPS-LPSCl) at 10C is 127 mAh/g, after a slow charge of 0.1C at room temperature with a low cut-off voltage of 1.0 V, which is larger than the capacity of single layer design with either LPSCl (87.9 mAh/g) or LSPS (80.6 mAh/g) electrolyte (FIG. 16A).

At elevated temperature (55° C.) and low cycling rate, the solid-state battery shows a 155.7 mAh/g capacity at 1.5C. After 600 cycles, the battery shows almost no degradation with 97.7% capacity retention (FIGS. 3A and 3B), better than most currently reported cycling performance. This indicates that the interface between cathode materials (NMC811) and solid electrolyte (LPSCl) is very stable. By comparing it with NMC811 liquid battery, the mechanical constrictive environment here should play an important role that prevents the degradation of NMC811, LPSCl and their interfaces.⁹ At high rate, the battery shows a discharge capacity of 144.1 mAh/g at 5C charge and 5C discharge, 114.4 mAh/g at 10C, 102.2 mAh/g at 15C, and 81.0 mAh/g at 20C as shown in FIG. 3D. The solid-state battery after 1000 cycling at 5C shows 77.8% capacity retention, which can be cycled back to 153.0 mAh/g at 0.1C after 1000 long cycling (FIG. 16B). This means that after the use in electrical vehicles, such a battery can be reused for the application of stationary energy storage system. The battery at 10C shows a capacity retention of 85.7% after 3000 cycles (FIG. 16C). Furthermore, the Li/G capacity ratio in the anode composite can be further increased to 10:1, equivalent to an anode specific capacity around 2000 mAh/g, indicating a large room to engineer the battery energy density further (FIG. 16D). In addition, the invention demonstrated that the operating stack pressure can be easily reduced to 50-75 MPa without sacrificing the electrochemical performance of our design (FIG. 16E). Another very promising aspect the invention is that the stability of the multilayer structure is originated from the designed combination of (electro) chemical stability and instability, which is not sensitive to the thickness and the micron crack density of the electrolyte layers in the initial battery assembly, so that the electrolyte layer thickness can be further reduced (FIG. 16F).

### Example 3

To further demonstrate the stability of the multilayer batteries of the invention against Li dendrite under extreme cycling conditions, a graphite covered Li—LiNi_{0.8}Mn_{0.1}Co_{0.1}O₂ (Li/G-NMC811) batteries with Li_{5.5} PS_{4.5}Cl_{1.5} Li_{9.54}Si_{1.74} (P_{0.9}Sb_{0.1})_{1.44}S_{11.7}Cl_{0.3} (LPSCl-LSPS-LPSCl) as the electrolyte was cycled at 15 and 20C up to 10,000 cycles. The battery shows a capacity retention of 90% after 3,000 cycles and 70% after 9,300 cycles at 15C (FIG. 3E) and a Coulombic inefficiency on the order of 10⁻⁴˜10⁻⁵ (FIG. 3F). At the high rate of 20C, the charge and discharge profiles (FIG. 3G) still show very limited shape change after long cycling, and the capacity retention is as high as 82% (FIG. 3H) with the Coulombic inefficiency on the order of 10⁻³˜10⁻⁴ (FIG. 3I). Note that the average Coulombic inefficiency for the battery cycling at 20C is 0.04%, or 99.96% efficiency, and that at 15C is −0.0009%, or 100.0009% efficiency. The high Coulombic efficiency together with long cycling performance indicates no detrimental side reactions happened in the system, which has not been reported from lithium metal battery systems, and is only rarely reported in other lithium ion batteries, whether the electrolyte is solid or liquid.¹⁰ The energy density and power density in this work are much higher compared with previously reported performance (FIG. 4B).^{6,11-13} Note that the small negative sign in the efficiency here at 15C indicates that small amount of lithium was replenished from the lithium metal anode. This is an advantage of lithium metal anode over the anode-free batteries,⁶ as even a very thin layer of lithium metal can be beneficial to the cycling performance.

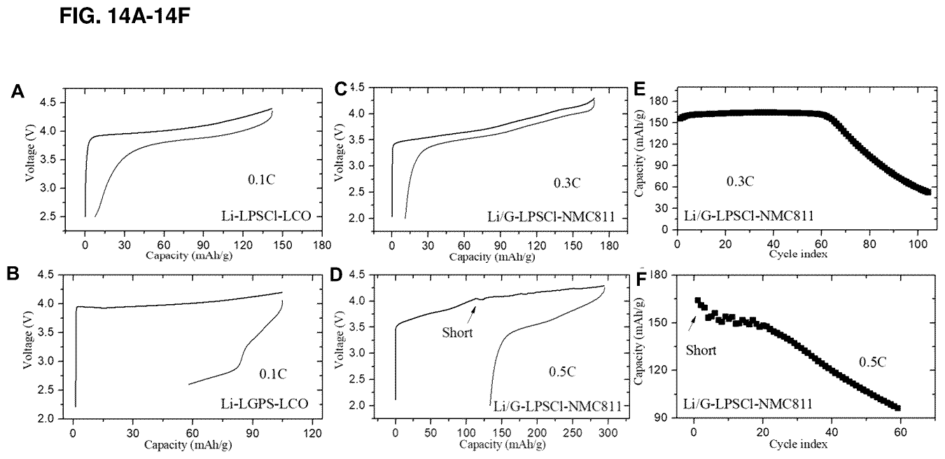

On the contrary, and consistent with the results from the symmetric battery tests, the irreversible capacity in the first cycle is small in the Li-LPSCl-LCO battery (see FIG. 14). It can retain for at least 50 cycles without high capacity loss (see FIG. 15), due to the stability of LPSCl with the lithium metal, as well as the cathode materials. In contrast, the reaction on the primary interface between LGPS and lithium metal layers leads to a high irreversible capacity (see, e.g., FIG. 14B).

FIG. 14C shows the charge and discharge curve of LPSCl battery with graphite protected lithium as anode² and uncoated NMC811 as cathode, where 30 wt % LPSCl is well mixed with NMC811 in the cathode layer. The battery shows good cycling performance at low cycling rate (FIG. 14E) in the first 60 cycles, which indicates a good interface stability between LPSCl and NMC811. The sudden capacity decrease after 60 cycles is due to the dendrite penetration through the cracks as discussed in FIG. 2. At a higher current density (0.5C), the battery with Li/G-LPSCl-NMC811 construction shows a signal of micro-short circuit at the very beginning of cycling (see FIG. 14D), which leads to a poor cycling performance (see FIG. 14F). The battery configuration and materials used are summarized in Table 16.

TABLE 16

| Battery | Anode | Electrolyte | Cathode |
|---|---|---|---|
| Li-LGPS-LCO | pure lithium | 140 mg LGPS | 70 wt % LiNbO₃ coated LCO |
| | | | 30 wt % LGPS |
| | | | 3 wt % extra PTFE |
| Li-LPSCI-LCO | pure lithium | 140 mg LPSCI | 70 wt % uncoated LCO |
| | | | 30 wt % LPSCI |
| | | | 3 wt % extra PTFE |
| Li/G-LPSCI-NMC811 | graphite covered lithium | 140 mg LPSCI | 70 wt % uncoated NMC811 |
| | (capacity ratio G:Li = 1:2.5) | | 30 wt % LPSCl |
| | | | 3 wt % extra PTFE |
| Li/G-LPSCI-LSPS- | graphite covered lithium | 20 mg LPSCI | 70 wt % uncoated NMC811 |
| LPSCI-NMC811 | (capacity ratio G:Li = 1:2.5) | 100 mg LSPS | 30 wt % LPSCI |
| | | 20 mg LPSCI | 3 wt % extra PTFE |
| Li/G-LSPS-LPSCI- | graphite covered lithium | 120 mg LSPS | 70 wt % uncoated NMC811 |
| NMC811 | (capacity ratio G:Li = 1:2.5) | 20 mg LPSCI | 30 wt % LPSCI |
| | | | 3 wt % extra PTFE |

### Example 4

The solid-state electrolyte design strategy of the invention was demonstrated experimentally by doping the original electrolyte material of Li argyrodite electrolyte Li_{5.5}PS_{4.5}Cl_{1.5} (LPSCl). Both LPSCl and doped LPSCl-X, e.g., Li_{5.5}PS_{4.5}Cl_{1.5-y}X_{y} (X=F, Br or I; y=0.4 for F, 0.15 for Br and I), were synthesized by solid-state reactions, followed by SSB assembly using graphite protected Li metal as the anode and NMC811 (LiNi_{0.83}Mn_{0.06}Co_{0.11}O₂ in this Example) single crystal particles as the cathode, with a multilayer electrolyte configuration following our recent approach (See Methods). By replacing the central layer of LPSCl with LPSCl-X with the compositional modification guided by our computational design, batteries of the invention demonstrate a super long cycling performance of over 25,000 cycles at a high current density of 8.6 mA/cm² (or 20C-rate). Moreover, high capacities of SSBs with various interfaces between cathode and electrolyte particles, and between multiple electrolyte layers have been demonstrated for NMC811, reaching 197 mAh/g at 0.5C-rate, around 180 mAh/g at 1.5C-rate. Such batteries of the invention can also show very different capacities at 20C-rate, i.e., an impressive 120 mAh/g v.s. a good 90 mAh/g (1C=150 mAh/g or 0.43 mA/cm²).

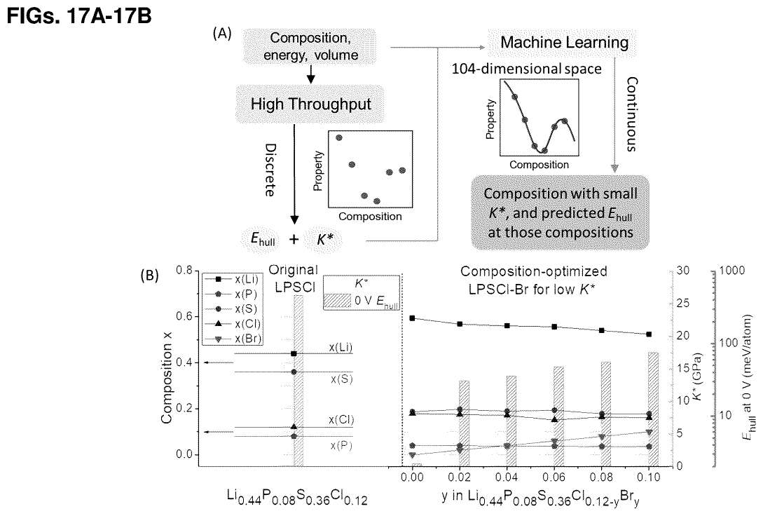

FIG. 17A shows the computational design procedure for new compositions with lower K*. With the materials information of composition, energy and volume from ab initio Density Functional Theory (DFT) based simulations, the hull energy Eₕᵤₗₗ at 0V and the critical modulus K* of 124,497 materials at the interface to Li metal were calculated (See Methods for computational details). By applying machine learning to model the macroscopic properties (composition, energy) and target values (Eₕᵤₗₗ, K*), we determined a relation from the discrete data points in a high dimensional parameter space generated by high throughput calculations. The relation was further extrapolated to a continuous compositional space to perform composition optimization toward smaller K for any composition as the input.

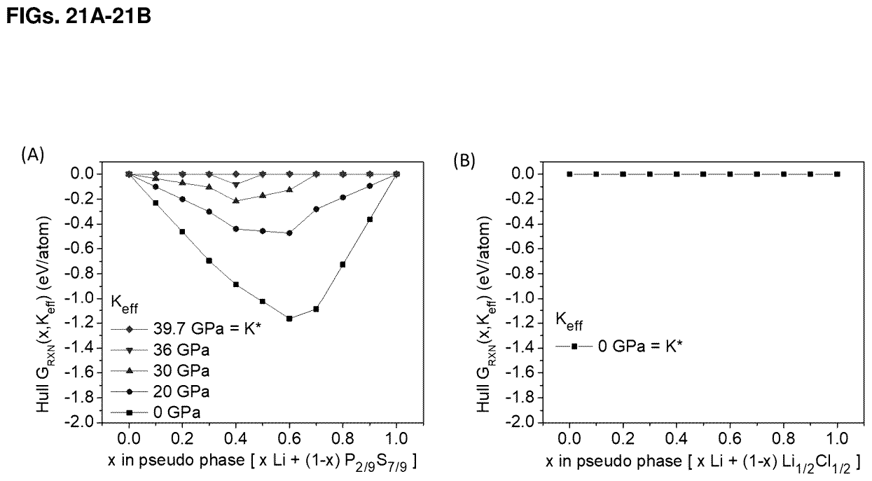

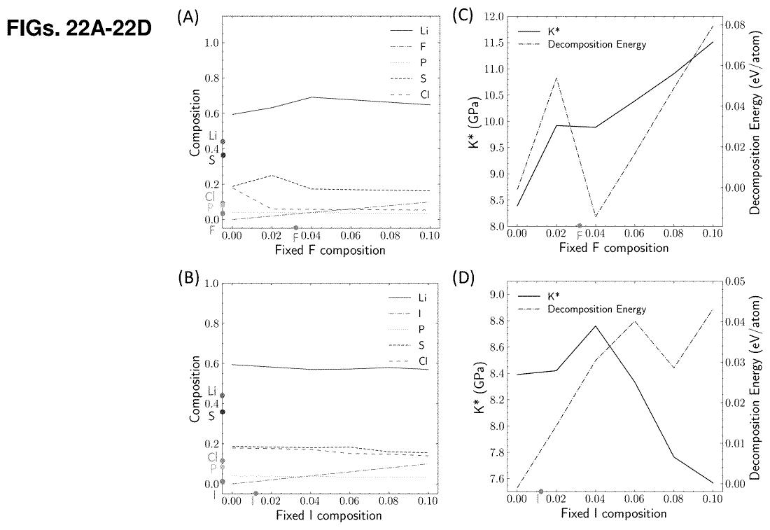

FIG. 17B shows the machine learning prediction of the required composition change to minimize K* for LPSCl-Br. Compared with the original LPSCl composition, minimizing K* by composition change without doping any new elements (y=0.00) can already reduce K* from 25.1 GPa to 8.4 GPa, where the LPSCl composition was optimized to be S, P deficient and CI, Li rich. Further doping Br with composition (y) from 0 to 0.2 and minimizing K* increases Eₕᵤₗₗ from 0 meV/atom to 30-75 meV/atom (still much lower than the 500 meV/atom of original LPSCl), with minor composition changes of other elements. Note that the 0 eV reference state for decomposition energy with Li metal in machine learning was aligned with the DFT result based on LiCl that was stable at 0 V (see methods, below, and FIG. 21). Similar compositional trends were also predicted for LPSCl-I and LPSCl-F (FIG. 22). Therefore, based on our picture such compositions with F, Br and I doping are likely to show low K* and sufficient Eₕᵤₗₗ to stabilize the Li metal anode.

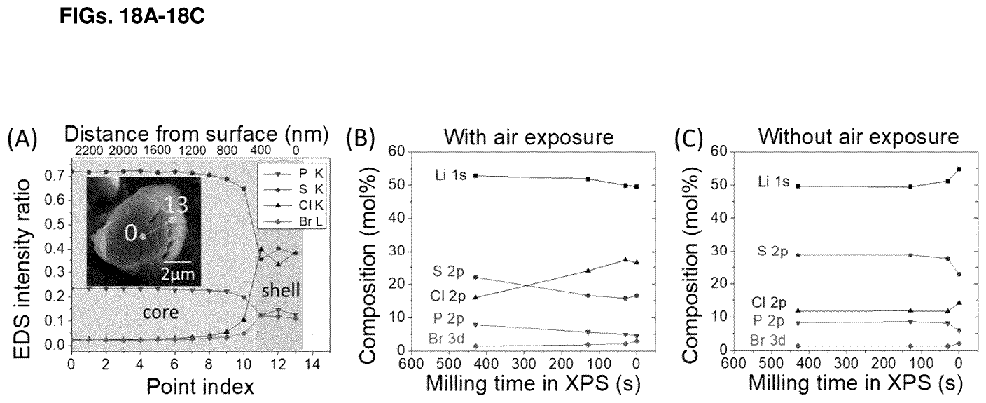

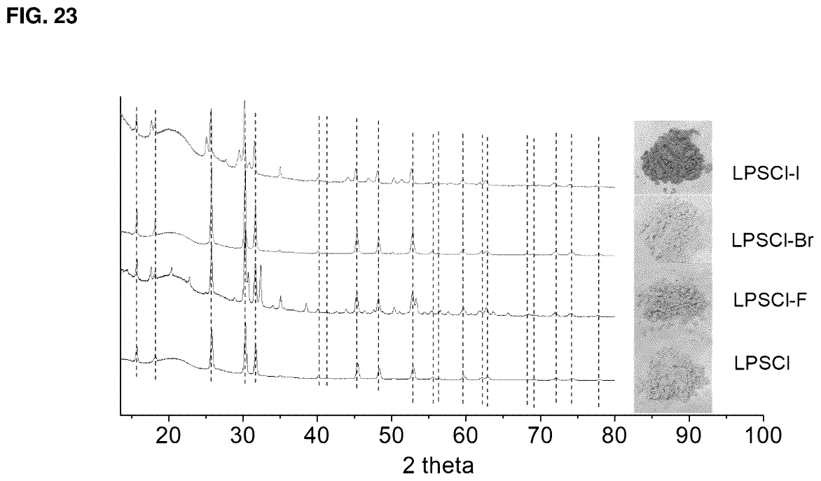

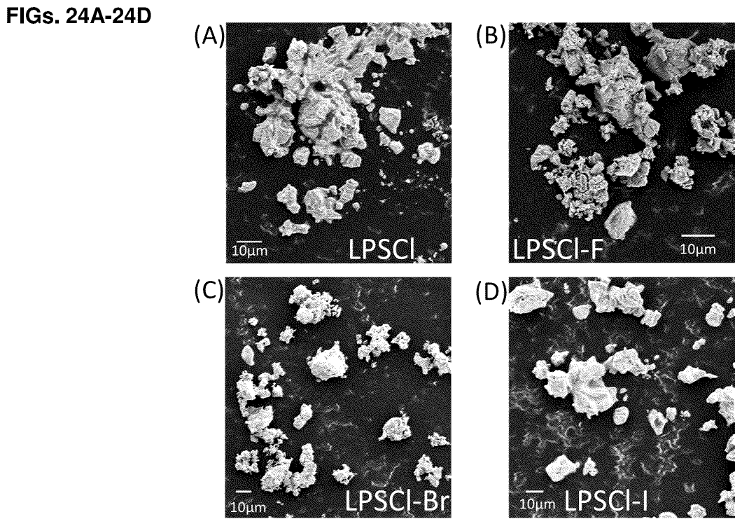

Core-shell LPSCl-X electrolytes were synthesized by solid state reactions (see Methods, below), whose x-ray diffraction (XRD), optical photographs and scanning electron microscopy (SEM) images can be found in FIGS. 23 and 24. LPSCl-X showed the same F-43m space group as the parent LPSCl and similar particle sizes. A core-shell structure was found in LPSCl-Br by energy dispersive spectroscopy (EDX) in SEM and X-ray photoelectron spectroscopy (XPS) from cross sections of particles milled by ion beams (FIG. 18). Thus, EDX line profile in FIG. 18A shows that the LPSCl-Br shell is P, S deficient and CI, Br rich.

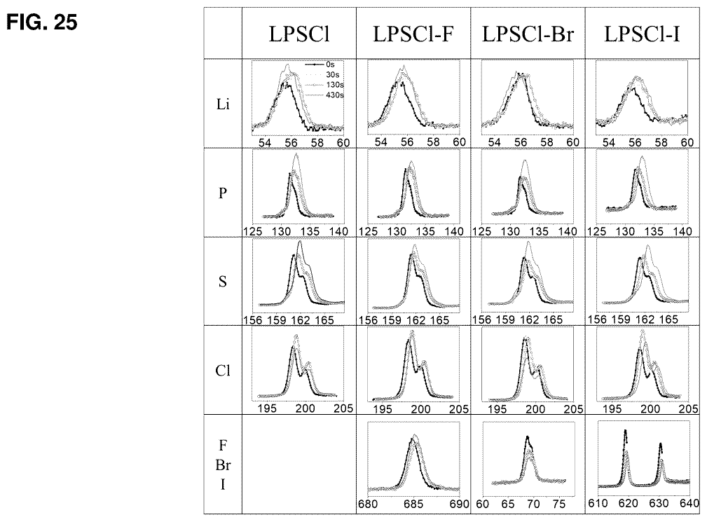

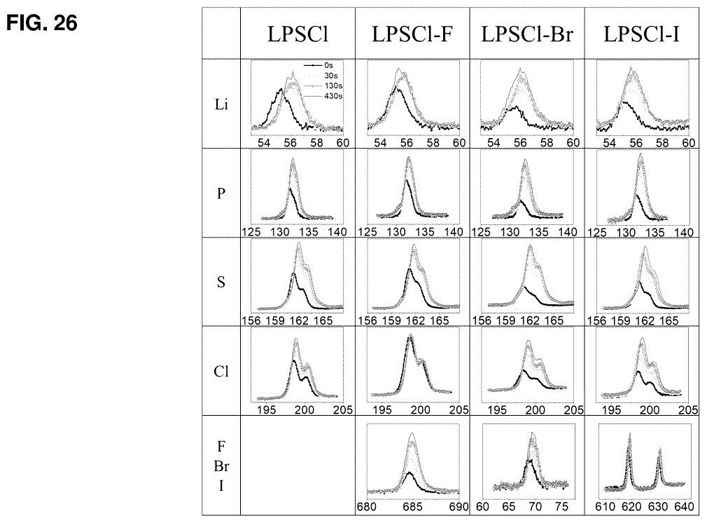

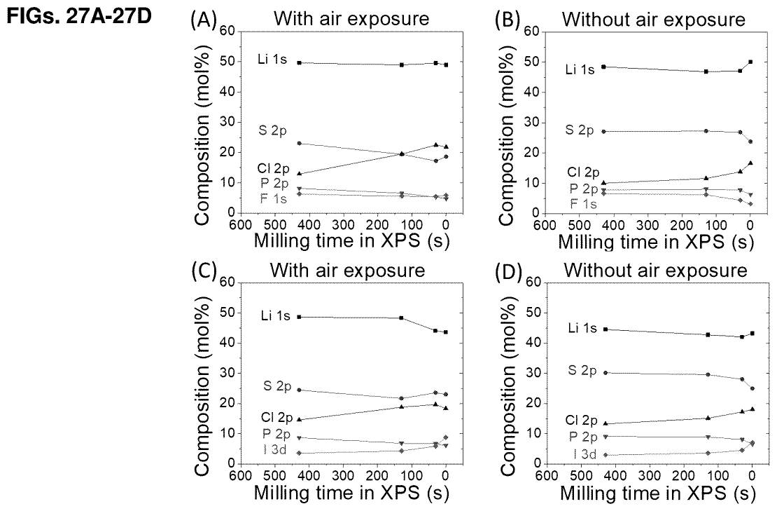

FIG. 2B shows the XPS quantification of elemental compositions at different ion-milling depth, which also shows a consistent core-shell compositional trend to EDX, accompanied by the information of Li deficiency in the shell. Note that both samples of SEM-EDX in FIG. 18A and XPS in FIG. 18B were with a short air exposure in the sample transfer. FIG. 18C shows the XPS result of the sample without any air exposure. Although the shell region is now better defined and more limited to the particle surface, the same core-shell compositional trend still holds, except for the Li one. Similar trends are also found in LPSCl-F and LPSCl-I (FIG. 27), with the original XPS data shown in FIG. 25 and FIG. 26. The shell compositional changes, especially the ones without the air contamination, are consistent with the predicted trend from minimizing K* (FIG. 21B, FIG. 22), suggesting that during high temperature synthesis the relatively low surface tension may also play the role of the surface effective modulus K_{eff} that can minimize the surface critical modulus K* through composition gradient, as a stable surface during synthesis should satisfy K*<K_{eff}^{s}.

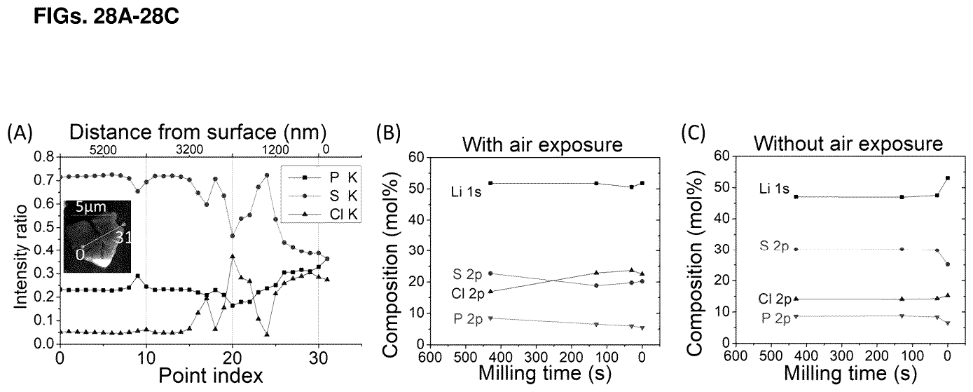

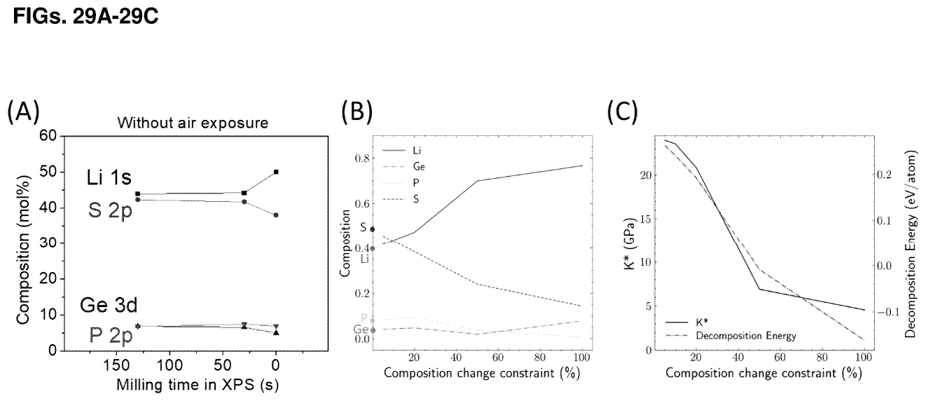

Note that our EDX and XPS analyses of the original LPSCl without Br doping also show a core-shell structure with a shell region of Li and Cl rich, and S deficient compositions (FIG. 28). Due to the much lower Eₕᵤₗₗ value suggested by machine learning predictions at y=0.00 after K* minimization (FIG. 17B, right panel), the shell composition of LPSCl is likely to be more stable with Li metal than the core, which may explain previous experiments that the Li argyrodite electrolyte LPSCl can cycle in a direct contact with the Li metal, albeit of the high Eₕᵤₗₗ predicted based on the core composition (FIG. 17B, left panel). We note that a common sulfide electrolyte of Li₁₀GeP₂S₁₂ (LGPS) also shows a Li rich and S deficient shell, with the predicted compositional trend toward lower K* of around 15 GPa, while still maintaining a relatively high Eₕᵤₗₗ (FIG. 29), consistent with previous DFT and experimental findings that LGPS is less stable with Li metal.

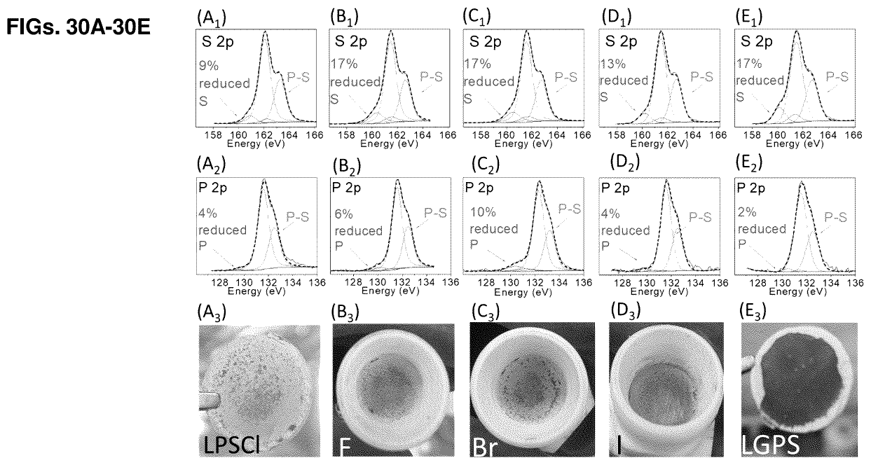

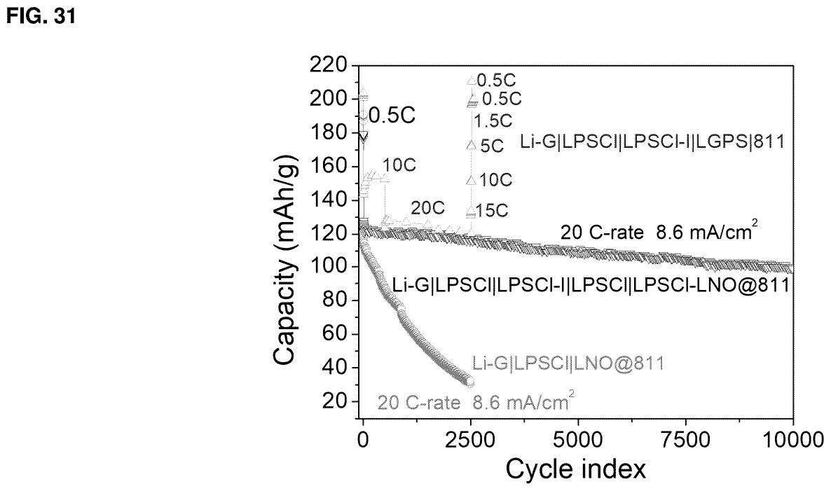

To test these different stabilities predicted above for the original LPSCl and the doped LPSCl-X, we deposited Li metal to the electrolyte through discharge in an asymmetric battery assembly with the multilayer configuration of Li metal, then graphite (G), then LPSCl, then LGPS, then an electrolyte of interest here (LPSCl or LPSCl-X), i.e., Li-G|LPSCl|LGPS|electrolyte. The thin graphite layer added between Li metal and LPSCl is for an improved interface stability at the initial battery assembly. FIG. 30 shows the XPS and visual comparisons between the Li-deposited pristine LPSCl, LPSCl-X and LGPS. XPS analysis shows that the decomposition is the weakest for the Li deposited LPSCl, while becomes stronger for LPSCl-X and LGPS, consistent with our above prediction. Therefore, we successfully synthesized the suggested compositions to the shell of the core-shell LPSCl-X and LPSCl particles, transforming LPSCl to be more stable with Li metal, likely due to both low K* and Eₕᵤₗₗ, while LPSCl-X to be less stable with Li metal and is more like LGPS, likely due to a relatively high Eₕᵤₗₗ. The decomposition of LPSCl-X at 0 V, however, is likely to be more promptly stabilized by mechanical constriction than LGPS, due to the lower critical modulus (K*) from the design.

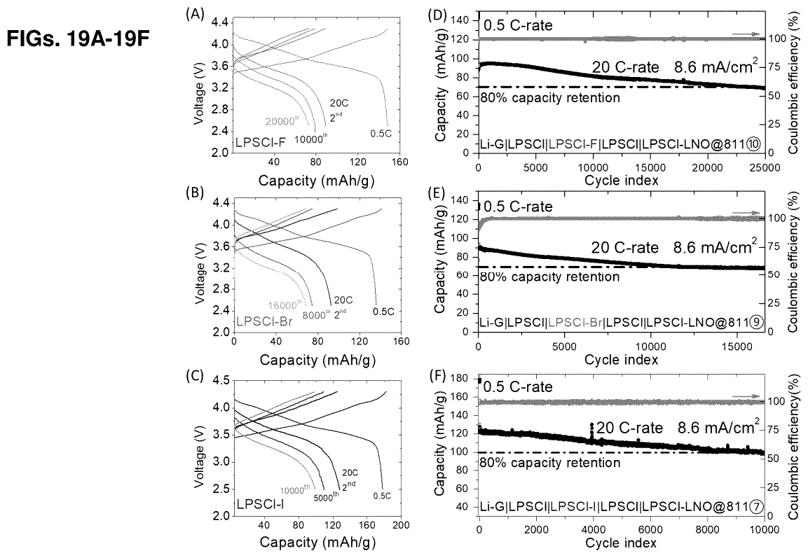

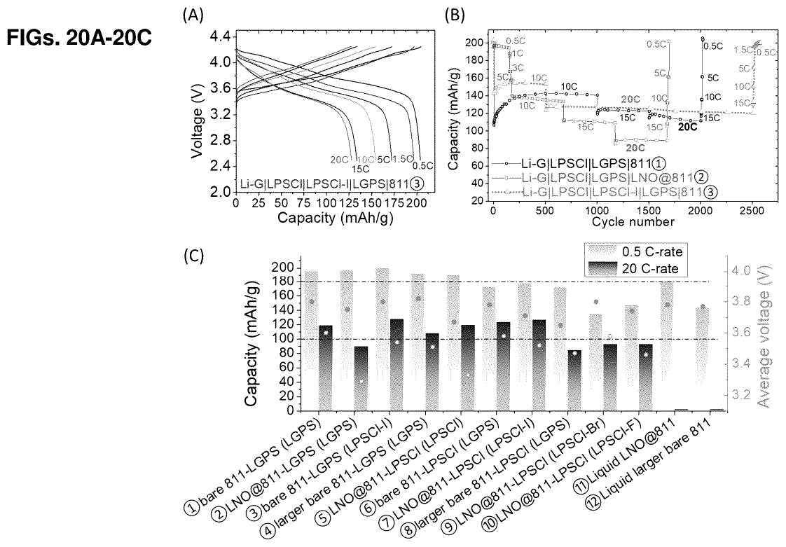

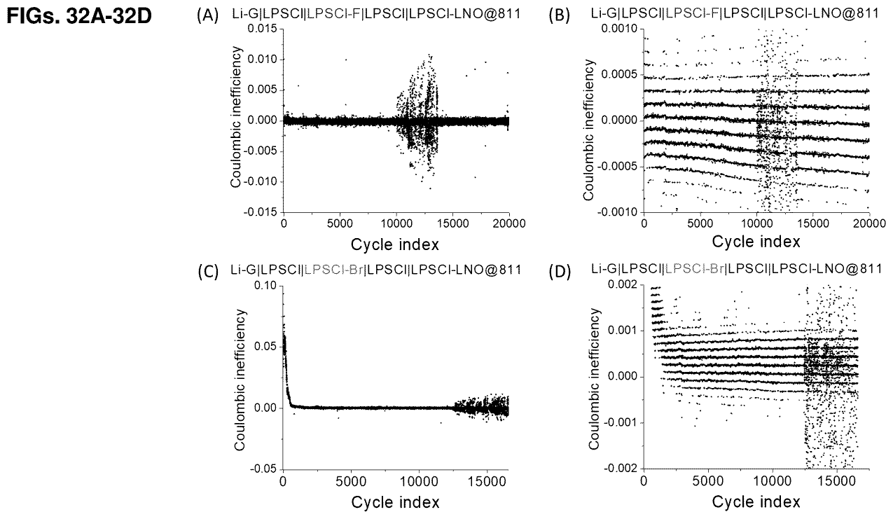

We further made a SSB assembly of Li-G|LPSCl|LNO@NMC811 with LiNbO₃ (LNO) coated single crystal particles of NMC811 or simply 811, embedded in LPSCl. The battery shows a high discharge capacity of 191 mAh/g at 0.5C-rate, which, however, decays quickly with the high-rate cycling (FIG. 3I). We then insert an additional layer of LPSCl-X to separate the original single LPSCl layer into two layers at anode and cathode regions, respectively, and make a new battery assembly of Li-G|LPSCl|LPSCl-X|LPSCl|LNO@811, which is called the LPSCl-X battery hereafter. In FIG. 19, all LPSCl-X (X=F, Br, I) batteries are tested for 5 cycles at 0.5C-rate initially with subsequent cycles at 20C-rate (8.6 mA/cm²). The voltage and capacity decay very slowly, over the 25,000 cycles for LPSCl-F and 16,600 cycles for LPSCl-Br batteries (FIGS. 20A, 20B, 20D, and 20E) with high Coulombic efficiency (low Coulombic inefficiency mainly on the order of 10⁻⁴ to 10⁻³ in FIG. 32), while the LPSCl-I battery shows a high initial capacity but a relatively faster decay over 10,000 cycles (FIGS. 20C and 20F), likely also influenced by the uncontrolled humidity level in the testing condition.

The initial 0.5C capacity for LPSCl-F and LPSCl-Br batteries are 148 mAh/g and 136 mAh/g respectively, while that of LPSCl-I is 178 mAh/g. At 20C, the LPSCl-F battery shows an 88 mAh/g initial discharge capacity, which quickly peaked at 95 mAh/g at 750 cycles, and then shows a large retention of 93% to 81.5 mAh/g after 10,000 cycles, and 83% to 73.2 mAh/g after 20,000 cycles. These numbers for the LPSCl-Br battery are 89 mAh/g (initial), 93 mAh/g (peak at 7th cycle), 78% (69 mAh/g) retention after 10,000 cycles and 77% after 16,000 cycles; and those for the LPSCl-I battery are 124 mAh/g (initial), 128 mAh/g (peak at 3^{rd} cycle) and 79% (98.2 mAh/g) retention after 10,000 cycles. The performance of the multilayer electrolyte batteries shows a substantial improvement compared with the battery with the single electrolyte layer of LPSCl (FIG. 3I).

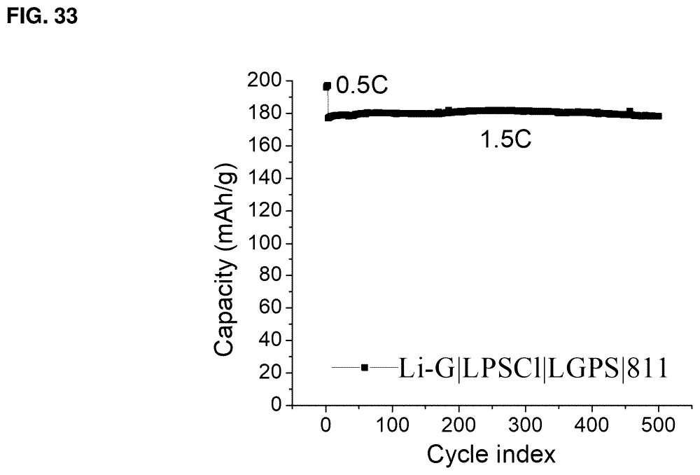

We further introduce LGPS to the battery multilayer configurations. We first assemble three batteries of Li-G|LPSCl|LPSCl-I|LGPS|811, called the LPSCl-I|LGPS|811 battery; Li-G|LPSCl|LGPS|811, called the LGPS|811 battery; and Li-G|LPSCl|LGPS|LNO@811, called the LGPS|LNO@811 battery. FIG. 20A shows the voltage curves at different rates for the LPSCl-I|LGPS|811 battery, with an impressive 128 mAh/g capacity at 20C-rate. FIG. 20B shows the cycling performance of the three batteries at different rates from low to high and back to low rates. At 0.5C-rate all three batteries exhibit high discharge capacities near 200 mAh/g. The LGPS|LNO@811 battery runs for 150 cycles with 98.9% capacity retention, with the other two batteries run for 5 cycles before ramping up the rate. Note that we also tested a separate LGPS|811 battery that runs at 1.5C for 500 cycles with the capacity from 177 mAh/g to 182 mAh/g (FIG. 33).

We note that the LGPS|811 and LPSCl-I|LGPS|811 batteries with uncoated bare NMC811 show different behaviors from the LGPSILNO@811 battery with the LNO coated NMC811 when ramping up the rate. At 20 C-rate, the LGPSILNO@811 battery shows only 90 mAh/g capacity while the LGPS|811 battery reaches 120 mAh/g and stabilizes at 111 mAh/g after 400 cycles. The LPSCl-I|LGPS|811 battery reaches the highest 128 mAh/g, and after the 2500th cycle at 20C-rate, the battery is cycled at slower rates back to 0.5C-rate with capacity of 198 mAh/g for 50 cycles. Note also that all three batteries recovered their low-rate capacities after the high-rate cycling.

Bare 811 batteries, however, show a larger capacity drop at the beginning of high-rate cycling tests, which is followed by a slow increase of capacity until it is stabilized. Such a phenomenon largely disappears for LNO coated 811. Therefore, the interface between LNO@811 and LGPS plays an important role in their high-rate behavior. Further development of a coating material or an electrolyte matrix for in situ coating through interface decompositions during the battery cycling is critical for SSBs to show both the flat cyclability and the >120 mAh/g high-rate capacity.

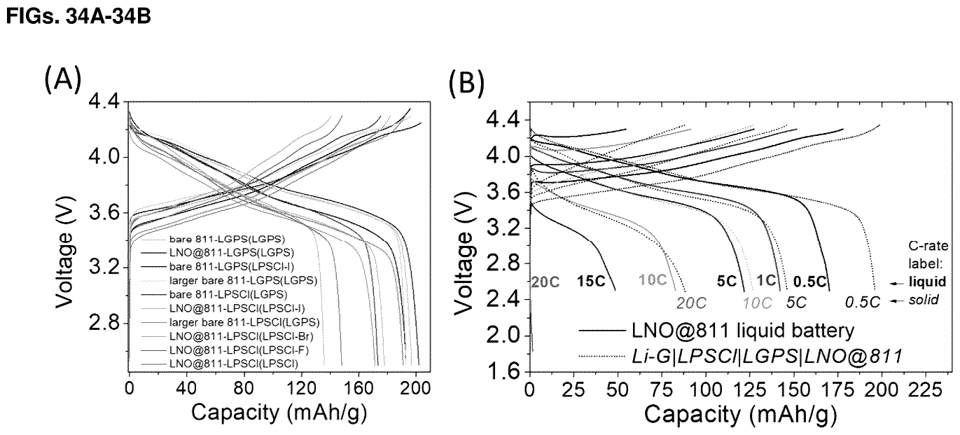

We further tested SSBs with different multilayer combinations, with their initial discharge capacities and average voltages shown in FIG. 4C (\textcircled{1}-\textcircled{10}), and voltage profiles shown in FIG. 34. The above three batteries discussed in FIGS. 20A/20B (\textcircled{1}\textcircled{2}\textcircled{3}) and the three batteries discussed in FIG. 19 (\textcircled{7}\textcircled{9}\textcircled{10}) are also included here. At 0.5C-rate all batteries with LGPS in the cathode region (\textcircled{1}-\textcircled{4}) in FIG. 4C) show capacities higher than 190 mAh/g, suggesting LGPS is good for low-rate capacity with either bare or coated 811. On the contrary, LPSCl in the cathode (\textcircled{6}-\textcircled{10}) decreases the capacity below 180 mAh/g, except for the all-LPSCl-battery (\textcircled{5}) with the least primary interfaces between multiple layers. The battery, however, shows a poor cycling (FIG. 3I).

At 20C-rate, bare 811-LGPS (\textcircled{1}\textcircled{3}\textcircled{4}) and bare 811-LPSCl (\textcircled{6}) batteries can all reach capacities higher than 100 mAh/g, suggesting interfaces between bare 811 and sulfide electrolytes may be in general good for high-rate capacity. The LNO@811-LPSCl (\textcircled{5}\textcircled{7}) batteries are higher than 100 mAh/g, while the LNO@811-LGPS (\textcircled{2}) battery shows a lower capacity of 90 mAh/g, suggesting that the LNO coating for 811 might be more compatible to LPSCl than LGPS at high rates. Another type of bare 811 with larger tap density and particle size shows lower high-rate capacities with LGPS (\textcircled{4}) and LPSCl (\textcircled{8}) as the cathode matrix than the counterparts with smaller 811 particles (\textcircled{1} and \textcircled{6}, respectively), which suggests that Li diffusion kinetics in 811 becomes a prominent factor to limit the capacity at 20C-rate. However, these SSBs all show much better high-rate performance than the liquid electrolyte LNO@811 batteries (FIG. 34B), which show almost no capacity at 20C due to large polarizations (\textcircled{11}\textcircled{12}).

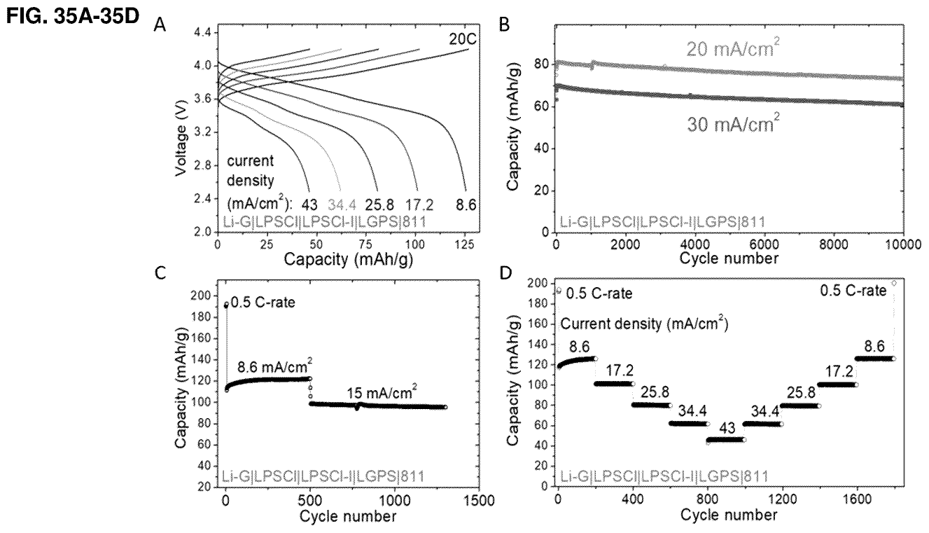

At extremely high rates higher than 20C-rate, bare 811-LGPS-LPSCl-I \textcircled{3} battery shows high capacities from 50 mAh/g (100C-rate, 43 mA/cm² current density) to 120 mAh/g (40C-rate, 17.2 mA/cm²) in FIG. 35A. At high current density of 20 mA/cm² and 30 mA/cm², batteries can cycle stably for more than 10,000 cycles (FIG. 35B). The two batteries in FIG. 35B were cycled with different histories before the 10,000 cycles of long cycling. The 20 mA/cm² battery was first cycled at 8.6 mA/cm² for 500 cycles and then cycled at 15 mA/cm² for 800 cycles (FIG. 35C), while the 30 mA/cm² battery was first cycled at various current densities up to 43 mA/cm² (FIG. 35D).

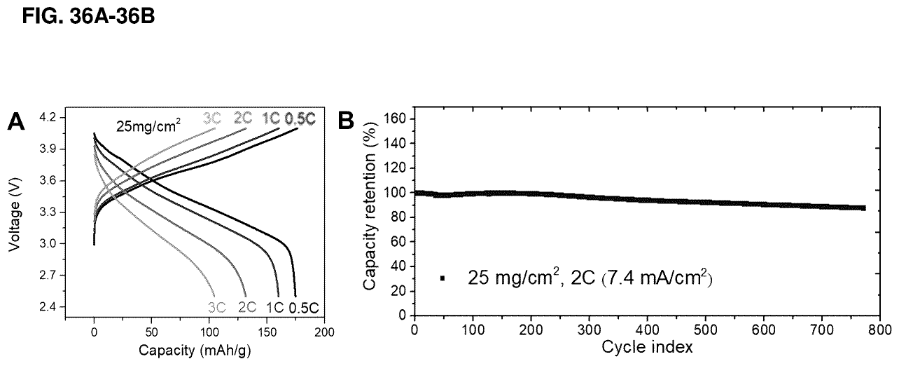

The cycling performance of solid-state batteries with the multilayer design (Li/Si-G|LPSCl-LGPS-LPSCl|NMC811) is shown in FIGS. 36A-36B. FIG. 36A shows the charge and discharge profiles at different C-rates, and FIG. 36B shows the capacity retention of the battery cycled at 2C with cutoff voltages set at 4.1 V and 2.5 V at 55° C. The capacity remained above 80% after 700 cycles. The anode was Li covered by silicon-graphite mixture (Li/Si-G), where the Si particle size=1 μm, the cathode was LiNi_{0.8} Mn_{0.1}Co_{0.1}O₂ (NMC811, cathode active material loading=25 mg/cm²), with Li_{5.5}PS_{4.5}Cl_{1.5} (LPSCl) and Li₁₀Ge₁P₂S₁₂ (LGPS) as the electrolytes following the multilayer design of LPSCl-LGPS-LPSCl.

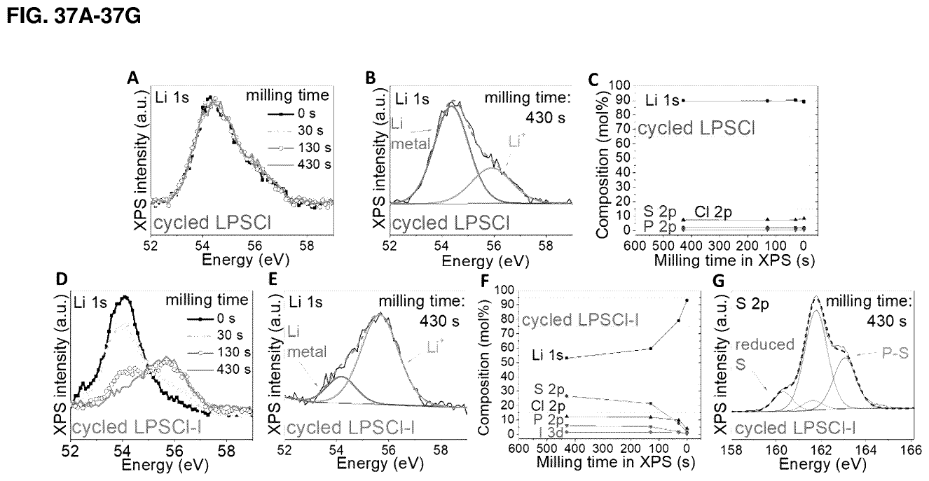

The results of XPS measurements of cycled battery pellet cross sections with ion milling results for a cycled LPSCl in Li-G|LPSCl|811 battery run at 8.6 mA/cm² are shown in FIGS. 37A-37C. FIG. 37A shows Li 1 s XPS at different milling times; FIG. 37B shows Li 1 s XPS refinement of the 430 s milled sample; and FIG. 37C shows XPS quantification of elemental compositions at different ion-milling times. The results of XPS measurements of cycled battery pellet cross sections with ion milling results for a cycled LPSCl-I in Li-G|LPSCl|LPSCl-I|LGPS|811 battery run at 30 mA/cm² are shown in FIGS. 37D-37G. FIG. 37D shows Li 1 s XPS at different milling time; FIG. 37E shows Li 1 s XPS refinement of the 430 s milled sample; FIG. 37F shows XPS quantification of elemental compositions at different ion-milling times; and FIG. 37G shows S 2p XPS refinement of the 430 s milled sample.

### Materials and Methods

DFT binary computation: The unconstrained (K_{eff}=0 GPa) Eₕᵤₗₗ (or decomposition energies) for a pseudo phase AₓB₁₋ₓ is G_{RXN} (x, 0 GPa), which is calculated by constructing phase diagram using the Python Materials Genomics library. All G_{RXN} (x, 0 GPa) are used as the Eₕᵤₗₗ input in machine learning. At different x compositions, both the volume (V) of the pseudo phase and the reaction strain (ε) are different, and G_{RXN} (x, K_{eff}) can be calculated by

$${G}_{R \times N} ( x , {K}_{eff} ) = \{ \begin{matrix}{G}_{R \times N} ( x , 0 GPa ) + {K}_{eff} V ( x ) ε ( x ) , & {G}_{R \times N} ( x , {K}_{eff} ) < 0 \\ 0 , & {G}_{R \times N} ( x , {K}_{eff} ) \geq 0\end{matrix}$$

The K* is the critical Ker when all x composition pseudo phases have the zero decomposition energy:

$${K}^{*} = max \{ \frac{- {G}_{RXN} ( x , 0 GPa )}{V ( x ) ε ( x )} \}$$

If ε(x)≤0, ε(x) will be defined to be 0 and K* will become infinite. For the situation that the material is intrinsically stable with Li, both Eₕᵤₗₗ and K* are 0 by definition. The new method here is built upon our computational platform, and together with the new machine learning model expands the ability of the constrained ensemble prediction to the design of material (in) stabilities.

Machine learning: Compositions, energies, and volumes of 124,497 materials are queried from Materials Project for high throughput calculations of hull energies (Eₕᵤₗₗ) and K* values for the interfaces between materials and Li metal. Machine learning is applied to model the relation between macroscopic properties (composition, energy, volume) and target values (Eₕᵤₗₗ, K*). Machine learning models in this work are based on decision trees. A decision tree consists of hierarchical computation (decision) nodes. The input data to the decision trees is in the form (X, y)=({x₁, x₂, . . . , xₙ}, y) where xᵢ are the features and y is a target value. The decision tree can perform both the regression and classification tasks, depending on whether the nature of target variable y being continuous or a finite number of classes. Starting with the input features, each node of the tree applies a conditional statement on the value of a feature, then moves to a subsequent node based on the truth of that statement. The optimization of the tree includes choosing both the feature and threshold for the criteria for each node that overall best splits the set of items. Instead of measuring the error, better metrics such as the cross entropy and the Gini index are generally used to measure the goodness of the choice of criteria and data split. Our input features X consist of the 104-dimensional composition vectors. Specifically, for K* at 0V, we also include the x from 0 to 0.9 in our input for a better learning result. The target y are chosen as the K*, and decomposition energy at different situations. For K* at 0V, the target y is the K* at the corresponding x. We use an ensemble model of individual decision trees, the Extremely Randomized Tree model. In such models, a number of N trees are initialized simultaneously (N=30 in our setting). Each tree in the ensemble is fed with training data sampled from the training set. A random subset of candidate features is used, from which thresholds are drawn at random for each candidate feature, and the best of these randomly generated thresholds is picked as the splitting rule. Using the trained models with target property y, we obtain the composition with optimal y using the grid search. Optimization with fixed F/Br/I in FIG. 17B and FIG. 22 are with 50% relative compositional change constraint on each element to avoid extinction of certain elements. Since most compounds are unstable with Li metal so that the zero hull energy data are insufficient in the training set, the machine learning predicted zero hull energy reference has to be calibrated by DFT. LiCl shows a ˜0 eV decomposition energy with Li metal in DFT binary calculations (FIG. 21), and the predicted decomposition energy for Li_{0.49}Cl_{0.49} S_{0.01}P_{0.01} is 0.915 eV, so the decomposition energy is shifted down by 0.915 eV in FIG. 17B, FIG. 22 and FIG. 29.

Materials synthesis: Li_{5.5}PS_{4.5}Cl_{1.5}, Li_{5.5}PS_{4.5}Cl_{1.1}F_{0.4}, Li_{5.5}PS_{4.5}Cl_{1.45}Br_{0.15}, and Li_{5.5}PS_{4.5}Cl_{1.45}I_{0.15} were prepared by ball milling and solid state reactions. Stoichiometric amounts of Li₂S (99.9% purity, Alfa Aesar), P₂S₅ (99% purity, Sigma Aldrich), LiF (>99% purity, Sigma Aldrich), LiBr (>99% purity, Sigma Aldrich), LiI (>99.9% purity, Sigma Aldrich), and LiCl (>99% purity, Alfa Aesar) were weighted and milled for 16 hours under argon protection. The precursor was transferred into a quartz tube and annealed at 550° C. for 1 hour with a temperature increasing rate of 5° C./min and a cooling rate of 1° C./min, in an argon flow.

LGPS (325 mesh) was purchased from MSE.

Scanning electron microscopy-focused ion beam-energy dispersive spectroscopy (SEM-FIB-EDX): The SEM-FIB-EDX was conducted on a FEI Helios 660. Solid state electrolyte powder was dispersed on to a carbon tape and attached to a SEM stub. The sample was sealed in a plastic box in the glovebox with O₂ and H₂O<0.1%. The sample was quickly transferred into the SEM in ˜15 s to avoid the air exposure. The high voltage is 10 kV and the magnification is 10,000×. The solid electrolyte particle was etched by the focused ion beam and the EDX line scan was conducted on the cross-section of the particle after the etching.

X-ray photoelectron spectroscopy (XPS): XPS was performed using a Thermo Scientific K-Alpha+ with a beam size of 400 um. Samples were mounted onto a standard XPS sample holder and sealed with plastic bags. Samples were then transferred into a vacuum environment with about 15 seconds air exposure. Some other samples were mounted onto a sample holder with vacuum transfer module to completely avoid the air exposure. Ar-ion milling was performed with 1000 eV ion energy and monatomic mode, which is estimated to mill Ta₂O₅ with ˜140 GPa bulk modulus at 0.26 nm/s. Survey spectrum is used for quantification. All XPS results were fitted through peak differentiating and imitating via Advantage.

X-ray diffraction (XRD): XRD data were obtained using a Rigaku Miniflex 6G. Powder samples are sealed with Kapton film in an argon-filled glovebox to prevent the air contamination.

Electrochemistry: A lithium metal solid state battery was made with the structure of Li/graphite-LPSCl-central layer-(separating layer)-cathode matrix. A 25 μm lithium metal was covered by a graphite thin film to act as the anode. The graphite layer was made by mixing 95 wt % graphite (BTR, China) with 5 wt % PTFE, and the capacity ratio of lithium to graphite is 2.5:1. 40 mg LPSCl and 100 mg central layer powders were applied as the electrolyte. A 60 mg separating layer of the same electrolyte powder in the cathode matrix is added when the central layer is different from that in the cathode matrix. The LiNbO₃ is coated on NMC811 (MSE Supplies) by 1.9 wt % following previous report (17). The larger particle size NMC811 is obtained from XTC, China. 70 wt % (LNO@) 811 was mixed with 30 wt % LPSCl to serve as the cathode with an additional 3% PTFE to make a cathode film. The loading of the cathode is 2 mg/cm². The battery was initially pressed at 460 MPa and a stack pressure of 250 MPa was maintained by a pressurized cell. The battery was either cycled on an Arbin battery testing station (data log rate: 10 points/sec) at 55° C. in an environmental chamber with the humidity controlled <10% inside Memmert hpp110, on a Solartron 1400 cell test system (data log rate: 10 points/sec) or an LANHE battery test system (data log rate: 1 point/sec) at 55° C. as listed.

| | |
|---|---|
| \textcircled{1}Li-G\|LPSCH\|LGPS\|811 | Solartron, 55° C. |
| \textcircled{2}Li-G\|LPSCI\|LGPS\|LNO@811 | Solartron, 55° C. |
| \textcircled{3}Li-G\|LPSCI\|\|LPSCI-I\|LGPS\|811 | LANHE, 55° C. |
| \textcircled{4}Li-G\|LPSCI\|LGPS\|larger 811 | Solartron, 55° C. |
| \textcircled{5}Li-G\|LPSCI\|LNO@811 | LANHE, 55° C. |
| \textcircled{6}Li-G\|LPSCI\|LGPS\|LPSCI\| 811 | LANHE, 55° C. |
| \textcircled{7}Li-G\|LPSCI\|LPSCI-I\|LPSCI\|LNO@811 | LANHE, 55° C. |
| \textcircled{8}Li-G\|LPSCI\|LGPS\|LPSCI\|larger 811 | Arbin, 55° C., 8% |
| | humidity control |
| \textcircled{9}Li-G\|LPSCI\|LPSCI-Br\|LPSC\|LNO@811 | Arbin, 55° C., 8% |
| | humidity control |
| \textcircled{10}Li-G\|LPSCI\|LPSCI-F\|LPSCI\|LNO@811 | Arbin, 55° C., 8% |
| | humidity control |

In FIG. 20B, the \textcircled{3} Li-G|LPSCl|LPSCl-I|LGPS|811 battery is cycled at 2.5V-4.25V from low to high and back to low rates. The subsequent cycles at 0.5C is within 2.5V-4.13V.

The liquid cells were assembled using Li metal as the anode, glass fiber as the separator and 1 M LiPF6 in EC/DMC (v:v=1:1) as the electrolyte. A cathode film with the same active material loading of 2 mg/cm² was applied, with the ratio of NMC811:Carbon:PTFE=85:10:5.

### REFERENCES

1. Wenzel, S. et al. Direct Observation of the Interfacial Instability of the Fast Ionic Conductor Li10GeP2S12 at the Lithium Metal Anode. Chem. Mater. 28, 2400-2407 (2016).
2. Su, Y. et al. A more stable lithium anode by mechanical constriction for solid state batteries. Energy Environ. Sci. 13, 908-916 (2020).
3. Kamaya, N. et al. A lithium superionic conductor. Nat. Mater. 10, 682-686 (2011).
4. Adeli, P. et al. Boosting Solid-State Diffusivity and Conductivity in Lithium Superionic Argyrodites by Halide Substitution. Angew. Chemie—Int. Ed. 58, 8681-8686 (2019).
5. Kasemchainan, J. et al. Critical stripping current leads to dendrite formation on plating in lithium anode solid electrolyte cells. Nat. Mater. doi:10.1038/s41563-019-0438-9
6. Lee, Y. G. et al. High-energy long-cycling all-solid-state lithium metal batteries enabled by silver-carbon composite anodes. Nat. Energy 5, 299-308 (2020).
7. Krauskopf, T., Richter, F. H., Zeier, W. G. & Janek, J. Physicochemical Concepts of the Lithium Metal Anode in Solid-State Batteries. Chem. Rev. (2020). doi:10.1021/acs.chemrev.0c00431
8. Wu, F., Fitzhugh, W., Ye, L., Ning, J. & Li, X. Advanced sulfide solid electrolyte by core-shell structural design. Nat. Commun. 9, 1-11 (2018).
9. Ye, L. et al. Toward Higher Voltage Solid-State Batteries by Metastability and Kinetic Stability Design. Adv. Energy Mater. 2001569, 1-13 (2020).
10. Jin, Y. et al. Self-healing SEI enables full-cell cycling of a silicon-majority anode with a coulombic efficiency exceeding 99.9%. Energy Environ. Sci. 10, 580-592 (2017).
11. Choi, D. et al. Li-ion batteries from LiFePO4 cathode and anatase/graphene composite anode for stationary energy storage. Electrochem. commun. 12, 378-381 (2010).
12. Peng, H. J. et al. Nanoarchitectured graphene/CNT@porous carbon with extraordinary electrical conductivity and interconnected micro/mesopores for lithium-sulfur batteries. Adv. Funct. Mater. 24, 2772-2781 (2014).
13. Li, J., Li, W., You, Y. & Manthiram, A. Extending the Service Life of High-Ni Layered Oxides by Tuning the Electrode-Electrolyte Interphase. Adv. Energy Mater. 8, 1-11 (2018).
14. Adeli, P. et al. Boosting Solid-State Diffusivity and Conductivity in Lithium Superionic Argyrodites by Halide Substitution. Angew. Chemie—Int. Ed. 58, 8681-8686 (2019).
15. Kamaya, N. et al. A lithium superionic conductor. Nat. Mater. 10, 682-686 (2011).
16. Fitzhugh, W., Wu, F., Ye, L., Su, H. & Li, X. Strain-Stabilized Ceramic-Sulfide Electrolytes. Small 1901470, 1-14 (2019).
17. Zhao, F. et al. Ultrastable Anode Interface Achieved by Fluorinating Electrolytes for All-Solid-State Li Metal Batteries. ACS Energy Lett. 5, 1035-1043 (2020).
18. Rangasamy, E. et al. An iodide-based Li7P2S81 superionic conductor. J. Am. Chem. Soc. 137, 1384-1387 (2015).
19. Wang, C. et al. Stabilizing interface between Li10SnP2S12 and Li metal by molecular layer deposition. Nano Energy 53, 168-174 (2018).
20. Kato, Y. et al. High-power all-solid-state batteries using sulfide superionic conductors. Nat. Energy 1, 16030 (2016).
21. Liang, J. et al. In Situ Li3PS4 Solid-State Electrolyte Protection Layers for Superior Long-Life and High-Rate Lithium-Metal Anodes. Adv. Mater. 30, 1-9 (2018).
22. Wu, F., Fitzhugh, W., Ye, L., Ning, J. & Li, X. Advanced sulfide solid electrolyte by core-shell structural design. Nat. Commun. 9, 1-11 (2018).
23. Braga, M. H., Ferreira, J. A., Stockhausen, V., Oliveira, J. E. & El-Azab, A. Novel Li3ClO based glasses with superionic properties for lithium batteries. J. Mater. Chem. A 2, 5470-5480 (2014).
24. Wenzel, S. et al. Interphase formation and degradation of charge transfer kinetics between a lithium metal anode and highly crystalline Li7P3S11 solid electrolyte. Solid State Ionics 286, 24-33 (2016).
25. Pan, M. et al. Electrochemistry. 23-26 (2018).
26. Han, F., Zhu, Y., He, X., Mo, Y. & Wang, C. Electrochemical Stability of Li 10 GeP 2 S 12 and Li 7 La 3 Zr 2 O 12 Solid Electrolytes. Adv. Energy Mater. 6, 1501590 (2016).
27. Cheng, E. J., Sharafi, A. & Sakamoto, J. Intergranular Li metal propagation through polycrystalline Li6.25Al0.25La3Zr2O12 ceramic electrolyte. Electrochim. Acta 223, 85-91 (2017).
28. Zhang, W. & Sun, C. Effects of CuO on the microstructure and electrochemical properties of garnet-type Li6.3La3Zr1.65W0.35O12 solid electrolyte. J. Phys. Chem. Solids 135, 109080 (2019).
29. Kim, Y. et al. Electrochemical stability of Li 6.5 La 3 Zr 1.5 M 0.5 O 12 (M=Nb or Ta) against metallic lithium. Front. Energy Res. 4, 1-7 (2016).
30. Li, J., Ma, C., Chi, M., Liang, C. & Dudney, N. J. Solid electrolyte: The key for high-voltage lithium batteries. Adv. Energy Mater. 5, 1-6 (2015).
31. Xu, D. et al. In Situ Generated Fireproof Gel Polymer Electrolyte with Li6.4Ga0.2La3Zr2O12 As Initiator and Ion-Conductive Filler. Adv. Energy Mater. 9, 1-12 (2019).
32. Yoshinari, T. et al. Interfacial Stability of Phosphate-NASICON Solid Electrolytes in Ni-Rich NCM Cathode-Based Solid-State Batteries. ACS Appl. Mater. Interfaces 11, 23244-23253 (2019).
33. Asano, T. et al. Solid Halide Electrolytes with High Lithium-Ion Conductivity for Application in 4 V Class Bulk-Type All-Solid-State Batteries. Adv. Mater. 30, 1-7 (2018).
34. Li, X. et al. Air-stable Li3InCl6 electrolyte with high voltage compatibility for all-solid-state batteries. Energy Environ. Sci. 12, 2665-2671 (2019).
35. Park, K. H. et al. High-Voltage Superionic Halide Solid Electrolytes for All-Solid-State Li-Ion Batteries. ACS Energy Lett. 533-539 (2020). doi:10.1021/acsenergylett.9b02599
36. Liang, J. et al. Site-Occupation-Tuned Superionic LixScCl3+xHalide Solid Electrolytes for All-Solid-State Batteries. J. Am. Chem. Soc. 142, 7012-7022 (2020).
37. Khurana, R., Schaefer, J. L., Archer, L. A. & Coates, G. W. Suppression of lithium dendrite growth using cross-linked polyethylene/poly(ethylene oxide) electrolytes: A new approach for practical lithium-metal polymer batteries. J. Am. Chem. Soc. 136, 7395-7402 (2014).
38. Ye, L. et al. An Efficient Route to Polymeric Electrolyte Membranes with Interparticle Chain Microstructure Toward High-Temperature Lithium-Ion Batteries. Adv. Mater. Interfaces 4, 1-6 (2017).

Other embodiments are in the claims.

1.-37. (canceled)

38. A battery, comprising:
an anode;
a cathode; and
a solid state electrolyte (SSE) multilayer disposed between the anode and the cathode, the SSE multilayer including:
a first layer including a first SSE, the first layer disposed on the anode; and
a second layer including a second SSE different from the first SSE, the second layer disposed on the first layer such that the second layer is separated from the anode by the first layer,
each of the first SSE and the second SSE including a sulfide.

39. The battery of claim 38, wherein the anode includes an alkali metal, and the first SSE is configured to be chemically stable towards the alkali metal such that the first SSE does not decompose upon contact with the alkali metal.

40. The battery of claim 39, wherein the second SSE is configured to decompose upon contact with the alkali metal, such that upon progression of a dendrite of the alkali metal from the anode towards the cathode, the dendrite penetrates the first layer and contacts a portion of the second SSE in the second layer, and the contacted portion of the second SSE decomposes to form a byproduct, the byproduct configured to inhibit further progression of the dendrite towards the cathode.

41. The battery of claim 40, wherein, upon formation of a crack in the second layer by the dendrite, the second SSE configured to decompose proximate the crack such that a portion of the byproduct fills the crack and inhibits progression of the dendrite therethrough.

42. The battery of claim 38, wherein the first SSE includes an LPSCl compound, the LPSCl compound including least one of Li_{6±y}PS_{5±y}Cl_{1±y} or Li_{5.5±y}PS_{4.5±y}Cl_{1.5±y}, wherein 0≤y≤1.

43. The battery of claim 42, wherein the first layer includes at least about 30 wt % of the LPSCl compound.

44. The battery of claim 38, wherein the second SSE includes at least one of an LGPS compound, an LSPS compound, or an LPSCl-X compound, wherein X includes at least one of F, Br, or I.

45. The battery of claim 44, wherein the second SSE includes at least about 30 wt % of the LGPS compound, the LSPS compound, or the LPSCl-X compound.

46. An electrochemical cell, comprising:
a first electrode;
a second electrode; and
a solid state electrolyte (SSE) separator disposed between the first and second electrodes, the SSE separator including:
a first layer including a first SSE, the first layer disposed on the first electrode;
a second layer including a second SSE different from the first SSE, the second layer disposed on the first layer such that the second layer is separated from the first electrode by the first layer; and
a third layer including a third SSE different from the second SSE, the third layer disposed on the second electrode such that the second layer is separated from the second electrode by the third layer,
each of the first SSE, the second SSE, and the third SSE including a sulfide.

47. The electrochemical cell of claim 46, wherein the first electrode includes an alkali material, the second SSE is configured to chemically react with the alkali material to form a decomposition product, and the first and third SSEs are configured to not chemically react with the alkali material.

48. The electrochemical cell of claim 47, wherein the second layer is configured such that, upon progression of a dendrite of the alkali material from the first electrode towards the second electrode through the first layer, the dendrite contacts a portion of the second SSE in the second layer such that the contacted portion of the second SSE forms a region of the decomposition product in the second layer, the region of the decomposition product configured to impede further progression of the dendrite towards the second electrode.

49. The electrochemical cell of claim 46, wherein the first SSE and the third SSE each include an LPSCl compound, the LPSCl compound including least one of Li_{6±y}PS_{5±y}Cl_{1±y} or Li_{5.5±y}PS_{4.5±y}Cl_{1.5±y}, wherein 0≤y≤1.

50. The electrochemical cell of claim 49, wherein the second SSE includes at least one of an LGPS compound, LSPS compound, or Li_{6±y}PS_{5±y}(Cl_{1-z}X_{z})_{1±y}, wherein 0≤y, z≤1, and X includes at least one of F, Br, or I.

51. The electrochemical cell of claim 46, further comprising:
a first protective layer between the first layer and the first electrode, the first protective layer configured to inhibit physical contact between the first layer and the first electrode; and
a second protective layer between the third layer and the second electrode, the second protective layer configured to inhibit physical contact between the third layer and the second electrode.

52. The electrochemical cell of claim 51, wherein the first and second protective layers each include at least one of silicon, silicon dioxide, Li₄Ti₅O₁₂, Li₃V₂O₅, carbon, Au, Ag, Sn, SnO₂, graphite, hard carbon, amorphous carbon, carbon nanotube, graphene, carbon nanofiber, or a fullerene.

53. The electrochemical cell of claim 52, wherein the first and second protective layers each include graphite.

54. A battery, comprising:
an anode including an alkali material;
a cathode; and
a solid state electrolyte (SSE) separator disposed between the anode and the cathode, the SSE separator including:
a first layer including a first SSE, the first SSE configured to be chemically stable towards the alkali material such that the first SSE does not decompose upon contact with the alkali material; and
a second layer including a second SSE, the second SSE configured to decompose upon contact with the alkali material to form a byproduct in the second layer, the byproduct configured to inhibit progression of the alkali material from the anode to the cathode through the second layer,
wherein the second layer is separated from the anode by the first layer.

55. The battery of claim 54, further comprising:
a third layer disposed between the second layer and the cathode, the third layer including a third SSE different from the second SSE.

56. The battery of claim 55, wherein:
the first SSE and the third SSE include at least one of Li₆PS₅Cl, Li_{6±y}PS_{5±y}Cl_{1±y}, Li_{5.5}PS_{4.5}Cl_{1.5}, or Li_{5.5±y}PS_{4.5±y}Cl_{1.5±y}, wherein 0≤y≤1, and
the second SSE includes at least one of Li_{10±z}Ge_{1±y}P_{2±p}S_{12±q}, Li_{10±z}Sn_{1±y}P_{2±p}S_{12±q}, or Li_{6±y}PS_{5±y}(Cl_{1-z}X_{z})_{1±y}, wherein 0≤p, q, y, z≤1, and X includes at least one of F, Br, or I.

57. The battery of claim 55, further comprising:
a first protective layer between the first layer and the anode; and
a second protective layer between the third layer and the cathode, the first and second protective layers configured to inhibit physical contact between the anode, the cathode, and corresponding first and third layers, the first and second protective layers including graphite.
